(19) United States
(12) Patent Application Publication
(10) Pub. No.: US 2014/0141309 A1
(43) Pub. Date: May 22, 2014

(54) BATTERY MODULE

(71) Applicant: Toru Suzuki, Sagamihara-shi (JP)

(72) Inventor: Toru Suzuki, Sagamihara-shi (JP)

(73) Assignee: NEC ENERGY DEVICES, LTD., Sagamihara-shi, Kanagawa (JP)

(21) Appl. No.: 14/232,774

(22) PCT Filed: Jul. 4, 2012
(86) PCT No.: PCT/JP2012/067093

§ 371 Date: Jan. 14, 2014

(30) Foreign Application Priority Data
Jul. 15, 2011 (JP) 2011-156733
Mar. 16, 2012 (JP) 2012-059708

(51) Int. Cl. H01M 2/10

(52) U.S. Cl. CPC H01M 2/1072
USPC 429/99

(57) ABSTRACT

To provide a battery module that can easily ensure a high level of flame retardancy, a battery module of the present invention includes: a flat-plate base that includes a front surface and a back surface as two main surfaces; a compartmentalization partition wall section (212) that is erected and formed on the front or back surface from the base; and a plurality of unit batteries that are mounted on the base, wherein the compartmentalization partition wall section (212) is provided between the unit battery and the adjacent unit battery.

### TECHNICAL FIELD

The present invention relates to a battery module that is made by using secondary unit batteries such as lithium-ion batteries.

### BACKGROUND ART

In recent years, in light of environmental issues, much attention has been paid to clean energy obtained from wind power generation, solar power generation, and the like, which can be used for households, such as detached houses, as well as for industries, such as transport machines and construction machines. However, the problem with clean energy is that the output varies widely depending on the situation. For example, the energy generated by solar power can be obtained during the day when the sun is out, but cannot be obtained during the night after the sun went down.

In order to ensure stable output of clean energy, what is used is a technique for temporarily storing the clean energy in batteries. For example, solar energy stored in batteries is available even during the night after the sun went down. As the batteries that store the clean energy, lead-acid batteries are typically used. However, the disadvantage is that typical lead-acid batteries are large in size, and are low in energy density.

In recent years, lithium-ion secondary batteries that can operate at normal temperatures and are high in energy density have been gaining attention. The lithium-ion secondary batteries are characterized as being high in energy density, as well as being excellent in responsiveness because of low impedance.

As lithium-ion secondary batteries, for example, there is a laminate battery in which battery elements are enclosed inside a flexible film. The laminate battery usually is a flat plate, with positive and negative electrodes pulled out of the flexible film.

What is known is a technique for connecting two or more such laminate batteries in series and putting the laminate batteries in a container body (casing) to make a module, which is suitable for large capacity.

For example, what is disclosed in Patent Document 1 (Japanese Patent No. 3,970,684) is a battery module that includes an assembled battery that is made by connecting together four sheet-like secondary battery cells, which are formed into a sheet, in series, and a thin, rectangular-parallelepiped-shaped casing that houses the assembled battery.
Patent Document 1: Japanese Patent No. 3,970,684

### SUMMARY OF THE INVENTION

### Problems to be Solved by the Invention

The lithium-ion secondary batteries are higher in energy density than other batteries. Therefore, to ensure safety, an especially high level of flame retardancy is required. The flame retardancy of the batteries can be enhanced by using highly flame-retardant electrode materials or improving the configuration of unit batteries. However, the configuration of a battery module in which the unit batteries are stored, too, is greatly required to be high in flame retardancy.

However, in the case of the battery module disclosed in Patent Document 1, when two secondary battery cells are used to make an assembled battery, the battery module has a structure in which seal sections of a bag-shaped casing body overlap with each other. The problem is that, if trouble, such as generation of heat, occurs in one of the batteries after the battery module is used in an abnormal state, the trouble is likely to be passed on to the other battery.

In addition, the battery module disclosed in Patent Document 1 has a structure in which flexible secondary battery cells are stored in a rectangular-parallelepiped-shaped casing. Therefore, the problem is that it is difficult to curb a decrease in rigidity as the battery module is made thinner, and it is difficult to make the battery module thinner.

If the rigidity is unlikely to be maintained, and the battery module becomes warped, stress is applied to a terminal that is pulled out of a secondary battery cell stored in the battery module. The problem is that an electric connection section between the battery cells can be easily damaged, resulting in a decrease in reliability, and that it is difficult to obtain desired electric characteristics.

When a device for supplying power from the battery module is designed, the dimensions of a battery module mounting portion needs to have a margin to compensate for the warpage. As a result, problems arise, such as difficulty of making the device itself thinner.

Accordingly, the object of the present invention is to provide a battery module that can easily have a highly flame-retardant structure, maintain reliability, and be easily made thinner.

### Means for Solving the Problems

The present invention has been made to solve the above problems. A battery module of the present invention includes: a flat-plate base that includes a front surface and a back surface as two main surfaces; a compartmentalization partition wall section that is erected and formed on the front or back surface from the base; and a plurality of unit batteries that are mounted on the base, wherein the compartmentalization partition wall section is provided between the unit battery and the adjacent unit battery.

In the battery module of the present invention, the compartmentalization partition wall sections are formed on both the front surface and the back surface.

In the battery module of the present invention, the compartmentalization partition wall section is so formed as to protrude from the base, and forms a rectangular shape as a shape on a plane of the front or back surface.

In the battery module of the present invention, the compartmentalization partition wall section is so formed as to protrude from the base, and forms a quadrangular shape as a shape on a plane of the front or back surface.

In the battery module of the present invention, a plurality of the compartmentalization partition wall sections are provided between the unit batteries and the adjacent unit batteries.

The battery module of the present invention includes: a first surface cover body that is placed on a plurality of the unit batteries on the front surface; and a second surface cover body that is placed on a plurality of the unit batteries on the back surface.

In the battery module of the present invention, the first and second cover bodies are made of aluminum.

The battery module of the present invention includes a protruding guide member that is provided on two side faces that are different from the front and back surfaces and face each other, in such a way as to extend along a planar direction of the front or back surface.

In the battery module of the present invention, the protruding guide member is so provided as to protrude from the peripheral partition wall section or to extend from the base; and a tapered section is so provided that a protruding amount of the protruding, or an extending amount of the extending, varies.

In the battery module of the present invention, a width of the protruding guide member provided on one of the two side faces is different from a width of the protruding guide member provided on the other side face in a direction perpendicular to the front or back surface.

In the battery module of the present invention, the compartmentalization partition wall section is provided in a direction perpendicular to a direction in which a pulled-out tab of the unit battery is pulled out, and a notch section is provided in the compartmentalization partition wall section.

The battery module of the present invention includes a first surface cover body that covers the front surface of the base, wherein an opening is so formed as to be surrounded by the first surface cover body and the notch section.

The battery module of the present invention includes a second surface cover body that covers the back surface of the base, wherein an opening is so formed as to be surrounded by the second surface cover body and the notch section.

In the battery module of the present invention, a plurality of the notch sections are provided in the compartmentalization partition wall section.

In the battery module of the present invention, the notch section is provided at a location of the compartmentalization partition wall section where the notch section intersects with a direction in which the pulled-out tab is pulled out.

In the battery module of the present invention, the pulled-out tabs of the unit battery include a positive electrode pulled-out tab and a negative electrode pulled-out tab; the positive electrode pulled-out tab is pulled out of one side of a body section of the unit battery; and the negative electrode pulled-out tab is pulled out of the other side of the body section which faces the one side.

In the battery module of the present invention, in a direction perpendicular to a direction in which a pulled-out tab of the unit battery is pulled out, a plurality of the unit batteries are arranged in one direction.

In the battery module of the present invention, on the compartmentalization partition wall section that intersects with a direction in which the pulled-out tab of each of the unit batteries is pulled out, the notch section is provided.

In the battery module of the present invention, a plurality of the unit batteries are electrically connected together.

In the battery module of the present invention, a connection type of the electric connection is series connection.

In the battery module of the present invention, the unit battery is an electrochemical element.

In the battery module of the present invention, the unit battery is a lithium-ion secondary battery.

### Advantages of the Invention

In the battery module of the present invention, the compartmentalization partition wall sections, which are provided between the adjacent unit batteries within the surface, help to keep abnormal heating or any other trouble of one battery, which might occur when the battery module is used in an abnormal state, from affecting other batteries. Therefore, it is possible to provide the battery module that easily can ensure a high level of flame retardancy. Moreover, the compartmentalization partition wall sections that are provided on both sides of a battery mounting plane keep the rigidity of the battery module high. Therefore, it is possible to provide the battery module that easily can be made thinner and maintain reliability.

### BRIEF DESCRIPTION OF THE DRAWINGS

FIG. 1 is a diagram showing a unit battery 100 that constitutes a battery module according to an embodiment of the present invention, and a preliminary processing step thereof.

FIG. 2 is a diagram illustrating a battery housing body 200 that is used in making a battery module according to an embodiment of the present invention.

FIG. 3 is a diagram illustrating a battery housing body 200 that is used in making a battery module according to an embodiment of the present invention.

FIG. 4 is a diagram illustrating a production process of a battery module according to an embodiment of the present invention.

FIG. 5 is a diagram illustrating a production process of a battery module according to an embodiment of the present invention.

FIG. 6 is a diagram illustrating a production process of a battery module according to an embodiment of the present invention.

FIG. 7 is a diagram illustrating a production process of a battery module according to an embodiment of the present invention.

FIG. 8 is a diagram illustrating a first surface cover body 310 that is used in making a battery module according to an embodiment of the present invention.

FIG. 9 is a diagram illustrating a second surface cover body 320 that is used in making a battery module according to an embodiment of the present invention.

FIG. 10 is a diagram showing a preliminary processing step of a cover body that constitutes a battery module according to an embodiment of the present invention.

FIG. 11 is a diagram illustrating a cover body insulation sheet 360 that is used in making a battery module according to an embodiment of the present invention.

FIG. 12 is a diagram showing a preliminary processing step of a cover body that constitutes a battery module according to an embodiment of the present invention.

FIG. 13 is a diagram illustrating a production process of a battery module according to an embodiment of the present invention.

FIG. 14 is a diagram showing a battery module 400 according to an embodiment of the present invention.

FIG. 15 is a diagram illustrating a production process of a battery module according to an embodiment of the present invention.

FIG. 16 is a diagram illustrating a production process of a battery module according to an embodiment of the present invention.

FIG. 17 is a diagram showing a preliminary processing step of a cover body that constitutes a battery module according to an embodiment of the present invention.

FIG. 18 is a diagram illustrating a production process of a battery management circuit unit 500.

FIG. 19 is a diagram illustrating a production process of a battery management circuit unit 500.

FIG. 20 is a diagram illustrating a production process of a battery management circuit unit 500.

FIG. 21 is a diagram showing a battery management circuit unit 500.

FIG. 22 is a diagram outlining an electric storage device 600 that uses a battery module 400 according to an embodiment of the present invention.

FIG. 23 is a diagram illustrating an assembled battery that includes unit batteries 100 connected in parallel for making a battery module 400 according to another embodiment of the present invention.

FIG. 24 is a diagram showing an assembled battery in which unit batteries 100 are connected in parallel.

FIG. 25 is a diagram showing a battery module 700 according to a second embodiment of the present invention.

FIG. 26 is a cross-sectional view of a battery housing body 200 that is used in making a battery module according to an embodiment of the present invention.

FIG. 27 is a cross-sectional view of a battery housing body 200 that is used in making a battery module according to an embodiment of the present invention.

FIG. 28 is a cross-sectional view of a battery housing body 200 that is used in making a battery module according to an embodiment of the present invention.

FIG. 29 is a cross-sectional view of a battery housing body 200 that is used in making a battery module according to an embodiment of the present invention.

FIG. 30 is a diagram illustrating portions shown in cross section of a battery housing body 200.

FIG. 31 is a cross-sectional view of a battery module 400 according to an embodiment of the present invention.

FIG. 32 is a diagram showing a unit battery 100 that constitutes a battery module according to another embodiment of the present invention, and a preliminary processing step thereof.

FIG. 33 is a diagram illustrating a battery housing body 800 that is used in making a battery module according to another embodiment of the present invention.

FIG. 34 is a diagram illustrating a battery housing body 800 that is used in making a battery module according to another embodiment of the present invention.

FIG. 35 is a diagram illustrating how a first connector 828 is mounted onto a battery housing body 800.

FIG. 36 is a diagram illustrating how a second connector 840 is mounted onto a connector mounting panel 847.

FIG. 37 is a diagram illustrating how a connector mounting panel 847 is mounted onto a battery housing body 800.

FIG. 38 is a front view of a second connector 840 mounted to a battery housing body 800.

FIG. 39 is a diagram illustrating a production process of a battery module according to another embodiment of the present invention.

FIG. 40 is a diagram illustrating a production process of a battery module according to another embodiment of the present invention.

FIG. 41 is a diagram illustrating a production process of a battery module according to another embodiment of the present invention.

FIG. 42 is a diagram illustrating a production process of a battery module according to another embodiment of the present invention.

FIG. 43 is a diagram illustrating a production process of a battery module according to another embodiment of the present invention.

FIG. 44 is a diagram illustrating a production process of a battery module according to another embodiment of the present invention.

FIG. 45 is a diagram illustrating a production process of a battery module according to another embodiment of the present invention.

FIG. 46 is a diagram illustrating a production process of a battery module according to another embodiment of the present invention.

FIG. 47 is an exploded perspective view of a battery module according to another embodiment of the present invention.

FIG. 48 is a perspective view showing a battery module 1000 according to another embodiment of the present invention.

FIG. 49 is a diagram illustrating an exhaust structure of a battery module 1000 according to another embodiment of the present invention.

FIG. 50 is a diagram illustrating a production process of a battery management circuit unit 1100.

FIG. 51 is a diagram illustrating a production process of a battery management circuit unit 1100.

FIG. 52 is a diagram illustrating a production process of a battery management circuit unit 1100.

FIG. 53 is a diagram showing a battery management circuit unit 1100.

FIG. 54 is a diagram outlining an electric storage device 1200 that uses a battery module 1000 according to another embodiment of the present invention.

FIG. 55 is a diagram illustrating a relay board 1150 of an electric storage device 1200.

FIG. 56 is a diagram outlining an electric storage device 1200 that uses a battery module 1000 according to another embodiment of the present invention.

FIG. 57 is a diagram illustrating the configuration of portions around a second connector 840 of a battery module 1000 according to another embodiment of the present invention.

FIG. 58 is a diagram outlining an electric storage device 1200 that uses a battery module 1000 according to another embodiment of the present invention.

FIG. 59 is a diagram outlining an electric storage device 1200 that uses a battery module 1000 according to another embodiment of the present invention.

### EMBODIMENTS FOR CARRYING OUT THE INVENTION

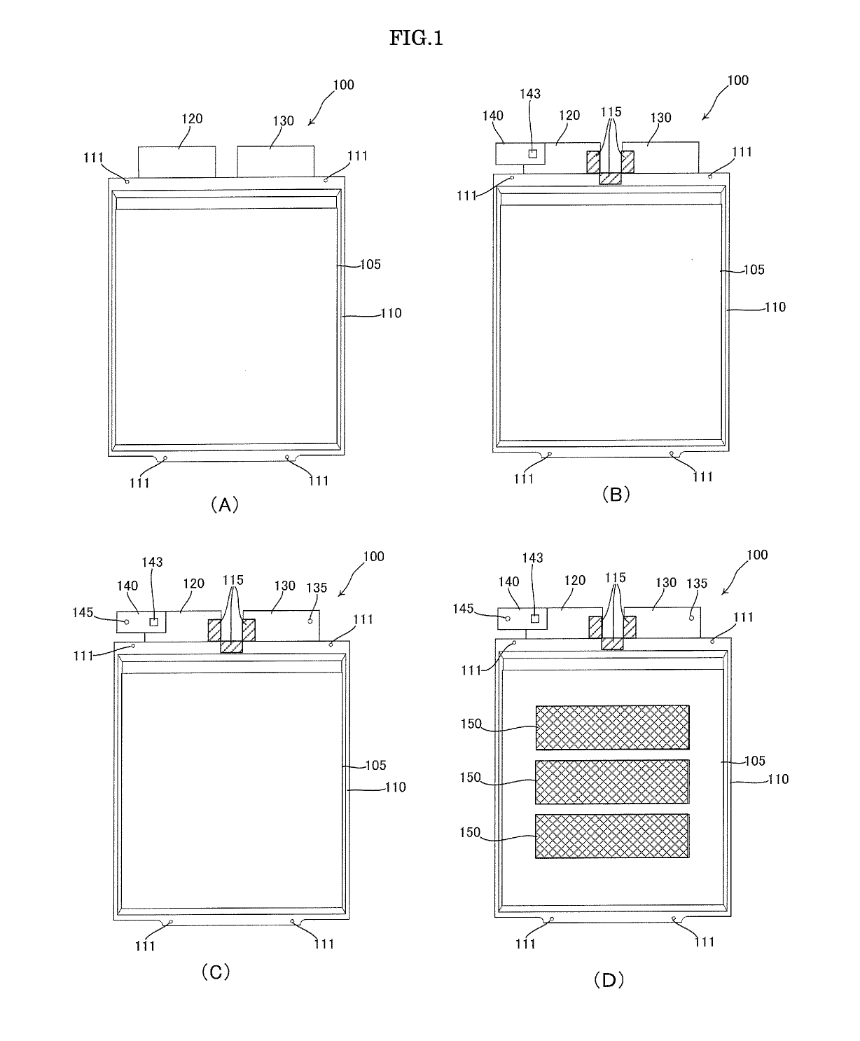

Hereinafter, an embodiment of the present invention will be described with reference to the accompanying drawings. FIG. 1 is a diagram showing a unit battery 100 that constitutes a battery module according to an embodiment of the present invention, and a preliminary processing step thereof. As the unit battery 100, a lithium-ion secondary unit battery, in which lithium ions move between a positive electrode and a negative electrode for charging and discharging, is used.

A battery body section 110 of the unit battery 100 has a structure in which an electrode stacked body and an electrolytic solution (both not shown in the diagram) are housed in a laminate film outer casing that is rectangular in planar view: In the electrode stacked body, a plurality of sheet-like positive electrodes and a plurality of sheet-like negative electrodes are stacked via separators. From one end portion of the battery body section 110, a positive electrode pulled-out tab 120 and a negative electrode pulled-out tab 130 are pulled out. A stacking direction in which a plurality of sheet-like positive electrodes and a plurality of sheet-like negative electrodes are stacked via separators as described above is defined as a sheet thickness direction.

Both the positive electrode pulled-out tab 120 and the negative electrode pulled-out tab 130 are planar in shape; in the laminate film outer casing, the positive electrode pulled-out tab 120 and the negative electrode pulled-out tab 130 each are connected directly, or via a lead body or the like, to a sheet-like positive electrode and a sheet-like negative electrode. The laminate film outer casing is made from metal laminate film with a heat-sealing resin layer. More specifically, for example, two metal laminate films are put together in such a way that the heat-sealing resin layers face each other, thereby forming a laminate film outer casing. An electrode stacked body having the sheet-like positive electrodes, sheet-like negative electrodes, and separators, and the electrolytic solution are housed inside, and the outer periphery of the laminate film outer casing is heat-sealed. Therefore, the inside thereof is sealed.

Here, metal pieces, such as the positive electrode pulled-out tab 120 and negative electrode pulled-out tab 130 that are pulled out of the battery body section 110 including the laminate film outer casing, are referred to as “pulled-out tabs.” Sheet-like positive and negative electrodes, which are stacked via separators, electrolytic solution, and the like in the laminate film outer casing, are referred to as “electrodes.”

Incidentally, the electrode stacked bodies include the above one in which a plurality of sheet-like positive electrodes and a plurality of sheet-like negative electrodes are stacked via separators, and a stack in which sheet-like positive electrodes and sheet-like negative electrodes are stacked via separators and wound around and are compressed.

In the above unit battery 100, as the material of the positive electrode pulled-out tab 120, aluminum or aluminum alloy is typically used. As the material of the negative electrode pulled-out tab 130, nickel, a material made by plating other metals with nickel (Nickel-plated material; e.g. copper plated with nickel, and the like), or a clad of nickel and other metals (Nickel-clad material; e.g. nickel-copper clad and the like) is typically used. According to the present embodiment, the positive electrode pulled-out tab 120 made of aluminum, and the negative electrode pulled-out tab 130 made of copper plated with nickel are used.

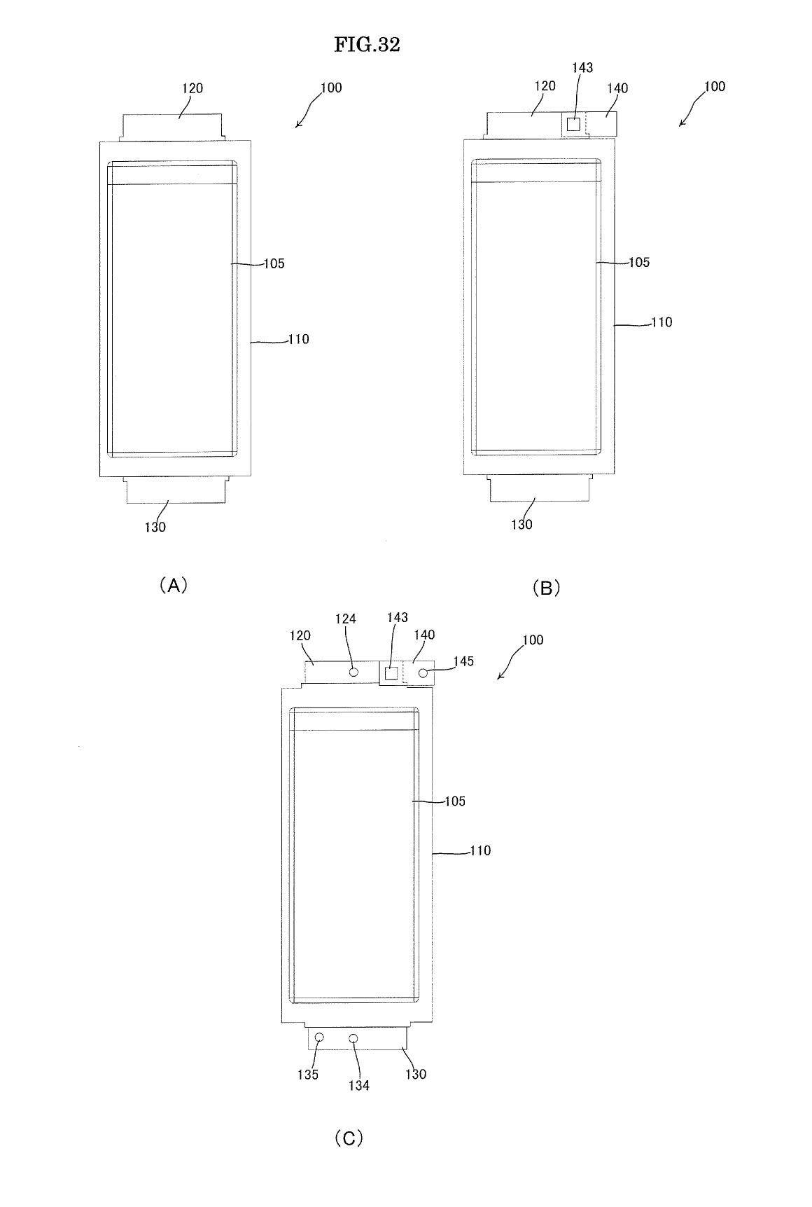

To the unit battery 100 having the above configuration, preliminary processing is carried out before a process of being incorporated into a battery module. First, as shown in FIG. 32(A), at four locations of the laminate film outer casing in a peripheral portion of the unit battery 100, alignment through-holes 111 are provided. The alignment through-holes 111 are used at subsequent steps where the unit battery 100 is set in the battery housing body 200.

In the battery housing body 200, unit-battery alignment projections 241 are provided. When the unit battery 100 is placed onto the battery housing body 200, the unit-battery alignment projections 241 are inserted into the alignment through-holes 111, which makes it easier for the unit battery 100 to be set into the battery housing body 200, helping improve production efficiency.

Then, in a process of FIG. 1(B), insulation tape 115 is affixed to three locations in all, i.e. two locations on the positive electrode pulled-out tab 120 and the negative electrode pulled-out tab 130 and one location of the laminate film outer casing between the positive electrode pulled-out tab 120 and the negative electrode pulled-out tab 130, thereby ensuring a more reliable level of insulation.

Moreover, in the process of FIG. 1(B), an additional tab member 140, which is made of copper, is ultrasonic-welded in a welding section 143. Therefore, the additional tab member 140 is connected to the positive electrode pulled-out tab 120. The reason why such an additional tab member 140 is used will be described.

In making a battery module of the present invention, the positive electrode pulled-out tab 120 of a unit battery 100 and the negative electrode pulled-out tab 130 of a unit battery 100 adjacent to the above unit battery 100 are mechanically fixed to a copper bus bar with screws, and therefore are electrically connected.

If the positive electrode pulled-out tab 120 containing aluminum of the unit battery 100 is mechanically fixed to the copper bus bar, the conductivity might deteriorate after certain years due to a difference in potential.

In the battery module of the present invention, as described above, to the positive electrode pulled-out tab 120 of the unit battery 100, the additional tab member 140 made of copper is welded. Then, the additional tab member 140 made of copper is mechanically fixed to the bus bar. In this manner, the problem of conductivity deterioration caused by the potential difference can be solved. According to the above configuration, in the mechanical electric connection section, the same kinds of metal material are electrically connected, not causing the problem of potential difference; the conductivity is unlikely to deteriorate over years.

Then, in a process of FIG. 1(C), in the additional tab member 140 that is added to the positive electrode pulled-out tab 120, a through-hole 145 is provided, and, in the negative electrode pulled-out tab 130, a through-hole 135 is provided. The through-holes, as described later, are used to: (1) mechanically fix the unit battery 100 to the unit battery housing body 200; (2) electrically connect the tabs to the bus bar of the unit battery housing body 200; and (3) electrically connect the tabs and a sense line.

Then, in a process of FIG. 1(D), two-sided tape 150 is affixed to the battery body section 110 of the unit battery 100. Three strips of two-sided tape 150 are affixed to each surface of the battery body section 110, i.e. six strips in total on both surfaces. A plane of the two-sided tape 150 that is not affixed to the unit battery 100 is affixed to the unit battery housing body 200 or to a cover body insulation sheet of a cover body. Therefore, the unit battery 100 is positionally fixed in the battery module.

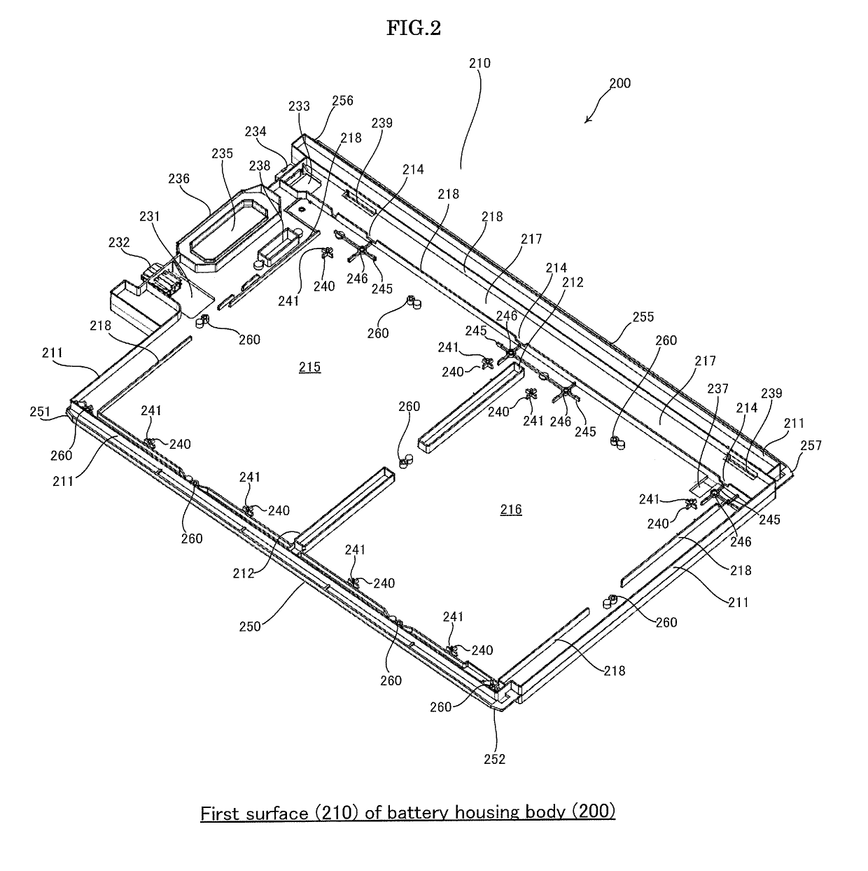

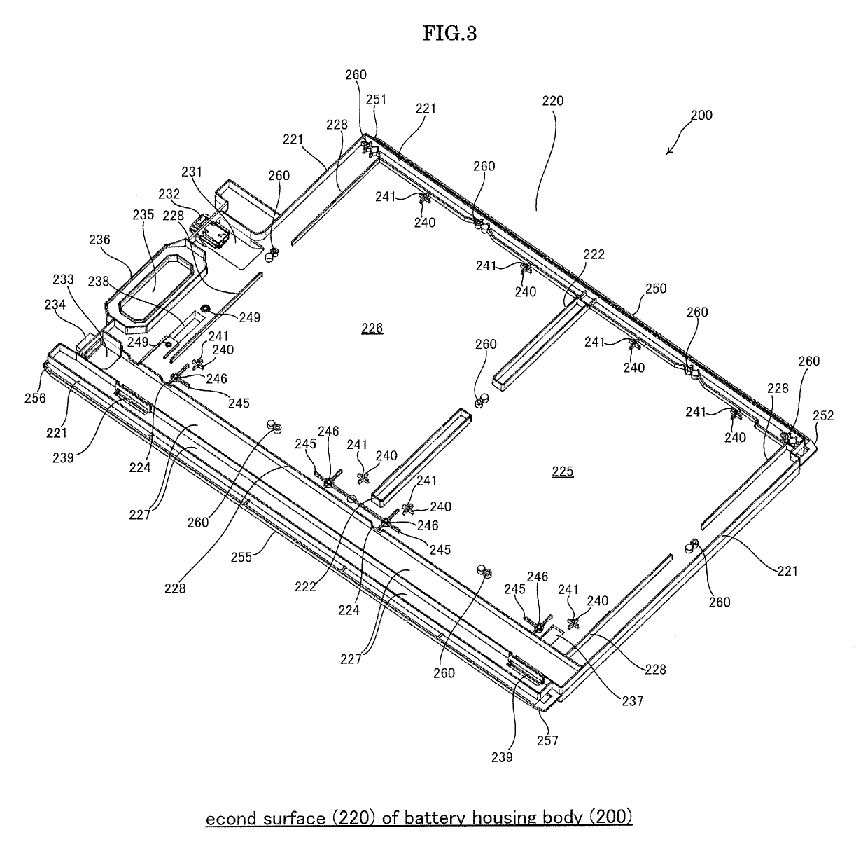

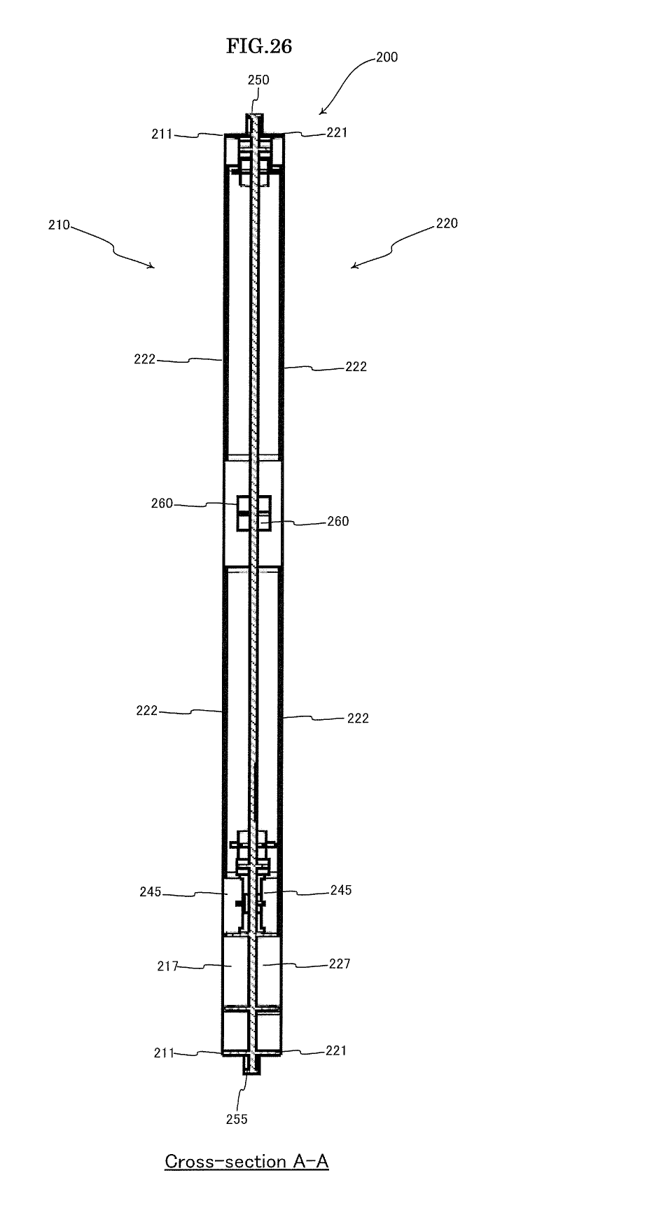

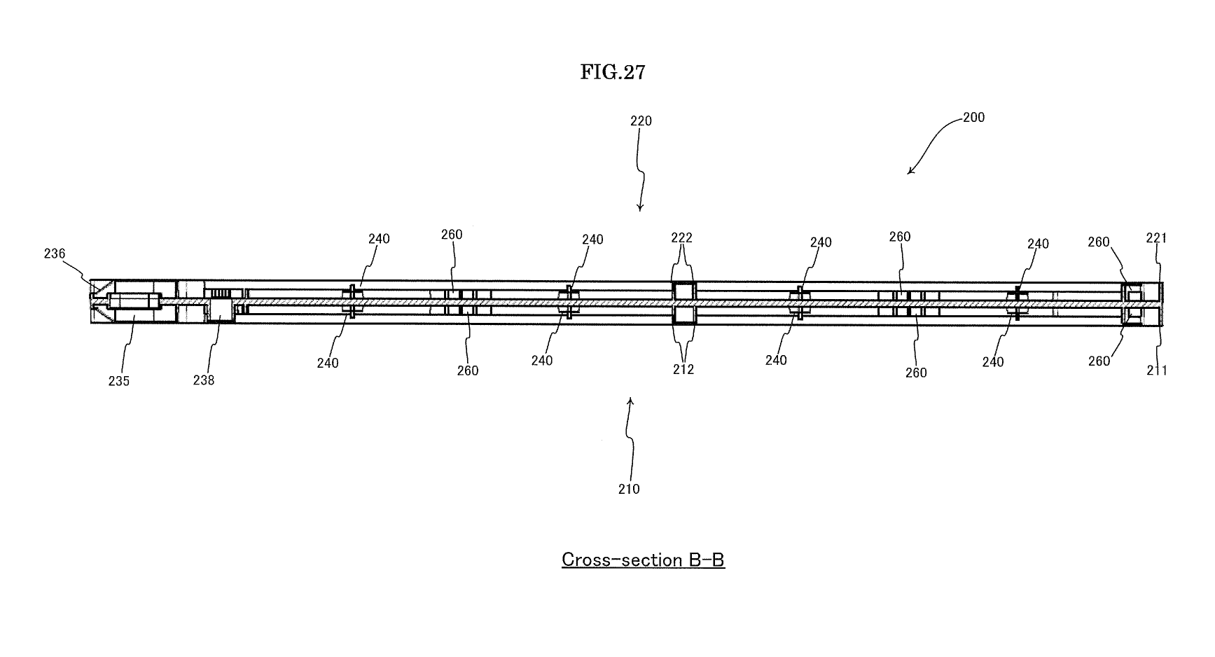

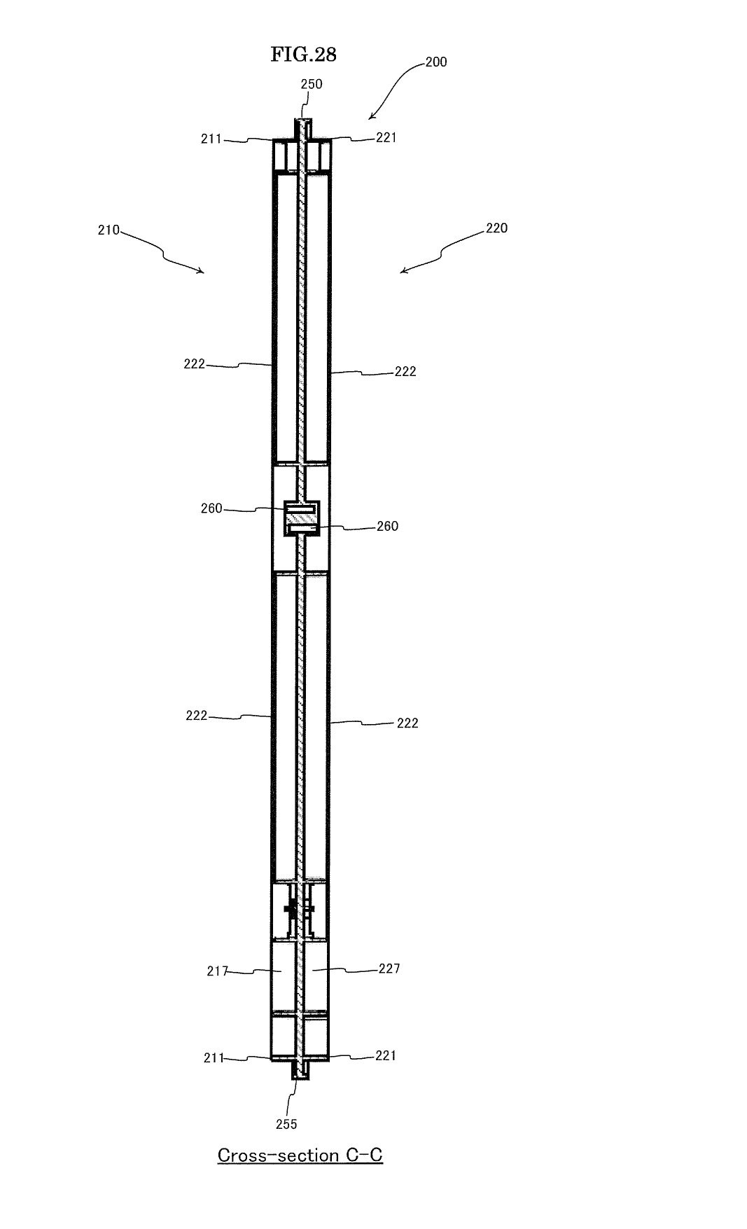

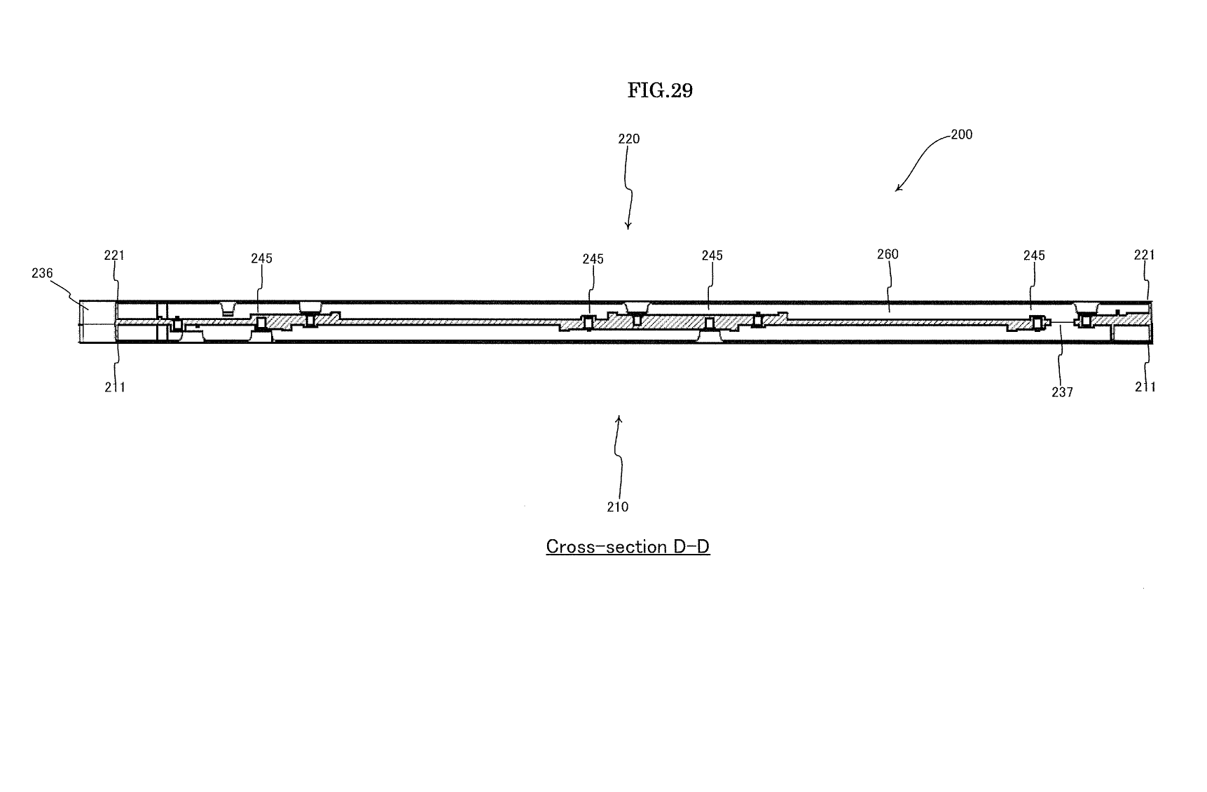

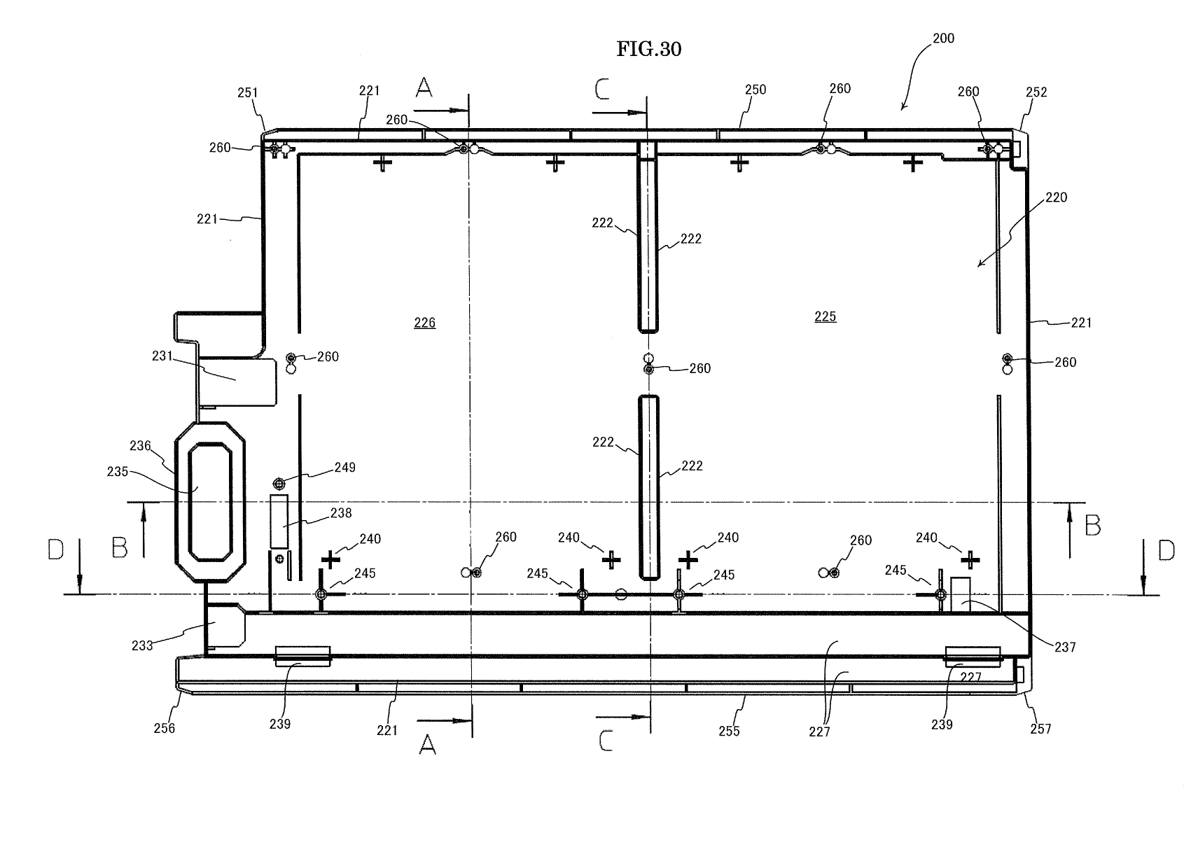

The configuration of the unit battery housing body 200, which houses unit batteries 100 that have been preliminarily processed as described above, will be detailed. FIGS. 2 and 3 are diagrams illustrating the battery housing body 200 that is used in making the battery module according to the embodiment of the present invention. FIGS. 26 to 29 are cross-sectional views of the battery housing body 200. FIG. 30 is a diagram illustrating which part of the battery housing body 200 is shown in the cross-sectional views of FIGS. 26 to 29. FIG. 26 is a cross-sectional view of FIG. 30 taken along A-A. FIG. 27 is a cross-sectional view of FIG. 30 taken along B-B. FIG. 28 is a cross-sectional view of FIG. 30 taken along C-C. FIG. 29 is a cross-sectional view of FIG. 30 taken along D-D.

The battery housing body 200 is a member made of synthetic resin such as ABS. In the battery housing body 200, the unit batteries 100 and other parts are mounted; the unit batteries 100 and other parts are connected together by wiring.

The battery housing body 200 includes a flat-plate base, and peripheral partition wall sections, which are formed in peripheral portions of front and back surfaces, which are two main surfaces of the base. The peripheral partition wall sections includes a first surface peripheral partition wall section, which is provided on the front surface of the base, and a second surface peripheral partition wall section, which is provided on the back surface of the base. FIG. 2 is a perspective view of the front surface of the base of the battery housing body 200. FIG. 3 is a perspective view of the back surface of the base of the battery housing body 200. In the following description, a main surface of the battery housing body on the base front surface's side shown in FIG. 2 is referred to as a first surface 210; a main surface of the battery housing body on the base back surface's side shown in FIG. 3 is referred to as a second surface 220.

On the first surface 210, a first surface peripheral partition wall section 211 is erected vertically on the front surface of the base in such a way as to surround the periphery of the front surface of the base. An inner area surrounded by the first surface peripheral partition wall section 211 is covered with a cover body described later.

In the inner area surrounded by the first surface peripheral partition wall section 211 on the first surface 210, first surface compartmentalization partition wall sections 212 are erected vertically on the front surface of the base, forming a partition wall between adjacent unit batteries 100 within the first surface. Moreover, first surface compartmentalization partition wall sections 218 are provided, too, to partition the space into housing chambers, in which unit batteries 100 are housed, and the like, along with the first surface compartmentalization partition wall sections 212.

On the first surface 210, mainly by the above first surface compartmentalization partition wall sections 212 and first surface compartmentalization partition wall sections 218, the following chambers are formed: a first battery housing chamber 215 and a second battery housing chamber 216, which are housing chambers that house unit batteries 100; and a first surface wiring housing chamber 217, which is a housing chamber that houses a sense line that is used to detect potential of a tab of a unit battery 100.

On the above first surface compartmentalization partition wall sections 218, wire-laying notch sections 214, where the height of the wall section is lower than other portions, are provided, making it possible to lay the sense line or the like from one housing chamber to the other housing chamber.

Similarly, on the second surface 220, a second surface peripheral partition wall section 221 is erected vertically on the back surface of the base in such a way as to surround the periphery of the back surface of the base. An inner area surrounded by the second surface peripheral partition wall section 211 is covered with a cover body described later.

In the inner area surrounded by the second surface peripheral partition wall section 221 on the second surface 220, second surface compartmentalization partition wall sections 222 are erected vertically on the back surface of the base, forming a partition wall between adjacent unit batteries 100 within the second surface. Moreover, second surface compartmentalization partition wall sections 228 are provided, too, to partition the space into housing chambers, in which unit batteries 100 are housed, and the like, along with the second surface compartmentalization partition wall sections 222.

On the second surface 220, mainly by the above second surface compartmentalization partition wall sections 222 and second surface compartmentalization partition wall sections 228, the following chambers are formed: a third battery housing chamber 225 and a fourth battery housing chamber 226, which are housing chambers that house unit batteries 100; and a second surface wiring housing chamber 227, which is a housing chamber that houses a sense line that is used to detect potential of a tab of a unit battery 100.

On the above second surface compartmentalization partition wall sections 228, wire-laying notch sections 224, where the height of the wall section is lower than other portions, are provided, making it possible to lay the sense line or the like from one housing chamber to the other housing chamber.

As described above, the unit battery housing body 200 has two housing chambers for unit batteries 100, i.e. the first battery housing chamber 215 and the second battery housing chamber 216, on the first surface 210; the unit battery housing body 200 has two housing chambers for unit batteries 100, i.e. the third battery housing chamber 225 and the fourth battery housing chamber 226, on the second surface 220. In total, the unit battery housing body 200 has four chambers for unit batteries 100 on both surfaces. If one battery housing chamber houses one unit battery 100, the unit battery housing body 200 of the present embodiment can house up to four unit batteries 100. Incidentally, in the battery module of the present invention, the number of unit batteries 100 that the unit battery housing body 200 can house is not limited to this example. If both sides of the unit battery housing body 200 are utilized, any given number of unit batteries 100 can be housed in the unit battery housing body 200.

In one end portion (or end portion on a side where the first battery housing chamber 215 and the fourth battery housing chamber 226 are disposed) of the unit battery housing body 200, a first through-hole 231 is provided. Between the first through-hole 231 and peripheral partition wall sections of the first surface peripheral partition wall section 211 and second surface peripheral partition wall section 221, a first connector 232 is provided. Through the first connector 232, power supply of unit batteries 100 connected in series can be taken out.

To the first connector 232, a power supply line coming from a unit battery 100 housed on the first surface 210, and a power supply line coming from a unit battery 100 housed on the second surface 220 are connected. Therefore, it is preferred that the above first through-hole 231 be provided so as to pass through between the first surface 210 and the second surface 220.

Moreover, the first through-hole 231 offers space for an operation of connecting a power supply line coming from a unit battery 100 to the first connector 232, and is therefore effective in terms of production efficiency.

Similarly, in one end portion (or end portion on a side where the first battery housing chamber 215 and the fourth battery housing chamber 226 are disposed) of the unit battery housing body 200, a second through-hole 233 is provided. Between the second through-hole 233 and peripheral partition wall sections of the first surface peripheral partition wall section 211 and second surface peripheral partition wall section 221, a second connector 234 is provided. Through the second connector 234, potential information of a tab of each of unit batteries 100 connected in series can be taken out. The potential information of a tab of each of unit batteries 100 enables a battery management circuit unit 500, described later, to manage each unit battery 100.

To the second connector 234, a sense line coming from a unit battery 100 housed on the first surface 210, and a sense line of tab potential of a unit battery 100 housed on the second surface 220 are connected. Therefore, it is preferred that the above second through-hole 233 be provided so as to pass through between the first surface 210 and the second surface 220.

Moreover, the second through-hole 233 offers space for an operation of connecting a sense line coming from a unit battery 100 to the second connector 234, and is therefore effective in terms of production efficiency.

In one end portion (or end portion on a side where the first battery housing chamber 215 and the fourth battery housing chamber 226 are disposed) of the unit battery housing body 200, and between the first through-hole 231 and the second through-hole 233, a grip through-hole 235 is so provided as to pass through between the first surface 210 and the second surface 220. The grip through-hole 235 and an adjacent area thereof function as a grip section 236. The grip section 236 contributes to making it easier to handle the battery module.

In the unit battery housing body 200, between the second battery housing chamber 216 of the first surface 210 and the third battery housing chamber 225 of the second surface 220, a bus-bar-laying through-hole 237 is so provided as to pass through between the first surface 210 and the second surface 220.

In the battery module of the present invention, batteries that are each disposed in the battery housing chambers are connected in series. The bus-bar-laying through-hole 237 makes it possible for one bus bar to stretch between the second battery housing chamber 216 of the first surface 210 and the third battery housing chamber 225 of the second surface 220. As a result, a unit battery 100 housed in the second battery housing chamber 216, and a unit battery 100 housed in the third battery housing chamber 225 are electrically connected together via the bus bar.

In one end portion (or end portion on a side where the first battery housing chamber 215 and the fourth battery housing chamber 226 are disposed) of the unit battery housing body 200, a fuse mounting through-hole 238 is so provided as to pass through between the first surface 210 and the second surface 220. A fuse is inserted in the middle of a power supply line of unit batteries 100 connected in series. The fuse mounting through-hole 238 is used to put the fuse. Near both longitudinal directions of the fuse mounting through-hole 238, two fuse-fixing screw holes 249 are disposed to allow a fuse, terminal, and bus bar to be fixed with screws. The fuse-fixing screw holes 249 are preferably provided in such a way that a metal cylindrical body, whose inner periphery is cut so as to form a screw pattern, is buried in and molded integrally with the unit battery housing body 200 made of resin.

In the unit battery housing body 200, cover-body locking through-holes 239 are provided at two locations so as to pass through between the first surface 210 and the second surface 220. In the unit battery housing body 200, as described later, unit batteries disposed on the first surface 210, and various wires are covered with a first surface cover body 310; unit batteries disposed on the second surface 220, and various wires are covered with a second surface cover body 320. When a cover body is mounted, a locking piece provided on the cover body engages with the above cover-body locking through-hole 239.

In the first battery housing chamber 215, the second battery housing chamber 216, the third battery housing chamber 225, and the fourth battery housing chamber 226, unit battery mounting sections 240 are erected on the front or back surface of the base in such a way as to be substantially in a cross shape.

The unit battery mounting sections 240 are provided at four locations in each housing chamber. The height of the unit battery mounting sections 240 from the front or back surface of the base is almost half the thickness of an electrode stack region 105 of a unit battery 100. Therefore, when unit batteries 100 are set in the housing chambers, the unit batteries 100 become stable.

In a central section of the cross shape of a unit battery mounting section 240, a unit battery alignment projection 241 of a pin-protruding shape is provided. When a unit battery 100 is set in a housing chamber, four unit battery alignment projections 241 are fitted into the alignment through-holes 111 that are provided at four locations of the laminate film outer casing in a peripheral portion of the unit battery 100. In this manner, when the unit battery 100 is mounted on the unit battery housing body 200, the unit battery 100 can be easily aligned, resulting in an improvement in productivity.

In the first battery housing chamber 215, the second battery housing chamber 216, the third battery housing chamber 225, and the fourth battery housing chamber 226, tab member mounting sections 245 are erected on the front or back surface of the base. The tab member mounting sections 245 are provided at two locations in each housing chamber.

The height of the tab member mounting sections 245 from the front or back surface of the base varies depending on the location. Therefore, a bus bar, described later, can be placed in a stable manner. More specifically, the height of a portion of a tab member mounting section 245 where a bus bar is placed is lower than a portion thereof where no bus bar is placed.

In one portion of a tab member mounting section 245, a tab member fixing screw hole 246 is provided. The tab member fixing screw holes 246 are preferably provided in such a way that a metal cylindrical body, whose inner periphery is cut so as to form a screw pattern, is buried in and molded integrally with the unit battery housing body 200 made of resin.

By using the tab member fixing screw holes 246, tabs of unit batteries 100, bus bars, and terminals of sense lines are integrally fixed with screws. Therefore, it is possible to: (1) mechanically fix the unit batteries 100 to the unit battery housing body 200; (2) electrically connect the tabs to the bus bars of the unit battery housing body 200; and (3) electrically connect the tabs and the sense lines.

In one pair of end portions, which face each other, on an outer periphery of the unit battery housing body 200, a first end side protruding guide member 250 and a second end side protruding guide member 255 are provided. The first end side protruding guide member 250 and the second end side protruding guide member 255 are so formed as to have a continuous convex portion extending in a longitudinal direction. The continuous convex portion is designed to slide in a concave section of a rack, which is described later. In this manner, the battery module of the present invention can be housed in the rack of the electric storage device.

In both end portions of the first end side protruding guide member 250, a tapered section 251 and a tapered section 252 are provided. In both end portions of the second end side protruding guide member 255, a tapered section 256 and a tapered section 257 are provided. Therefore, when the battery module is inserted into the concave sections of the rack as described above, it is easy to insert, making it easier to handle. When the battery module is taken out of the concave sections of the rack, each tapered section offers play. Therefore, there is less need to pay attention to the direction in which the battery module is removed, and it becomes easier to handle.

The width of the first end side protruding guide member 250 used is different from the width of the second end side protruding guide member 255 used. Therefore, it is possible to prevent the battery module that takes an unexpected posture from being inserted into or removed from the rack. Incidentally, the width of the first end side protruding guide member 250, or the width of the second end side protruding guide member 255, can be defined as a length seen in a direction perpendicular to the front or back surface of the base.

Both the first end side protruding guide member 250 and the second end side protruding guide member 255 are on side faces, which are different from the front and back surfaces of the base. On the two side faces that face each other, the first end side protruding guide member 250 and the second end side protruding guide member 255 are provided along a planar direction of the front or back surface of the base.

It can be said that the first end side protruding guide member 250 and the second end side protruding guide member 255 are so provided as to protrude from the peripheral partition wall sections (211, 221) or to extend from the base, and that, in each tapered section, a protruding amount of the above protruding, or an extending amount of the extending, varies.

The unit battery housing body 200 adopts a structure in which unit batteries 100 disposed on the first surface 210, and various wires are covered with the first surface cover body 310, and unit batteries 100 disposed on the second surface 220, and various wires are covered with the second surface cover body 320. Therefore, nine cover body fixing screw holes 260, which are used to fix the first surface cover body 310 to the first face 210 with screws, are provided on the first surface 210. Similarly, nine cover body fixing screw holes 260, which are used to fix the second surface cover body 320 to the first face 220 with screws, are provided on the second surface 220. On each surface, nine cover body fixing screw holes 260 are provided. However, all the cover body fixing screw holes 260 may not be used for screw-fixing. Moreover, the number of cover body fixing screw holes 260 provided on one surface is not limited to nine; any number of cover body fixing screw holes 260 can be provided. As illustrated in the diagrams, as for the positions where the cover body fixing screw holes 260 are placed, those on the first surface 210 are so disposed as to be symmetrical to and adjacent to those on the second surface 220. Accordingly, compared with the case where the cover body fixing screw holes 260 are placed at the same positions, it is possible to reduce the thickness required for the screw holes, thereby easily making the battery module thinner.

The following describes a process of mounting unit batteries 100 and other components in the unit battery housing body 200 having the above configuration to make the battery module of the present invention.

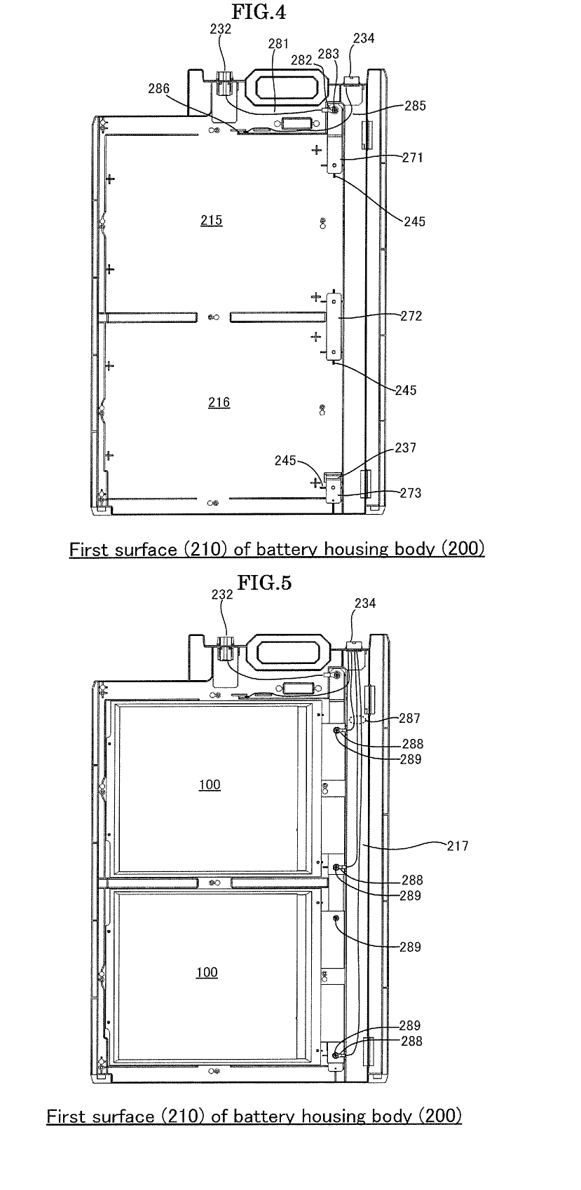

First, with reference to FIGS. 4 and 5, a process of mounting on the first surface 210 of the unit battery housing body 200 will be described.

On a tab member mounting section 245 that is provided between a compartment where the first connector 232 and the second connector 234 are provided and a compartment of the first battery housing chamber 215, a first bus bar 271 is placed. On the first bus bar 271, two through-holes are provided at locations that face the tab member fixing screw holes 246 when being placed on the tab member mounting section 245.

In a hole of a power supply line terminal 282 of a power supply line 281, and in a through-hole (or through-hole on the first connector's side) of the first bus bar 271, and in a tab member fixing screw hole 246, a screw 283 is inserted. Then, the power supply line terminal 282, the first bus bar 271, and the tab member fixing screw hole 246 are integrally fastened with the screw 283. In this manner, the components are mechanically fixed and electrically connected.

An end portion of the power supply line 281 where no power supply line terminal 282 is provided is electrically connected to a terminal, not shown, that is enclosed in a casing of the first connector 232.

In a space formed by the first surface compartmentalization partition wall sections 212, a thermistor 286 is disposed. A thermistor connection line 285 of the thermistor 286 is electrically connected to a terminal, not shown, of the second connector 234.

The thermistor 286 detects a temperature inside the battery module; a detection signal thereof is transmitted to the battery management circuit unit 500 via the second connector 234. In the battery module of the present invention, the battery management circuit unit 500 obtains temperature data from the thermistor 286, and carries out control processes, such as discharge stop, based on the data.

Then, on a tab member mounting section 245 that is provided between a compartment of the first battery housing chamber 215 and a compartment of the second battery housing chamber 216, a second bus bar 272 is placed. On the first bus bar 272, two through-holes are provided at locations that face the tab member fixing screw holes 246 when being placed on the tab member mounting section 245.

Then, on a tab member mounting section 245 that is provided in the second battery housing chamber 216 on the first surface 210, and on a tab member mounting section 245 that is provided in the third battery housing chamber 225 on the second surface 220, a third bus bar 273 is mounted. The cross section of the third bus bar 273 is substantially in a Z-shape. Through the bus-bar-laying through hole 237, the third bus bar 273 is so mounted as to stretch between the first surface 210 and the second surface 220. On the third bus bar 273, two through-holes are provided at locations that face the tab member fixing screw holes 246 when being placed at a predetermined position.

Then, as shown in FIG. 5, in the first battery housing chamber 215 and the second battery housing chamber 216, unit batteries 100 are respectively placed. In this process, the unit battery alignment projections 241 of the unit battery housing body 200 are inserted into the alignment through-holes 111 of the unit batteries 100. Therefore, the unit batteries 100 easily can be placed on the unit battery housing body 200.

Incidentally, when the unit batteries 100 are placed in the housing chambers, two-sided tap 150 is utilized, and is affixed to the housing chambers when the unit batteries 100 are fixed.

Then, as shown in FIG. 5, in a hole of a sense line terminal 288 of a sense line 287, and in a hole (a through-hole 135 of a negative electrode pulled-out tab 130, or a through-hole 145 of an additional tab member 140) of a tab member, and in a through-hole of a bus bar, and in a tab member fixing screw hole 246, a screw 289 is inserted. Then, the sense line terminal 288, the bus bar, the tab member, and the tab member fixing screw hole 246 are integrally fastened with the screw 289. In this manner, the components are mechanically fixed and electrically connected.

An end portion of the sense line 287 where no sense line terminal 288 is provided is electrically connected to a terminal, not shown, of the second connector 234. Potential of the tab that is detected at the sense line terminal 288 is transmitted to the battery management circuit unit 500 via the second connector 234. The battery management circuit unit 500 obtains potential data from each tab, and carries out control processes, such as discharge stop, based on the data.

In order to lay the sense line 287 between the sense line terminal 288 and the second connector 234, the first surface wiring housing chamber 217 is used.

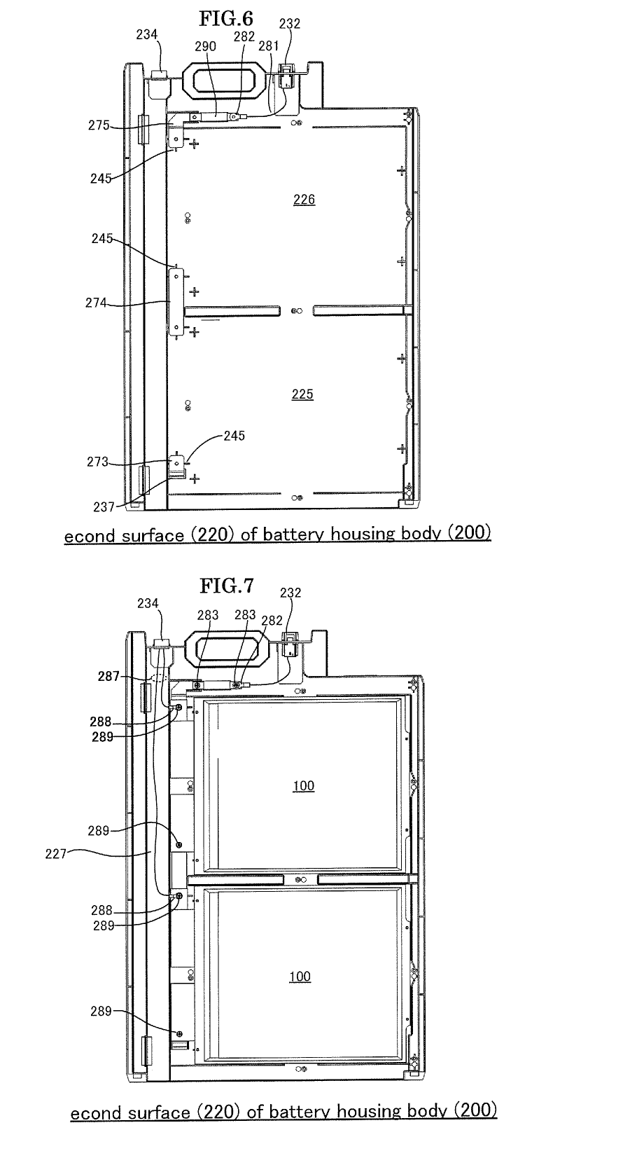

With reference to FIGS. 6 and 7, a process of mounting various components on the second surface 220 of the unit battery housing body 200 will be described.

First, on a tab member mounting section 245 that is provided between a compartment of the third battery housing chamber 255 and a compartment of the fourth battery housing chamber 226, a fourth bus bar 274 is placed. On the fourth bus bar 274, two through-holes are provided at locations that face the tab member fixing screw holes 246 when being placed on the tab member mounting section 245.

On a tab member mounting section 245 that is provided between a compartment of the fourth battery housing chamber 226 and a compartment where the first connector 232 and the second connector 234 are provided, a fifth bus bar 275 is provided. On the fifth bus bar 275, two through-holes are provided: One through-hole is placed so as to face a tab member fixing screw hole 246 on the tab member mounting section 245, and the other is so placed as to face a fuse-fixing screw hole 249.

Then, in a fuse mounting through-hole 238, a fuse 290 is placed. In one terminal hole of the fuse 290, in a through-hole of the fifth bus bar 275, and in a fuse-fixing screw hole 249, a screw 283 is inserted. The fuse 290, the fifth busbus bar bar 275, and the tab member fixing screw hole 246 are integrally fastened with the screw 283. In this manner, the components are mechanically fixed and electrically connected.

In the other terminal hole of the fuse 290, in a power line terminal 282 of a power supply line 281, and in a fuse-fixing screw hole 249, a screw 283 is inserted. The fuse 290, the power line terminal 282, and the fuse-fixing screw hole 249 are integrally fastened with the screw 283. In this manner, the components are mechanically fixed and electrically connected.

An end portion of the power supply line 281 where no power line terminal 282 is provided is electrically connected to a terminal, not shown, of the first connector 232.

Then, as shown in FIG. 7, in the third battery housing chamber 225 and the fourth battery housing chamber 226, unit batteries 100 are respectively placed. In this process, the unit battery alignment projections 241 of the unit battery housing body 200 are inserted into the alignment through-holes 111 of the unit batteries 100. Therefore, the unit batteries 100 easily can be placed on the unit battery housing body 200.

Incidentally, when the unit batteries 100 are placed in the housing chambers, two-sided tap 150 is utilized, and is affixed to the housing chambers when the unit batteries 100 are fixed.

Then, as shown in FIG. 7, in a hole of a sense line terminal 288 of a sense line 287, and in a hole (a through-hole 135 of a negative electrode pulled-out tab 130, or a through-hole 145 of an additional tab member 140) of a tab member, and in a through-hole of a bus bar, and in a tab member fixing screw hole 246, a screw 289 is inserted. Then, the sense line terminal 288, the bus bar, the tab member, and the tab member fixing screw hole 246 are integrally fastened with the screw 289. In this manner, the components are mechanically fixed and electrically connected.

An end portion of the sense line 287 where no sense line terminal 288 is provided is electrically connected to a terminal, not shown, of the second connector 234. Potential of the tab that is detected at the sense line terminal 288 is transmitted to the battery management circuit unit 500 via the second connector 234. The battery management circuit unit 500 obtains potential data from each tab, and carries out control processes, such as discharge stop, based on the data.

In order to lay the sense line 287 between the sense line terminal 288 and the second connector 234, the second surface wiring housing chamber 227 is used.

As described above, various components are mounted on the unit battery housing body 200. Voltage from the four unit batteries 100 connected in series can be taken out through the first connector 232. The potential of the tab of each unit battery 100, and the temperature detected by the thermistor can be taken out through the second connector 234.

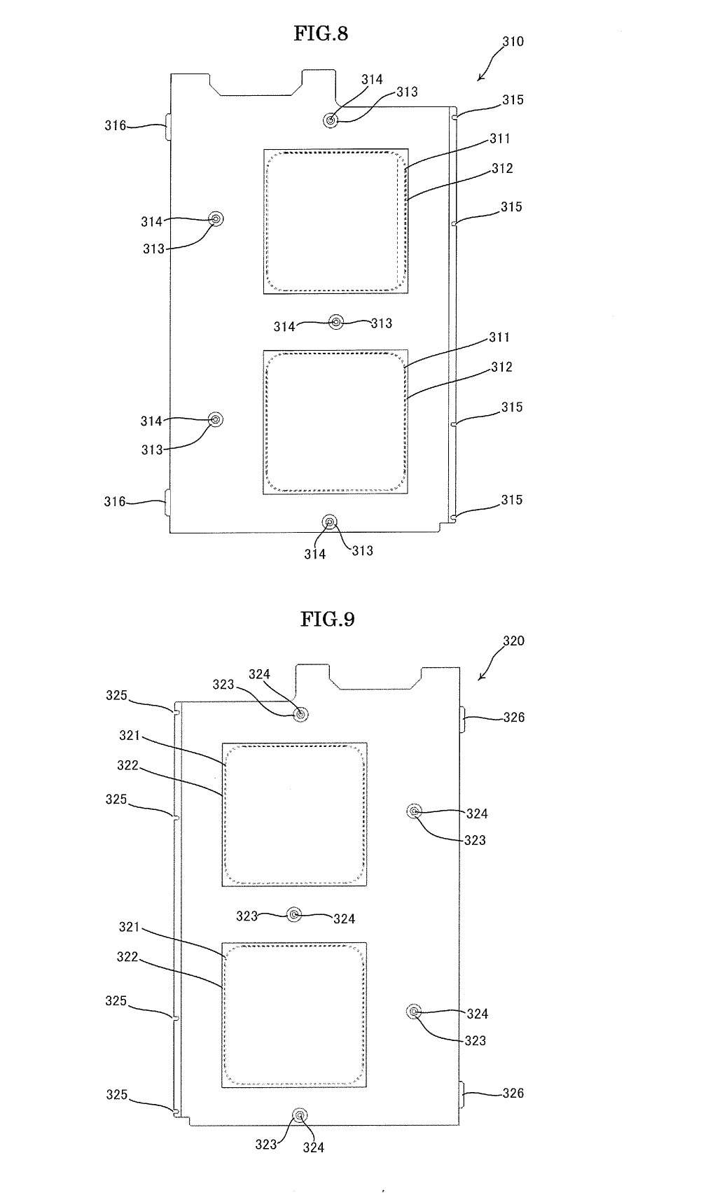

The following describes cover bodies that cover the unit battery housing body 200 on which various components are mounted as described above. FIG. 8 is a diagram illustrating the first surface cover body 310 that is used in making the battery module according to the embodiment of the present invention. FIG. 9 is a diagram illustrating the second surface cover body 320. The first surface cover body 310 and the second surface cover body 320 have the same configuration except that the first surface cover body 310 is mirror-symmetrical to the second surface cover body 320. Therefore, the first surface cover body 310 will be illustrated below.

The first surface cover body 310 is a cover member made of aluminum to cover a unit battery 100, power supply line 281, sense line 287, thermistor 286, and other components that are housed on the first surface 210 of the unit battery housing body 200.

Raising of the first surface cover body 310 (battery-pressing raised sections 311) has been performed to press the unit battery 100 housed in the first battery housing chamber 215 and the unit battery 100 housed in the second battery housing chamber 216 when the first surface cover body 310 is mounted on the first surface 210. Because of the battery-pressing raised sections 311, the surfaces that press the unit batteries 100 are defined as pressing surfaces 312. The pressing surfaces 312 that are based on the battery-pressing raised sections 311 press electrode stack regions 105 of the unit batteries 100 when the first surface cover body 310 is mounted, thereby suppressing bulging of unit batteries 100 and the like, which might occur over time as the unit batteries 100 are used, and extending the life of the unit batteries 100.

Incidentally, the battery-pressing raised sections 311 are formed in a direction in which the battery-pressing raised sections 311 protrude from the paper surface of FIG. 8. Dotted lines indicate how the back surface of the first surface cover body 310 is formed.

On the first surface cover body 310, screw holes 314 and notch sections 315 are formed at locations that face the cover body fixing screw holes 260 when the first surface cover body 310 is mounted on the first surface 210. Around the screw holes 314, screw-hole raised sections 313 are provided. Therefore, the first surface cover body 310 is fixed in such a way that regions of the first surface cover body 310 around the screw holes 314 come in close contact with the first surface 210. Incidentally, the screw-hole raised sections 313 are formed in a direction in which the screw-hole raised sections 313 protrude from the paper surface of FIG. 8.

On one side of the first surface cover body 310, locking pieces 316 are provided; the locking pieces 316 engage with two cover-body locking through-holes 239 provided on the unit battery housing body 200.

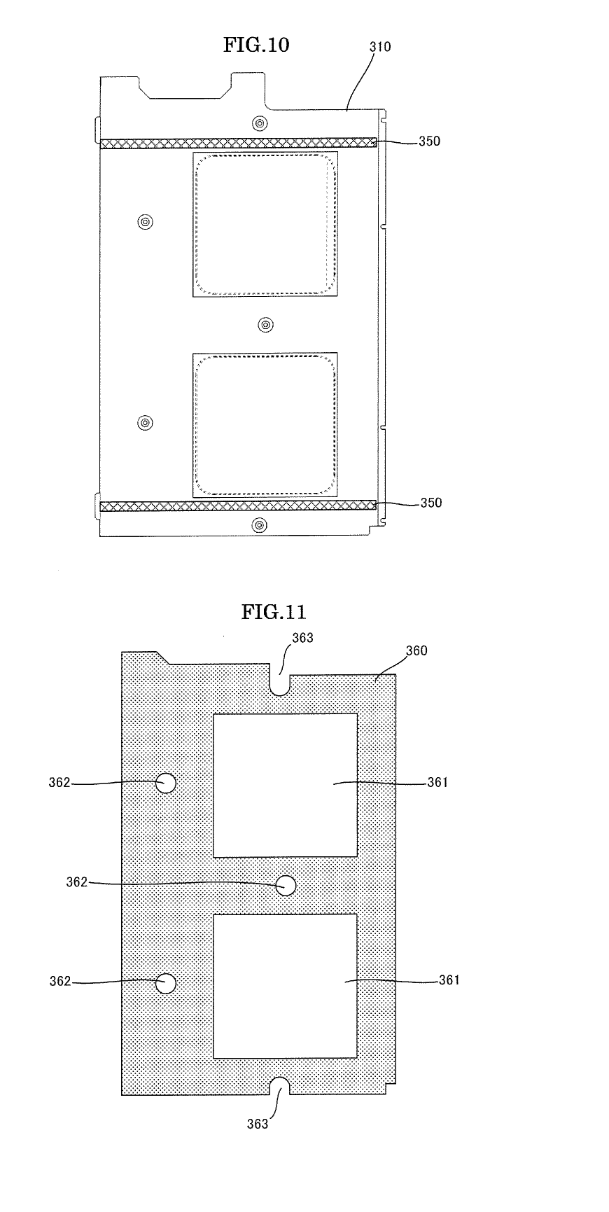

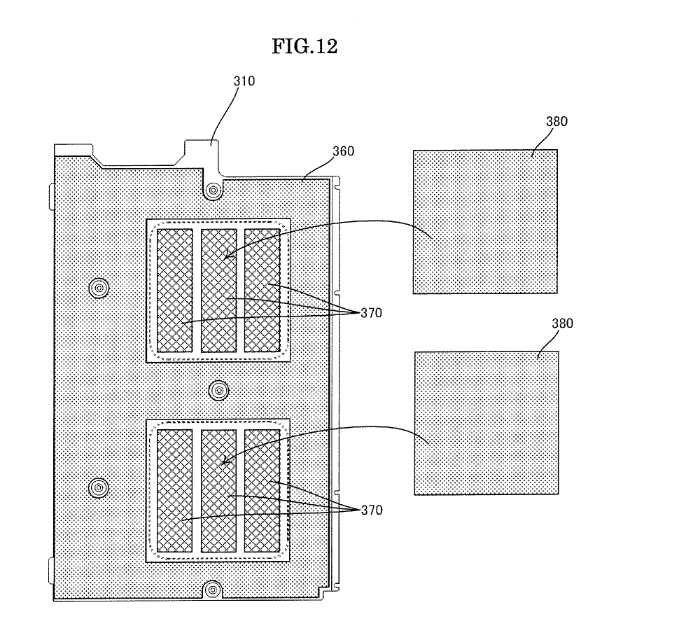

Then, a process of giving insulation properties to the above first surface cover body 310 to protect the unit batteries 100 and wires housed in the unit battery housing body 200 will be described. First, as shown in FIG. 10, to the first surface cover body 310, two strips of two-sided tape 350 are affixed.

Then, with the two strips of two-sided tape 350, a cover body insulation sheet 360 shown in FIG. 11 is affixed to the first surface cover body 310. On the cover body insulation sheet 360, the following are provided: pressing-surface punched sections 361, which correspond to the pressing surfaces 312 of the first surface cover body 310; screw-hole punched sections 362, which correspond to the screw holes 314 of the first surface cover body 310; and screw-hole notch sections 363, which correspond to the notch sections 315 of the first surface cover body 310.

To the two pressing surfaces 312 of the first surface cover body 310, three strips of two-sided tape 370 are affixed. With the three strips of two-sided tape 370, a pressing-surface insulation sheet 380 is affixed to each pressing surface 312.

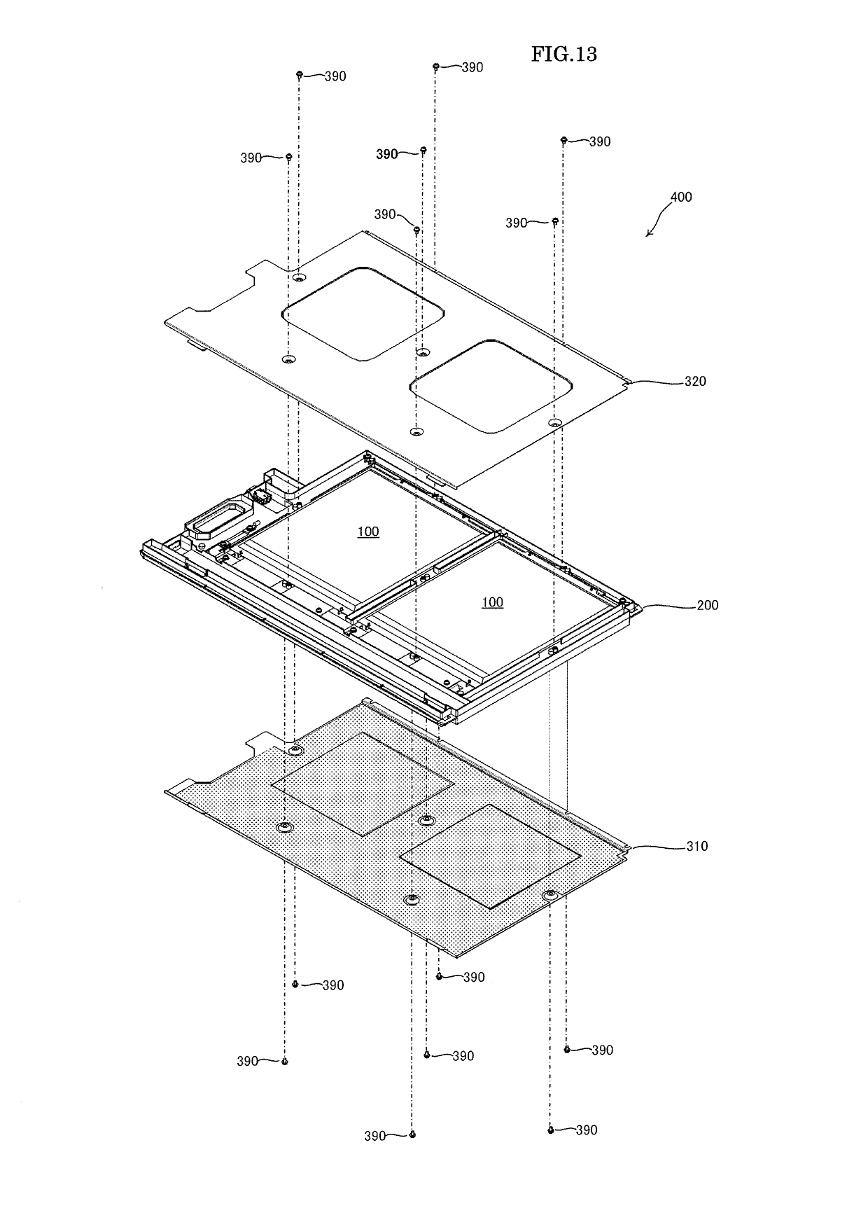

Then, as shown in FIG. 13, the first surface cover body 310 and the second surface cover body 320, to which insulation sheets are affixed, are mounted in such a way that the unit battery housing body 200 is sandwiched between the first surface cover body 310 and the second surface cover body 320. When the first surface cover body 310 and the second surface cover body 320 are mounted on the unit battery housing body 200, the locking pieces 316 and 326 of both the bodies engage with the cover-body locking through-holes 239.

Incidentally, when the unit battery housing body 200 is held between the first surface cover body 310 and the second surface cover body 320, the two-sided tape 150 provided on the unit batteries 100 is used to affix the pressing-surface insulation sheets 380 to the unit batteries 100.

From the first surface cover body 310's side, with seven screws 390, the first surface cover body 310 and the cover body fixing screw holes 260 of the unit battery housing body 200 are fastened. Similarly, from the second surface cover body 320's side, with seven screws 390, the second surface cover body 320 and the cover body fixing screw holes 260 of the unit battery housing body 200 are fastened.

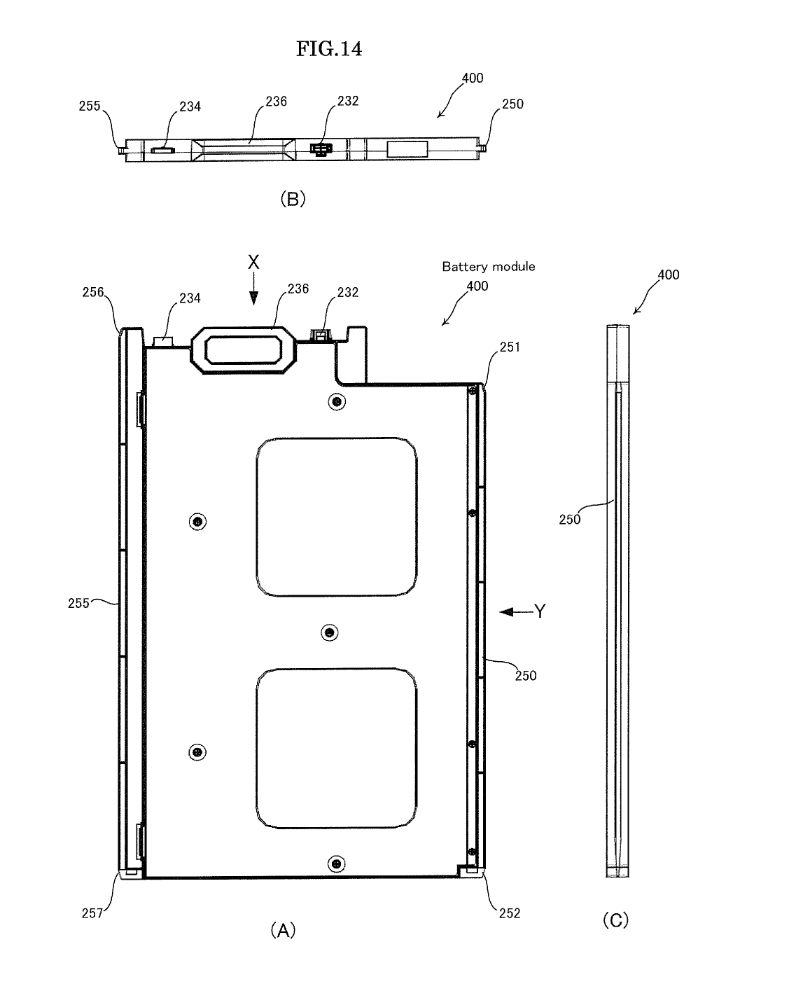

FIG. 14 is a diagram showing a battery module 400 according to the embodiment of the present invention, which is produced by the above processes. FIG. 14(A) is a view of a main surface of the battery module 400. FIG. 14(B) is a view of the battery module 400 when seen from a direction of X of FIG. 14(A). FIG. 14(C) is a view of the battery module 400 when seen from a direction of Y of FIG. 14(A).

As for the appearance of the battery module 400, the first connector 232, from which power supply of the batteries are taken out, and the second connector 234, from which monitored data such as the tab potential of the batteries and temperatures are taken out, are exposed.

In one pair of end portions, which face each other, of the battery module 400, a first end side protruding guide member 250 and a second end side protruding guide member 255 are disposed: in both end portions of each member, tapered portions are provided. The protruding guide members are used when the battery module 400 is mounted on a rack of an electric storage device as described later.

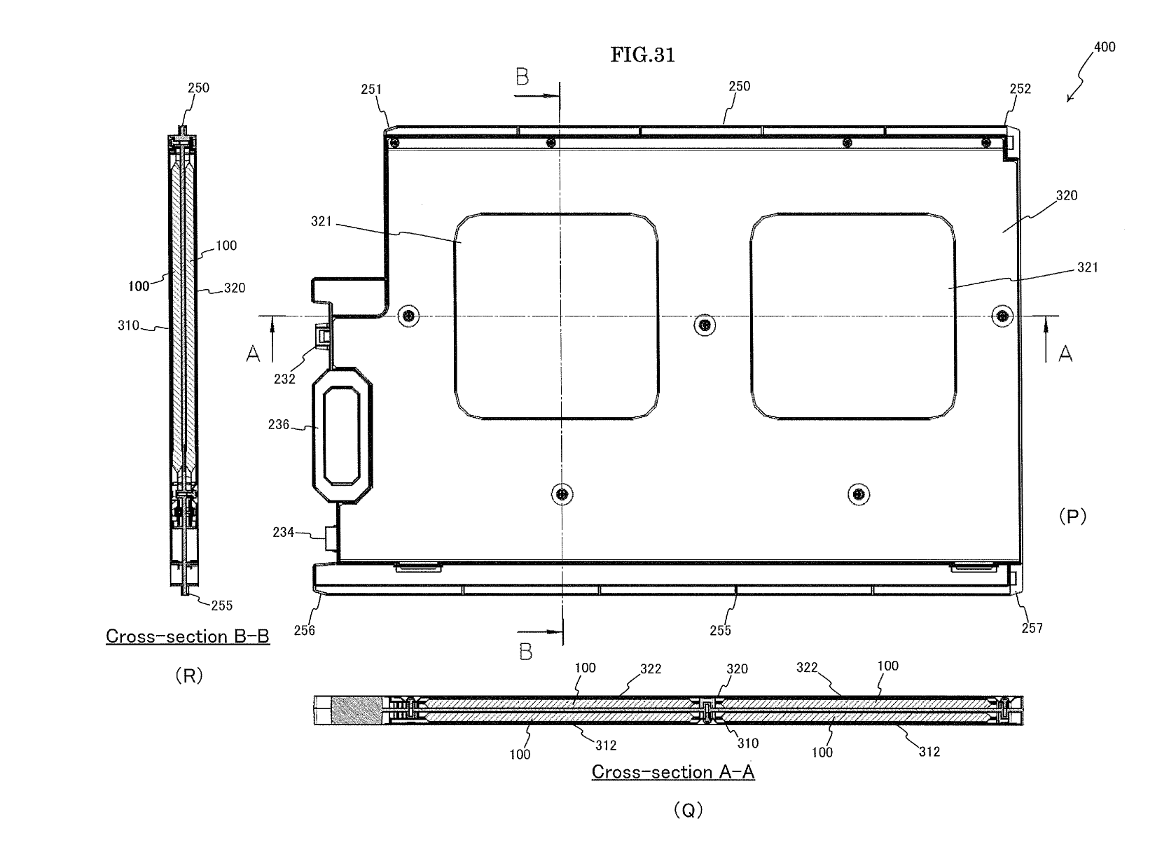

FIG. 31 is a cross-sectional view of the battery module 400 according to the embodiment of the present invention. In FIG. 31, FIG. 31(Q) is a view of an A-A cross section of FIG. 31(P); FIG. 31(R) is a view of a B-B cross section of FIG. 31(P).

In the above battery module 400 of the present invention, the peripheral partition wall sections (211, 221) keep the rigidity of the battery module 400 high. Therefore, it is possible to provide the battery module 400 that easily can be made thinner and maintain reliability.

Moreover, the compartmentalization partition wall sections (212, 222), which are provided between the adjacent unit batteries 100 within a surface, keep troubles of one battery such as abnormal heating from affecting the other battery. Therefore, it is possible to provide the battery module that can easily ensure a high level of flame retardancy. Moreover, the compartmentalization partition wall sections (212, 222, 218, 228) provided on both surfaces of battery mounting planes help to keep the rigidity of the battery module 400 high. Therefore, it is possible to provide the battery module 400 that easily can be made thinner and maintain reliability.

Moreover, by the cover bodies (310, 320) that press the unit batteries 100 in a sheet thickness direction, deformation of the unit batteries 100 can be effectively suppressed. Therefore, it is possible to provide the battery module 400 that easily can maintain excellent battery characteristics such as repeated charge-and-discharge performance. In addition, the peripheral rib sections provided on both sides of the battery mounting plane, and the compartmentalization partition wall sections help to keep the rigidity of the battery module high. Therefore, it is possible to provide the battery module that easily can be made thinner and maintain reliability.

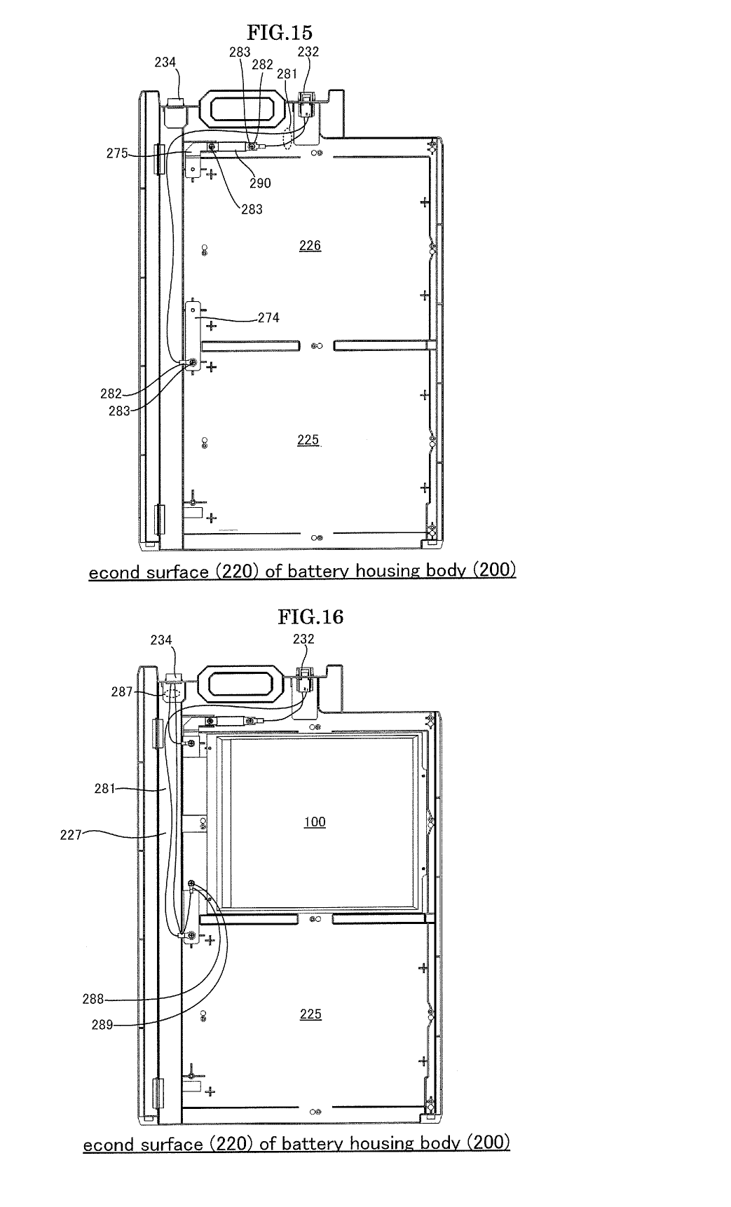

The following describes a case where all the housing chambers of the unit battery housing body 200 are not used for mounting the unit batteries 100, with reference to FIGS. 15 to 17.

In the battery module 400 described above, the unit batteries 100 are housed in all the four housing chambers of the unit battery housing body 200, and are connected in series; through the first connector 232, the voltage four times larger than a unit battery 100 is taken out.

However, in a charging device that uses the voltage of the battery modules 400 connected in series, the voltage that is a multiple of four times that of the unit battery 100 is not always used. Accordingly, for example, what is prepared is one in which only one unit battery 100 is mounted in the battery module 400 so that the voltage that is one times that of the unit battery 100 is taken out; it is therefore possible to support various charging devices.

The following describes a battery module 400 in which a unit battery 100 is mounted in only one housing chamber of the unit battery housing body 200 so that the same voltage as that of the unit battery 100 is taken out, with reference to FIGS. 15 to 17. Hereinafter, the unit battery housing body 200 and unit battery 100 used are the same as those described above, and therefore will not be described again.

FIGS. 15 and 16 are diagrams illustrating a process of mounting various components of the battery module 400 from which the same voltage as that of the above unit battery 100 is taken out. In the battery module 400, a unit battery 100 is housed in the fourth battery housing chamber 226 on the second surface 220 to form the battery module 400.

First, on a tab member mounting section 245 that is provided between a compartment of the fourth battery housing chamber 226 and a compartment in which the first connector 232 and the second connector 234 are provided, a fifth bus bar 275 is placed. On the fifth bus bar 275, two through-holes are provided: One through-hole is provided at a location that faces the tab member fixing screw hole 246 on the tab member mounting section 245, and the other through-hole is provided at a location that faces the fuse-fixing screw hole 249.

Then, in the fuse mounting through-hole 238, the fuse 290 is placed. In one terminal hole of the fuse 290, in the through-hole of the fifth bus bar 275, and in the fuse-fixing screw hole 249, a screw 283 is inserted. The fuse 290, the fifth bas bar 275, and the tab member fixing screw hole 246 are integrally fastened with the screw 283. In this manner, the components are mechanically fixed and electrically connected.

In the other terminal hole of the fuse 290, in the power line terminal 282 of the power supply line 281, and in the fuse-fixing screw hole 249, a screw 283 is inserted. The fuse 290, the power line terminal 282, and the fuse-fixing screw hole 249 are integrally fastened with the screw 283. In this manner, the components are mechanically fixed and electrically connected.

An end portion of the power supply line 281 where no power line terminal 282 is provided is electrically connected to a terminal, not shown, of the first connector 232.

Then, on a tab member mounting section 245 that is provided between a compartment of the third battery housing chamber 255 and a compartment of the fourth battery housing chamber 226, a fourth bus bar 274 is placed. On the fourth bus bar 274, two through-holes are provided at locations that face the tab member fixing screw holes 246 when being placed on the tab member mounting section 245.

As shown in FIG. 15, in a hole of the power line terminal 282 of the power supply line 281, in a through-hole of the fourth bus bar 274, and in the tab member fixing screw hole 246, a screw 283 is inserted. Then, the power line terminal 282, the fourth bus bar 274, and the tab member fixing screw hole 246 are integrally fastened with the screw 283. In this manner, the components are mechanically fixed and electrically connected. An end portion of the power supply line 281 where no power line terminal 282 is provided is electrically connected to a terminal, not shown, of the first connector 232. In order to lay the power supply line 281, the second surface wiring housing chamber 227 is used.

Then, as shown in FIG. 16, only in the fourth battery housing chamber 226, a unit battery 100 is placed. In this process, the unit battery alignment projections 241 of the unit battery housing body 200 are inserted into the alignment through-holes 111 of the unit battery 100. Therefore, the unit battery 100 easily can be placed on the unit battery housing body 200.

Incidentally, when the unit battery 100 is placed in the housing chamber, two-sided tap 150 is utilized, and is affixed to the housing chamber when the unit battery 100 is fixed.

Then, as shown in FIG. 16, in a hole of the sense line terminal 288 of the sense line 287, and in a hole (the through-hole 135 of the negative electrode pulled-out tab 130) of a tab member, and in the through-hole of the fourth bus bar 274, and in the tab member fixing screw hole 246, a screw 289 is inserted. Then, the sense line terminal 288, the fourth bus bar 274, the tab member, and the tab member fixing screw hole 246 are integrally fastened with the screw 289. In this manner, the components are mechanically fixed and electrically connected.

An end portion of the sense line 287 where no sense line terminal 288 is provided is electrically connected to a terminal, not shown, of the second connector 234. Potential of the tab that is detected at the sense line terminal 288 is transmitted to the battery management circuit unit 500 via the second connector 234. The battery management circuit unit 500 obtains potential data from each tab, and carries out control processes, such as discharge stop, based on the data.

In order to lay the sense line 287 between the sense line terminal 288 and the second connector 234, the second surface wiring housing chamber 227 is used.

In that manner, various components are mounted on the unit battery housing body 200. As a result, the same voltage as that of one unit battery 100 can be take out through the first connector 232. The potential of the tab of one unit battery 100 mounted, and the temperature detected by the thermistor can be taken out through the second connector 234.

When cover bodies are provided on the above unit battery housing body 200, the first surface 210 is blank because no unit batteries 100 are placed. Therefore, as for the first surface cover body 310 that is provided on the first surface 210, the cover body insulation sheet 360 can be omitted.

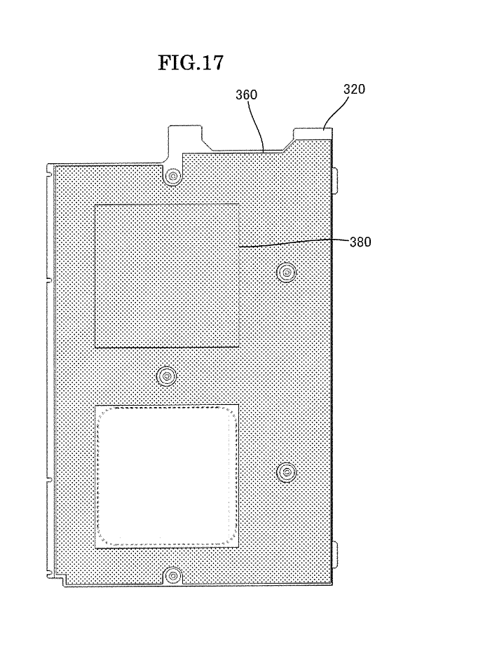

On the first surface 210, because the unit battery 100 is mounted only in the fourth battery housing chamber 226, and the third battery housing chamber 225 is blank, it is possible to use a second surface cover body 320 to which the cover body insulation sheet 360 and only one pressing-surface insulation sheet 380 are affixed as shown in FIG. 17.

The above unit battery housing body 200 and cover bodies are used in a similar way to that in FIG. 13 to cover the unit battery housing body 200. In this manner, it is possible to form the battery module 400 from which the same voltage as that of the unit battery 100 is taken out.

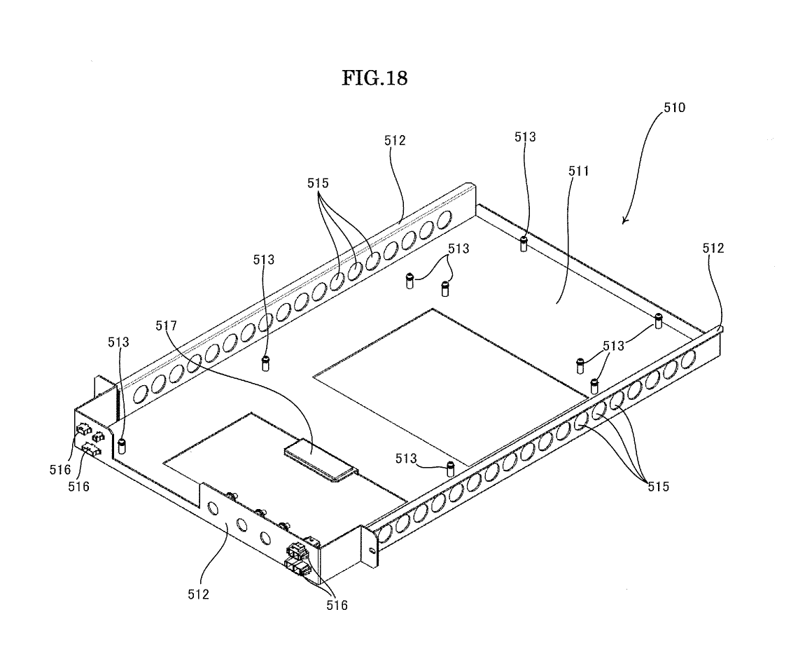

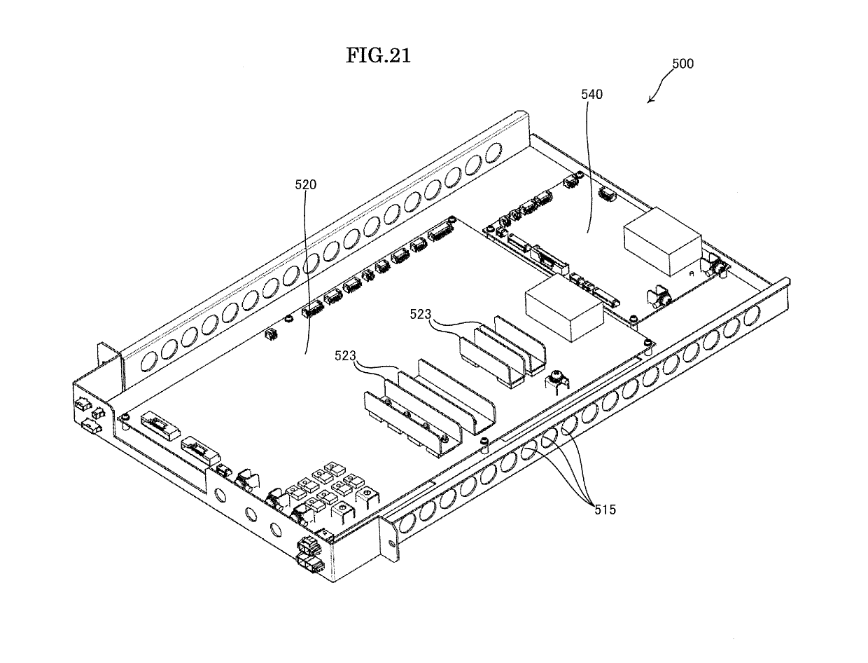

The following provides an outline of the configuration of the battery management circuit unit 500 that manages the above battery module 400 according to the present invention. FIGS. 18, 19, and 20 are diagrams illustrating a production process of the battery management circuit unit 500. FIG. 21 is a diagram showing the battery management circuit unit 500.

In FIG. 18, a chassis 510 on which the boards and connectors that constitute the battery management circuit unit 500 are mounted includes a bottom surface section 511, and side wall sections 512, which are so provided as to extend vertically from the bottom surface section 511. On the bottom surface section 511, a plurality of screw hole sections 513 are erected vertically from the bottom surface section 511.

On two side wall sections 512, which face each other, of the chassis 510, a plurality of ventilation holes 515 are provided along a longitudinal direction of the side wall sections 512. Between the two side wall sections 512 facing each other, the ventilation holes 515 makes it easier for a steam of air to flow easily.

On the side wall sections 512 of the chassis 510, connectors 516 are mounted to be electrically connected to the battery module 400. On the bottom surface section 511, a heat dissipation sheet 517 is mounted to release heat generated from the boards.

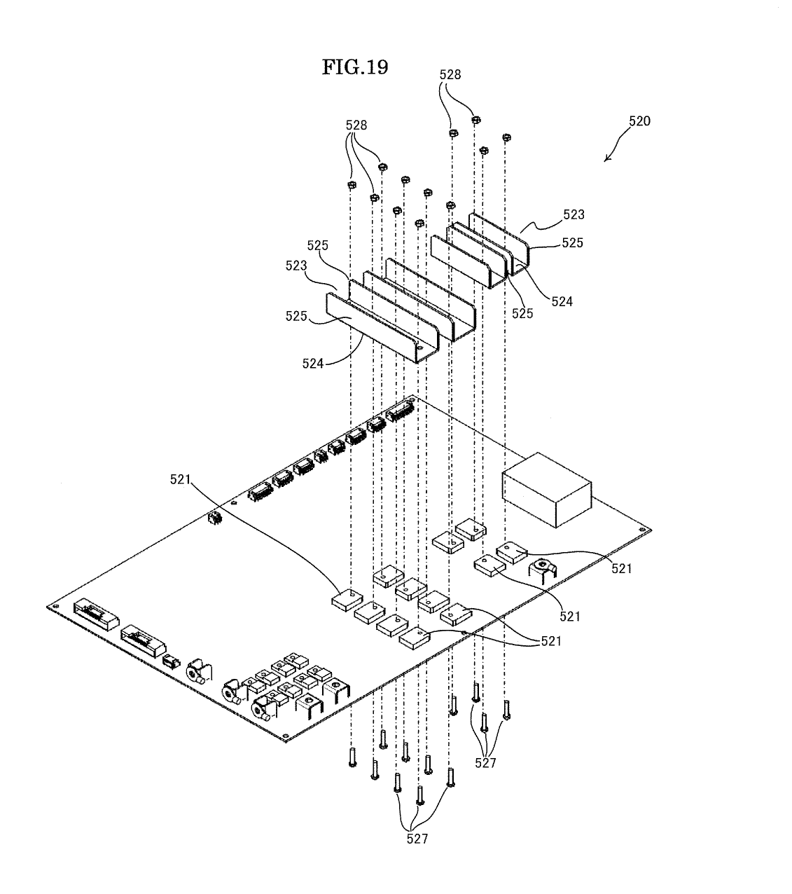

FIG. 19 shows a production process of a first circuit board 520. On the first circuit board 520, semiconductor components 521, such as FETs, which generate heat when in use, are mounted. On the semiconductor components 521, a heat sink 523 is mounted with bolts 527 and nuts 528 as shown in the diagram: the heat sink 523 includes a bottom surface section 524, and fins 525, which are so provided as to extend vertically therefrom.

Incidentally, according to the present embodiment, when the heat sink 523 is mounted on the semiconductor components 521, fixing means, such as bolts 527 and nuts 528, are used. Instead, when the heat sink 523 is mounted on the semiconductor components 521, both may be bonded together with an adhesive; or, when the heat sink 523 is mounted on the semiconductor components 521, the bolts 527 and nuts 528 and the adhesive may be used together.

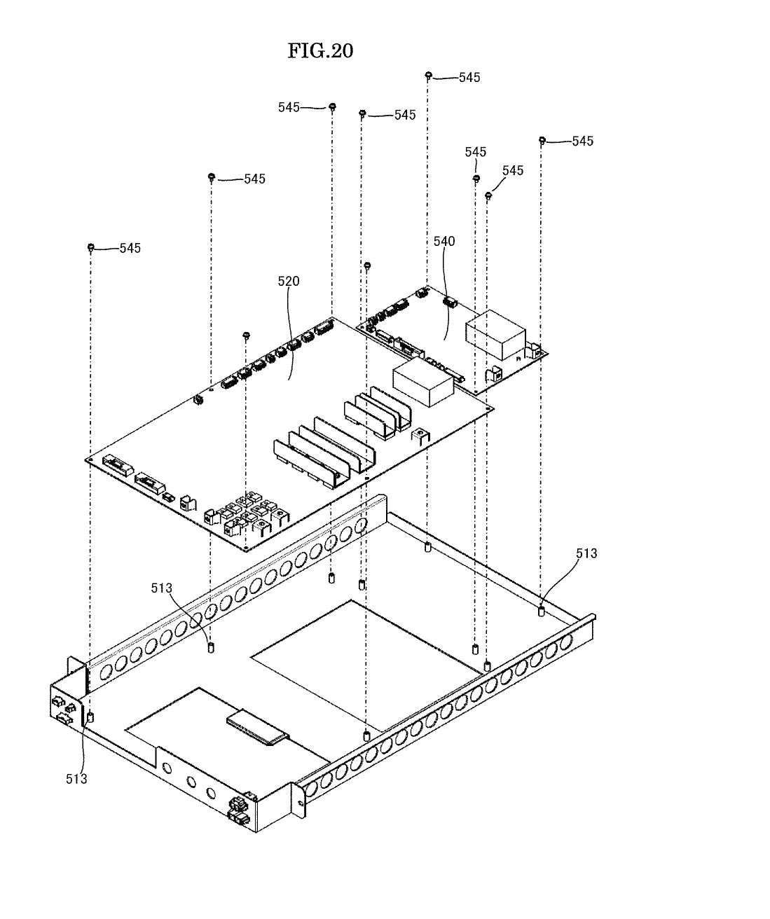

FIG. 20 shows a process of fixing the first circuit board 520 and a second circuit board 540 to the chassis 510 with screws 545 by using screw hole sections 513. FIG. 21 shows the battery management circuit unit 500 completed.

As shown in FIG. 21, a direction perpendicular to the two side wall sections 512 which face each other and on which the ventilation holes 515 are provided is parallel to a longitudinal direction of the fins 525 of the heat sinks 523. Therefore, the stream of air going into, or coming out of, the ventilation holes 515 helps to cool the fins 525 of the heat sinks 523 in an efficient manner, making it possible to improve the efficiency of the semiconductor components 521.

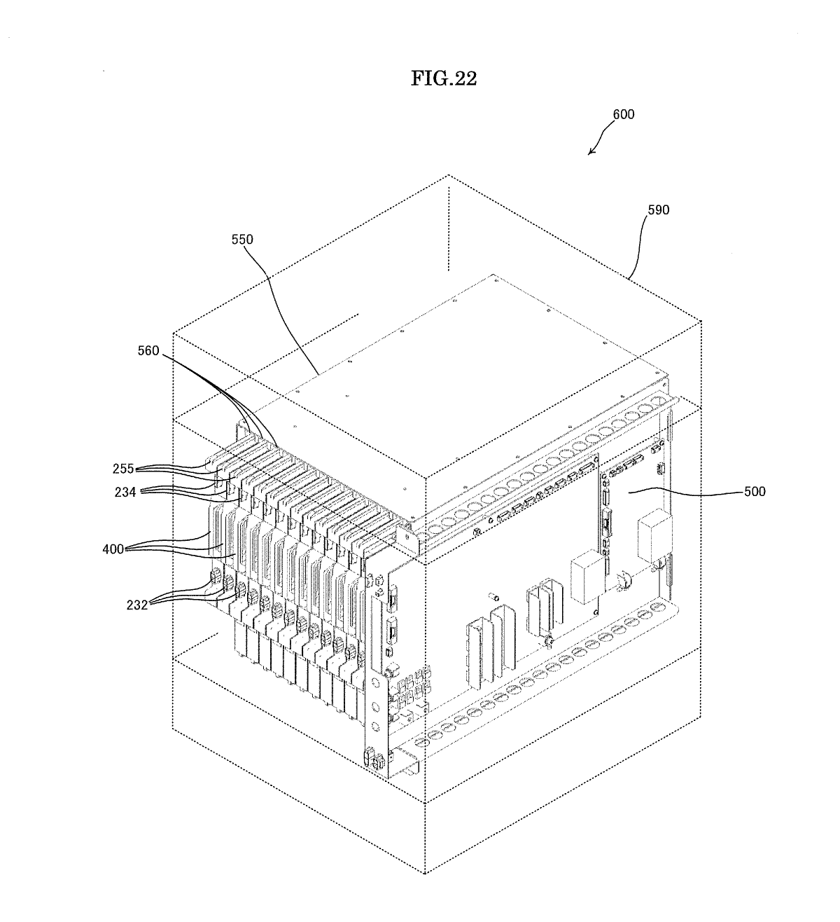

The battery module 400 and battery management circuit unit 500 that are configured as described above are used to make an electric storage device 600. FIG. 22 is a diagram outlining the electric storage device 600 that uses the battery modules 400 according to an embodiment of the present invention.

In a housing 590 of the electric storage device 600, the following are housed: a module housing rack 550, which houses a plurality of battery modules 400; and the battery management circuit unit 500, which is mounted integrally with the module housing rack 550. Furthermore, in the spaces of the housing 590 that are above and below the above components, a power conditioner, and an air blowing unit, which is used to cool the battery management circuit unit 500, are provided; however, these components are not shown in FIG. 22.

Above and below the module housing rack 550, thirteen pairs of concave guide members 560 are provided. For one pair of upper and lower concave guide members 560, one battery module 400 is fitted into a first end side protruding guide member 250 (lower) and a second end side protruding guide member 255 (upper), which are provided above and below the battery module 400; the battery module 400 can be inserted and removed.

Incidentally, the width of the first end side protruding guide member 250 is different from the width of the second end side protruding guide member 255. The concave portions of the upper and lower concave guide members 560 of the module housing rack 550 are similarly different in width. If the battery module 400 is placed upside down, the battery module 400 cannot be inserted into the module housing rack 550. Therefore, it is possible to prevent the battery module 400 from being misused.

As for thirteen battery modules 400 that are housed in the module housing rack 550, the first connectors 232 of the adjacent battery modules 400 are connected together in series via wire harnesses, not shown. Therefore, the battery modules 400 are input to the battery management circuit unit 500.

In an embodiment shown in FIG. 22, twelve battery modules 400 each of which houses four unit batteries 100 connected in series, and one battery module 400 which houses one unit battery 100, i.e. thirteen battery modules 400 in total, are mounted in the module housing rack 550. Based on a total sum of all the battery modules 400, voltage that is 49 times larger than that of the unit battery 100 can be taken out.

Meanwhile, the second connectors 234 of the thirteen battery modules 400 each are independently connected to the battery management circuit unit 500. The battery management circuit unit 500 therefore obtains potential data of each unit battery 100 and temperature data of the inside of each battery module 400, and carries out control processes, such as discharge stop, based on the data.

Another embodiment of the present invention will be described. According to another embodiment, the configuration of a battery housed in one battery housing chamber of the battery module 400 is different from the above embodiment, which will be described below.

According to the above embodiment, one unit battery 100 is housed in one battery housing chamber of the battery module 400. According to the present embodiment, an assembled battery in which a plurality of unit batteries 100 are connected together in parallel is housed in one battery housing chamber of the battery module 400.

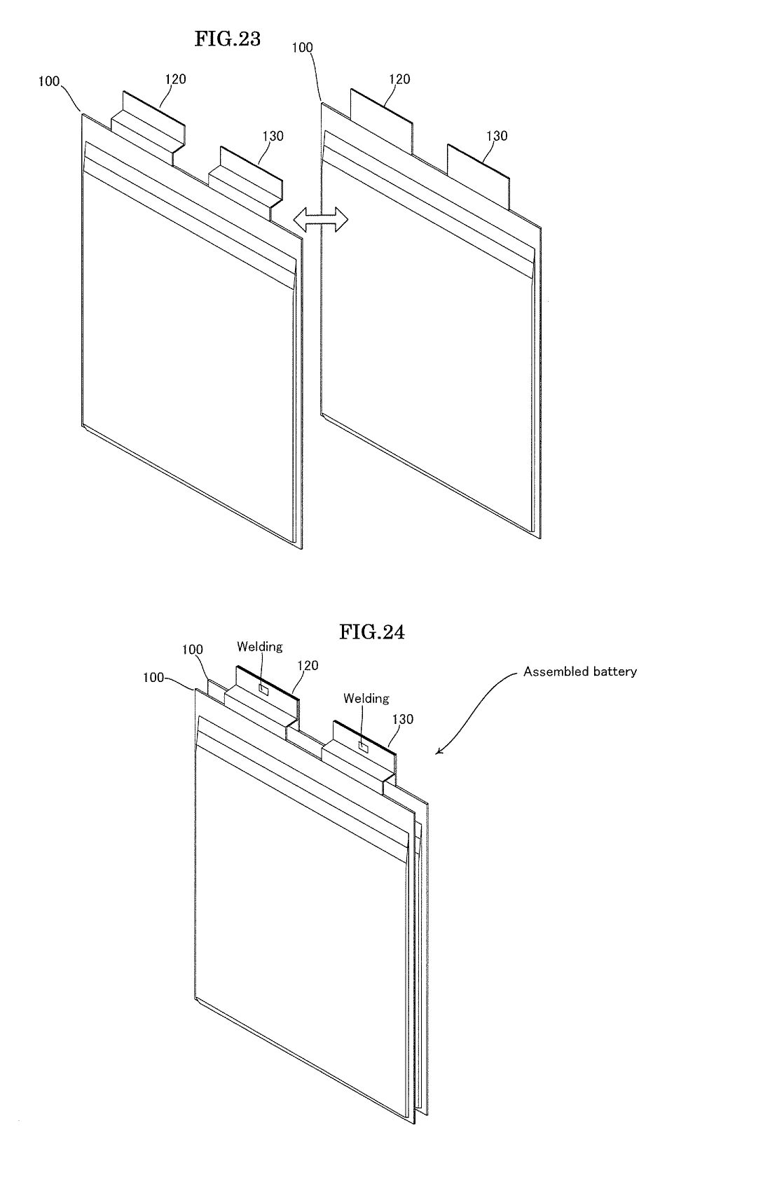

The structure will be described below in detail. FIG. 23 is a diagram illustrating an assembled battery that includes unit batteries 100 connected in parallel for making a battery module 400 according to another embodiment of the present invention. In an example of FIG. 23, two unit batteries 100 are connected in parallel to form one assembled battery. Instead, three or more unit batteries 100 may be connected in parallel to form one assembled battery.

In an embodiment shown in FIG. 23, a positive electrode pulled-out tab 120 and negative electrode pulled-out tab 130 of one unit battery 100 are bent and are joined to a positive electrode pulled-out tab 120 and negative electrode pulled-out tab 130 of the other unit battery 100 that are not bent. In this case, the same-polarity pulled-out tabs of the two unit batteries 100 are, for example, welded together as shown in FIG. 24. As a result, what is obtained is an assembled battery in which the unit batteries 100 are connected in parallel as shown in FIG. 24.

According to the present embodiment, the above assembled batteries are housed in the first battery housing chamber 215, second battery housing chamber 216, third battery housing chamber 225, and fourth battery housing chamber 226 of the unit battery housing body 200, and are connected in series as in the case of the above embodiment.

According to the present embodiment, compared with the one in which one battery housing chamber houses one unit battery 100, a larger capacity battery module 400 can be made.

As described above, in the battery module of the present invention, the peripheral partition wall sections help keep the rigidity of the battery module high. Therefore, it is possible to provide a battery module that easily can be made thinner and maintain reliability.

Moreover, the compartmentalization partition wall sections, which are provided between the adjacent unit batteries within a surface, keep troubles of one battery such as abnormal heating from affecting the other battery. Therefore, it is possible to provide the battery module that can easily ensure a high level of flame retardancy. Moreover, the compartmentalization partition wall sections provided on both surfaces of battery mounting planes help to keep the rigidity of the battery module high. Therefore, it is possible to provide the battery module that easily can be made thinner and maintain reliability.

Moreover, by the cover bodies that press the unit batteries in a sheet thickness direction, deformation of the battery elements can be effectively suppressed. Therefore, it is possible to provide the battery module that easily can maintain excellent battery characteristics such as repeated charge-and-discharge performance. In addition, the peripheral rib sections provided on both sides of the battery mounting plane, and the compartmentalization partition wall sections help to keep the rigidity of the battery module high. Therefore, it is possible to provide the battery module that easily can be made thinner and maintain reliability.

The following describes a second embodiment of the present invention with reference to the drawings.

The above-described battery module 400 of the first embodiment of the present invention houses a unit battery 100 with a positive electrode pulled-out tab 120 and negative electrode pulled-out tab 130 pulled out of one end portion of the unit battery 100, i.e. a unit battery with one-side tabs. Two unit batteries 100 are housed on one side of a battery module 400, or four unit batteries 100 on both sides. The inserting of the battery module 400 into the module housing rack 550 and the removing of the battery module 400 from the module housing rack 550 are realized by fitting the protruding guide members (250, 255), one of which is provided in the upper portion of the battery module 400 and the other one in the lower portion thereof, into the concave guide members 560 of the module housing rack 550.

However, the battery modules of the present invention are not limited to the above configuration.

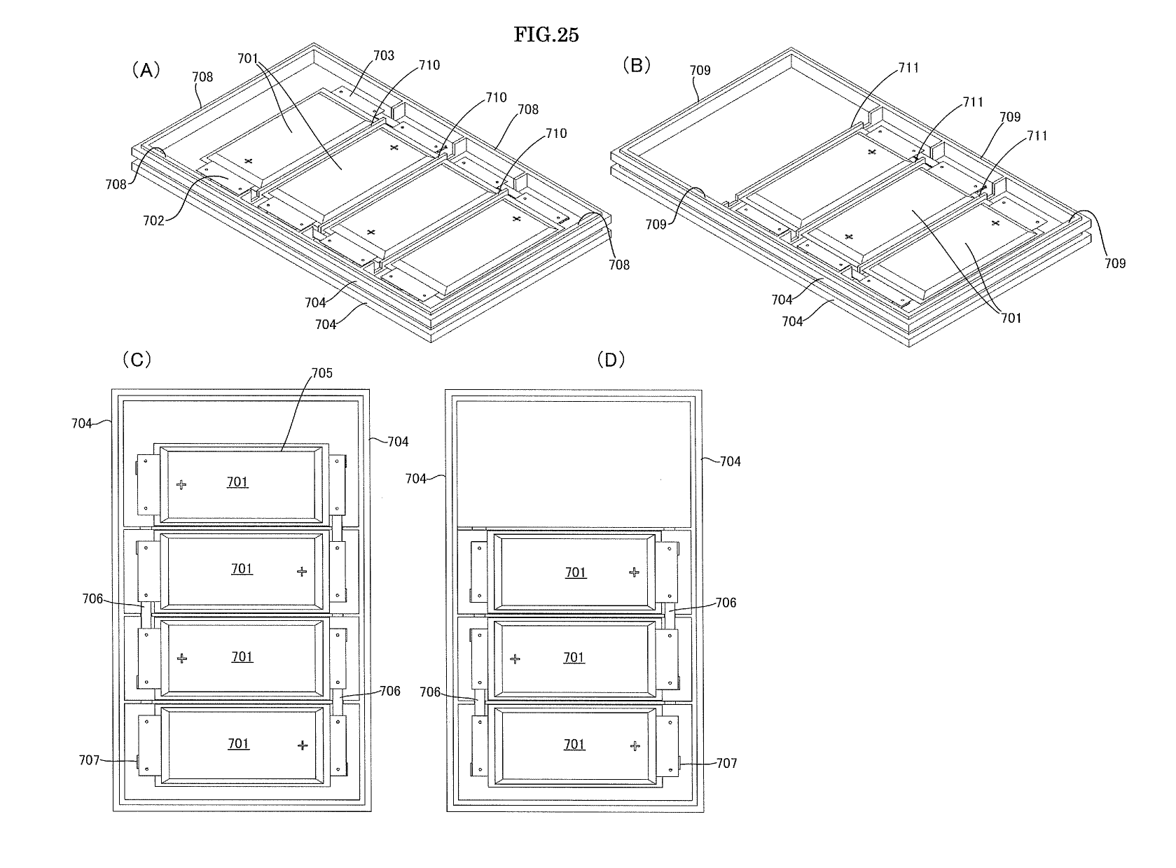

FIG. 25 is a perspective view and plane view of main components of a battery module 700 according to the second embodiment of the present invention.

FIG. 25(A) and FIG. 25(C) are views of the battery module 700 when seen from a first surface's side. FIG. 25(B) and FIG. 25(D) are views of the battery module 700 when seen from a second surface's side.

In the battery module 700 of the second embodiment of the present invention, from one end portion of a unit battery 701, a positive electrode pulled-out tab 702 is pulled out; from the other end portion, a negative electrode pulled-out tab 703 is pulled out. That is, unit batteries 701 with two-side tabs are housed.

The battery module 700 can house four unit batteries 701 on one side, or up to eight unit batteries 701 on both sides. However, what is illustrated in the present example is the configuration of the battery module 700 on which seven unit batteries 701 are mounted.

The battery module 701 includes two convex guide members 704 in an upper portion, and two convex guide members 704 in a lower portion. The two convex guide members 704 are fitted into two adjacent concave sections of concave guide members 560 of a module housing rack 550. In this manner the battery module 700 can be inserted into and removed from the module housing rack 550.

In general, in many cases, as a unit battery housed is changed in thickness, the battery module itself is accordingly changed in thickness. However, as described above, if the number of guide members used for the fitting is adjusted, even battery modules that are different in thickness can be housed in the same module housing rack.

Incidentally, as described in detail in the first embodiment, the width of the convex guide members 704 of the present example in the upper portion of the battery module 701 is so formed as to be different from the width of the convex guide members 704 in the lower portion of the battery module 701. Therefore, the inserting or removing of the battery modules 701 into or from the module housing rack 550 in a wrong direction can be prevented.

When unit batteries 701 of the battery module 700 of the second embodiment are connected in series, as shown in FIG. 25, the unit batteries 701 are housed in such a way that a direction in which the positive electrode tab 702 and negative electrode tab 703 of a unit battery 701 are housed is opposite to a direction in which the positive electrode tab 702 and negative electrode tab 703 of a unit battery 701 that is adjacent to the above unit battery 701 within the surface. A bus bar 706 is used to connect the positive electrode pulled-out tab 702 and negative electrode pulled-out tab 703 of a unit battery 701 to the positive electrode pulled-out tab 702 and negative electrode pulled-out tab 703 of a unit battery 701 that is adjacent to the above unit battery 701 within the surface. To connect the first and second surfaces, a bus bar 707, which is similar to the third bus bar 273 used in the first embodiment and which stretches from the first surface to the second surface, is used to connect the first and second surfaces. Therefore, the length of wiring paths can be reduced between the unit batteries.

As in the case of the battery module 400 of the first embodiment, the battery module 700 of the second embodiment includes first surface peripheral partition wall sections 708, second surface peripheral partition wall sections 709, first surface compartmentalization partition wall sections 710, and second surface compartmentalization partition wall sections 711. Therefore, as in the case of the battery module 400 of the first embodiment, it is possible to keep the rigidity of the battery module high. Thus, it is possible to provide the battery module that easily can be made thinner and maintain reliability.

Cover bodies, not shown, that cover battery housing chambers of the battery module 701 can be formed in such a way that battery-pressing raised sections, not shown, press electrode stack regions 705 of the unit batteries 701, as in the case of the first and second cover bodies 310 and 320 of the first embodiment. Therefore, as in the case of the battery module 400 of the first embodiment, deformation of the battery elements can be effectively suppressed. Therefore, it is possible to provide a battery module that easily can maintain excellent battery characteristics such as repeated charge-and-discharge performance.

A third embodiment of the present invention will be described. If a battery module is used under abnormal conditions such as abnormal heating and abnormal vibration, and if one of a plurality of unit batteries that make up the battery module generates abnormal heat as a result, and gas is generated inside the unit battery, a laminate battery is designed to open a portion of a heat seal at an outer peripheral side of a laminate casing body at a time when the pressure inside the battery becomes greater than or equal to a predetermined value, in order to discharge the gas inside the laminate casing body out of the laminate casing body. Therefore, according to the third embodiment, what is realized is a structure in which the effects of the gas on an adjacent unit battery can be reduced even when the gas generated inside the laminate casing body is discharged out of the laminate casing body.

Incidentally, the configuration of unit batteries used in the third embodiment is different from those described above. Therefore, components, including the unit batteries, will be described below.

FIG. 32 is a diagram showing a unit battery 100 that constitutes a battery module according to another embodiment of the present invention, and a preliminary processing step thereof. As the unit battery 100, a lithium-ion secondary unit battery, one type of electrochemical element in which lithium ions move between a negative electrode and a positive electrode for charging and discharging, is used.

FIG. 32(A) shows the unit battery 100 that has not been subjected to preliminary processing. A battery body section 110 of the unit battery 100 has a structure in which an electrode stacked body and an electrolytic solution (both not shown in the diagram) are housed in a laminate film outer casing that is rectangular in planar view: In the electrode stacked body, a plurality of sheet-like positive electrodes and a plurality of sheet-like negative electrodes are stacked via separators. From one end portion (side) of the battery body section 110, a positive electrode pulled-out tab 120 is pulled out; from the other end portion (side) that faces the above one end portion, a negative electrode pulled-out tab 130 is pulled out. A stacking direction in which a plurality of sheet-like positive electrodes and a plurality of sheet-like negative electrodes are stacked via separators as described above is defined as a sheet thickness direction.

Both the positive electrode pulled-out tab 120 and the negative electrode pulled-out tab 130 are planar in shape; in the laminate film outer casing, the positive electrode pulled-out tab 120 and the negative electrode pulled-out tab 130 each are connected directly, or via a lead body or the like, to a sheet-like positive electrode and a sheet-like negative electrode. The laminate film outer casing is made from metal laminate film with a heat-sealing resin layer. More specifically, for example, two metal laminate films are put together in such a way that the heat-sealing resin layers face each other, thereby forming a laminate film outer casing. An electrode stacked body having the sheet-like positive electrodes, sheet-like negative electrodes, and separators, and the electrolytic solution are housed inside, and the outer periphery of the laminate film outer casing is heat-sealed. Therefore, the inside thereof is sealed.

Here, metal pieces, such as the positive electrode pulled-out tab 120 and negative electrode pulled-out tab 130 that are pulled out of the battery body section 110 including the laminate film outer casing, are referred to as “pulled-out tabs.” Sheet-like positive and negative electrodes, which are stacked via separators, electrolytic solution, and the like in the laminate film outer casing, are referred to as “electrodes.”

Incidentally, the electrode stacked bodies include the above one in which a plurality of sheet-like positive electrodes and a plurality of sheet-like negative electrodes are stacked via separators, and a stack in which sheet-like positive electrodes and sheet-like negative electrodes are stacked via separators and wound around and are compressed.

In the above unit battery 100, as the material of the positive electrode pulled-out tab 120, aluminum or aluminum alloy is typically used. As the material of the negative electrode pulled-out tab 130, nickel, a material made by plating other metals with nickel (Nickel-plated material; e.g. copper plated with nickel, and the like), or a clad of nickel and other metals (Nickel-clad material; e.g. nickel-copper clad and the like) is typically used. According to the present embodiment, the positive electrode pulled-out tab 120 made of aluminum, and the negative electrode pulled-out tab 130 made of copper plated with nickel are used.

To the unit battery 100 having the above configuration, preliminary processing is carried out before a process of being incorporated into a battery module. First, as shown in FIG. 32(B), an additional tab member 140, which is made of copper, is ultrasonic-welded in a welding section 143. Therefore, the additional tab member 140 is connected to the positive electrode pulled-out tab 120. The reason why such an additional tab member 140 is used will be described.

In making a battery module of the present invention, the positive electrode pulled-out tab 120 of a unit battery 100 and the negative electrode pulled-out tab 130 of a unit battery 100 adjacent to the above unit battery 100 are mechanically fixed to a copper bus bar with screws, and therefore are electrically connected.

If the positive electrode pulled-out tab 120 containing aluminum of the unit battery 100 is mechanically fixed to the copper bus bar, the conductivity might deteriorate after certain years due to a difference in potential.

In the battery module of the present invention, as described above, to the positive electrode pulled-out tab 120 of the unit battery 100, the additional tab member 140 made of copper is welded. Then, the additional tab member 140 made of copper is mechanically fixed to the bus bar. In this manner, the problem of conductivity deterioration caused by the potential difference can be solved. According to the above configuration, in the mechanical electric connection section, the same kinds of metal material are electrically connected, not causing the problem of potential difference; the conductivity is unlikely to deteriorate over years.

Then, in a process of FIG. 32(C), on the positive electrode pulled-out tab 120, an alignment through-hole 124 is provided; on the additional tab member 140 added to the positive electrode pulled-out tab 120, a through-hole 145 is provided; on the negative electrode pulled-out tab 130, an alignment through-hole 134 and a through-hole 135 are provided. The alignment through-hole 124 of the positive electrode pulled-out tab 120 and the alignment through-hole 134 of the negative electrode pulled-out tab 130, which are among the above through-holes, will be used to set the unit battery 100 in a unit battery housing body 800, which will be described in detail later.

On the unit battery housing body 800, unit battery alignment projections 860 are provided. When the unit battery 100 is placed on the unit battery housing body 800, the unit battery alignment projections 860 are inserted into the alignment through-holes 124 and 134, which makes it easier for the unit battery 100 to be set into the battery housing body 800, helping improve production efficiency.

The through-hole 145 of the additional tab member 140 and the through-hole 135 of the negative electrode pulled-out tab 130, as described later, are used to: (1) mechanically fix the unit battery 100 to the unit battery housing body 800; (2) electrically connect the tabs to the bus bar of the unit battery housing body 200; and (3) electrically connect the tabs and a sense line and a power supply line.

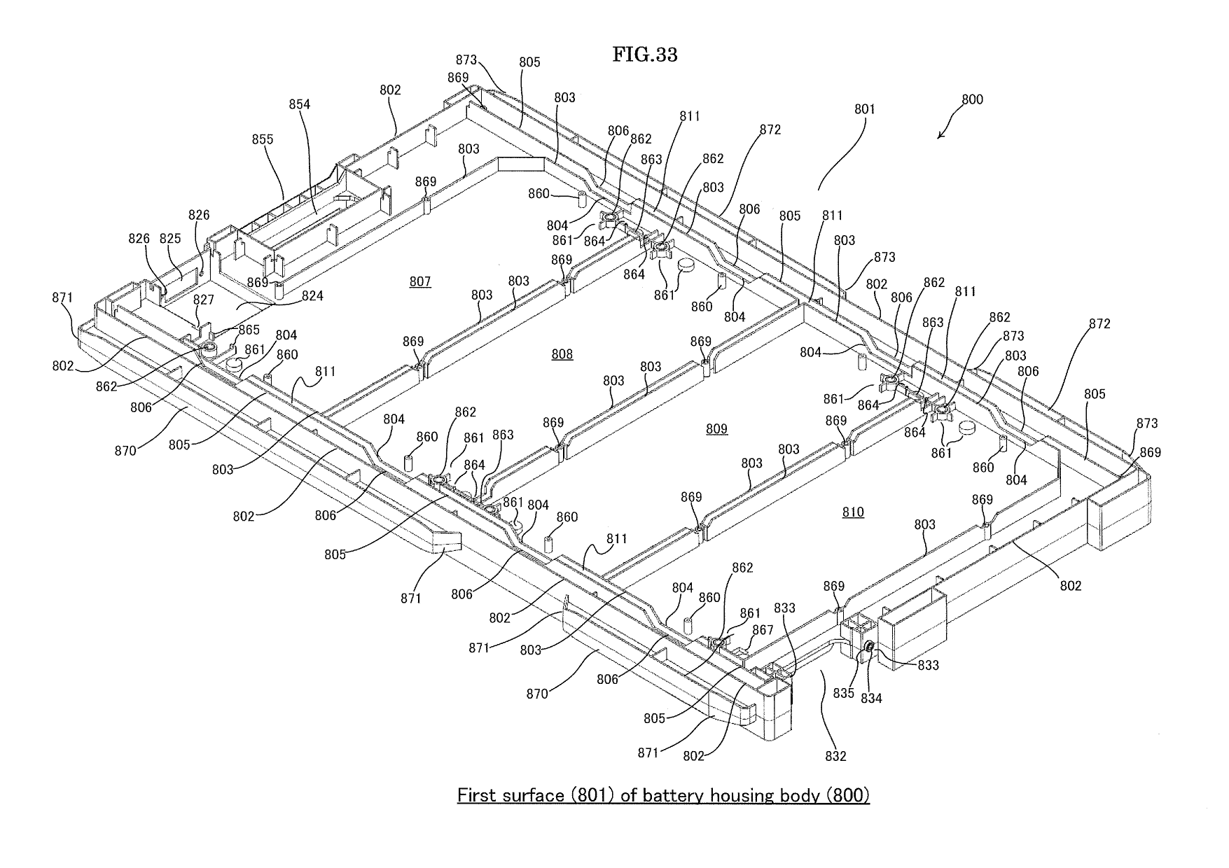

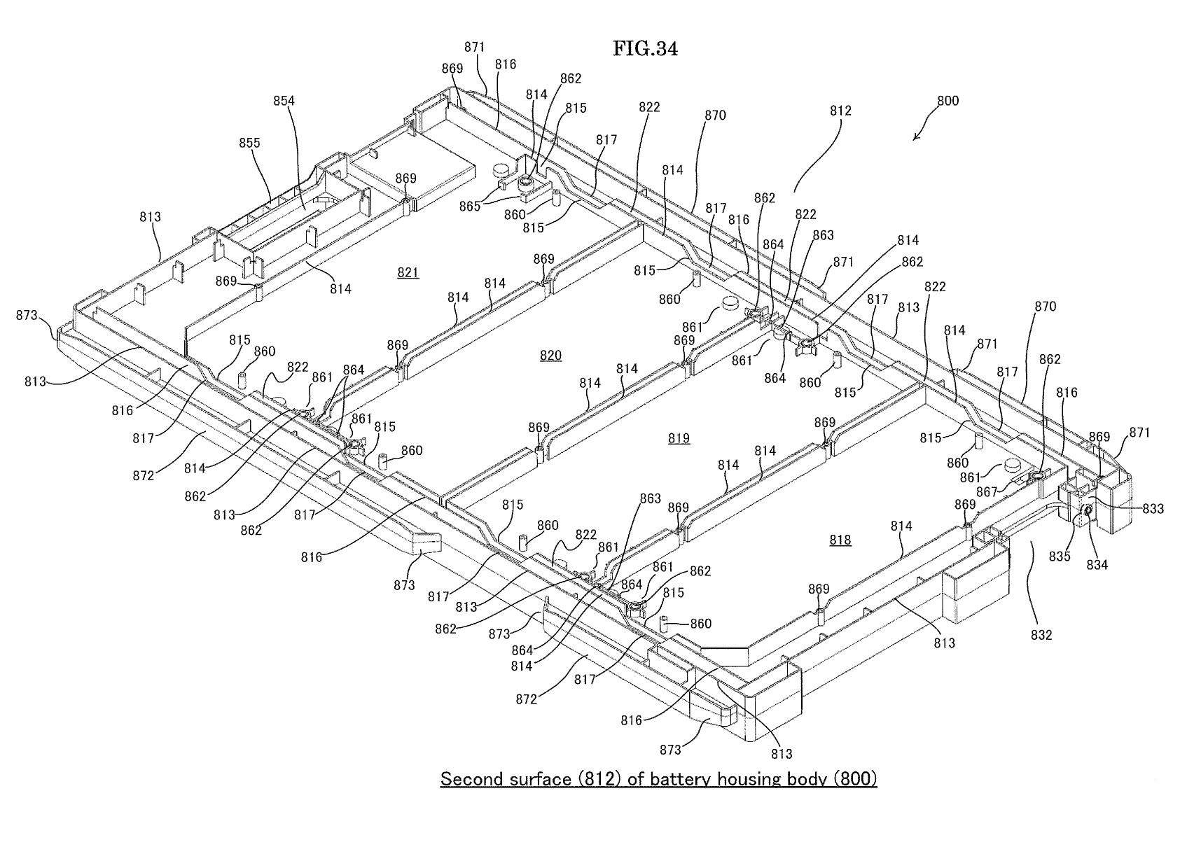

The configuration of the unit battery housing body 800, which houses unit batteries 100 that have been preliminarily processed as described above, will be detailed. FIGS. 33 and 34 are diagrams illustrating the battery housing body 800 that is used in making the battery module according to the embodiment of the present invention.

The battery housing body 800 is a member made of synthetic resin such as ABS. In the battery housing body 800, the unit batteries 100 and other parts are mounted; the unit batteries 100 and other parts are connected together by wiring.

The battery housing body 800 includes a flat-plate base, and peripheral partition wall sections, which are formed in peripheral portions of front and back surfaces, which are two main surfaces of the base. The peripheral partition wall sections includes a first surface peripheral partition wall section, which is provided on the front surface of the base, and a second surface peripheral partition wall section, which is provided on the back surface of the base. FIG. 33 is a perspective view of the front surface of the base of the battery housing body 800. FIG. 34 is a perspective view of the back surface of the base of the battery housing body 800. In the following description, a main surface of the battery housing body on the base front surface's side shown in FIG. 33 is referred to as a first surface 801; a main surface of the battery housing body on the base back surface's side shown in FIG. 34 is referred to as a second surface 812.

On the first surface 801, a first surface peripheral partition wall section 802 is erected vertically on the front surface of the base in such a way as to surround the periphery of the front surface of the base. An inner area surrounded by the first surface peripheral partition wall section 802 is covered with a cover body described later.

In the inner area surrounded by the first surface peripheral partition wall section 802 on the first surface 801, first surface compartmentalization partition wall sections 803 are erected vertically on the front surface of the base, forming a partition wall between adjacent unit batteries 100 within the first surface, and providing independent housing chambers in which unit batteries 100 are housed. The first surface compartmentalization partition wall sections 803 also function as partition walls for unit batteries 100 that are arranged in a line and located in an end portion. On the first surface 801, the first surface compartmentalization partition wall sections 803 make it possible to form four housing spaces for unit batteries 100 in total, i.e. a first battery housing chamber 807, a second battery housing chamber 808, a third battery housing chamber 809, and a fourth battery housing chamber 810.

On one end side of the first surface 801, and on the other end side that faces the one end side, first surface intermediate partition wall sections 805 are erected vertically on the front surface of the base in such a way as to be between the first surface peripheral partition wall section 802 and the first surface compartmentalization partition wall sections 803. A space between the first surface compartmentalization partition wall sections 803 and the first surface intermediate partition wall sections 805 is used as a first surface sense line housing section 811 in which a sense line that detects potential of a tab of a unit battery 100, and the like are laid.

At a location where a direction in which a pulled-out tab of a unit battery 100 is pulled out intersects with a first surface compartmentalization partition wall section 803 when the unit battery 100 is housed in a housing chamber for the unit battery 100 that is formed by the first surface compartmentalization partition wall section 803, a compartmentalization partition wall notch section 804 is provided. Similarly, at a location where a direction in which the pulled-out tab is pulled out intersects with a first surface intermediate partition wall section 805, an intermediate partition wall notch section 806 is provided. The benefit obtained by providing the compartmentalization partition wall notch section 804 and the intermediate partition wall notch section 806 will be described later.

Similarly, on the second surface 812, a second surface peripheral partition wall section 813 is erected vertically on the back surface of the base in such a way as to surround the periphery of the back surface of the base. An inner area surrounded by the second surface peripheral partition wall section 813 is covered with a cover body described later.

In the inner area surrounded by the second surface peripheral partition wall section 813 on the second surface 812, second surface compartmentalization partition wall sections 814 are erected vertically on the front surface of the base, forming a partition wall between adjacent unit batteries 100 within the second surface, and providing independent housing chambers in which unit batteries 100 are housed. The second surface compartmentalization partition wall sections 814 also function as partition walls for unit batteries 100 that are arranged in a line and located in an end portion. On the second surface 812, the second surface compartmentalization partition wall sections 814 make it possible to form four housing spaces for unit batteries 100 in total, i.e. a fifth battery housing chamber 818, a sixth battery housing chamber 819, a seventh battery housing chamber 820, and an eighth battery housing chamber 821. Both the first surface 801 and the second surface 812 of the unit battery housing body 800 house eight unit batteries 100 in total.

On one end side of the second surface 812, and on the other end side that faces the one end side, second surface intermediate partition wall sections 816 are erected vertically on the front surface of the base in such a way as to be between the second surface peripheral partition wall section 813 and the second surface compartmentalization partition wall sections 814. A space between the second surface compartmentalization partition wall sections 814 and the second surface intermediate partition wall sections 816 is used as a second surface sense line housing section 822 in which a sense line that detects potential of a tab of a unit battery 100, and the like are laid.

At a location where a direction in which a pulled-out tab of a unit battery 100 is pulled out intersects with a second surface compartmentalization partition wall section 814 when the unit battery 100 is housed in a housing chamber for the unit battery 100 that is formed by the second surface compartmentalization partition wall section 814, a compartmentalization partition wall notch section 815 is provided. Similarly, at a location where a direction in which the pulled-out tab is pulled out intersects with a second surface intermediate partition wall section 816, an intermediate partition wall notch section 817 is provided. The benefit obtained by providing the second surface compartmentalization partition wall section 814 and the intermediate partition wall notch section 817 will be described later.

As described above, the unit battery housing body 800 includes four housing chambers for unit batteries 100 on the first surface 801, or the first battery housing chamber 807, the second battery housing chamber 808, the third battery housing chamber 809, and the fourth battery housing chamber 810; and four housing chambers for unit batteries 100 on the second surface 812, or the fifth battery housing chamber 818, the sixth battery housing chamber 819, the seventh battery housing chamber 820, and the eighth battery housing chamber 821. The unit battery housing body 800 has eight housing chambers in total for unit batteries 100 on both sides. If one battery housing chamber houses one unit battery 100, the unit battery housing body 800 of the present embodiment can house up to eight unit batteries 100. Incidentally, in the battery module of the present invention, the number of unit batteries 100 that the unit battery housing body 800 can house is not limited to this example. If both sides of the unit battery housing body 800 are utilized, any given number of unit batteries 100 can be housed in the unit battery housing body 800.

In one end portion (or end portion on a side where the first battery housing chamber 807 and the eighth battery housing chamber 821 are disposed) of the unit battery housing body 800, a first connector housing concave section 824 is provided: The first connector housing concave section 824 is a space where a first connector 828 is disposed, and power supply of unit batteries 100 connected in series can be taken out through the first connector 828.

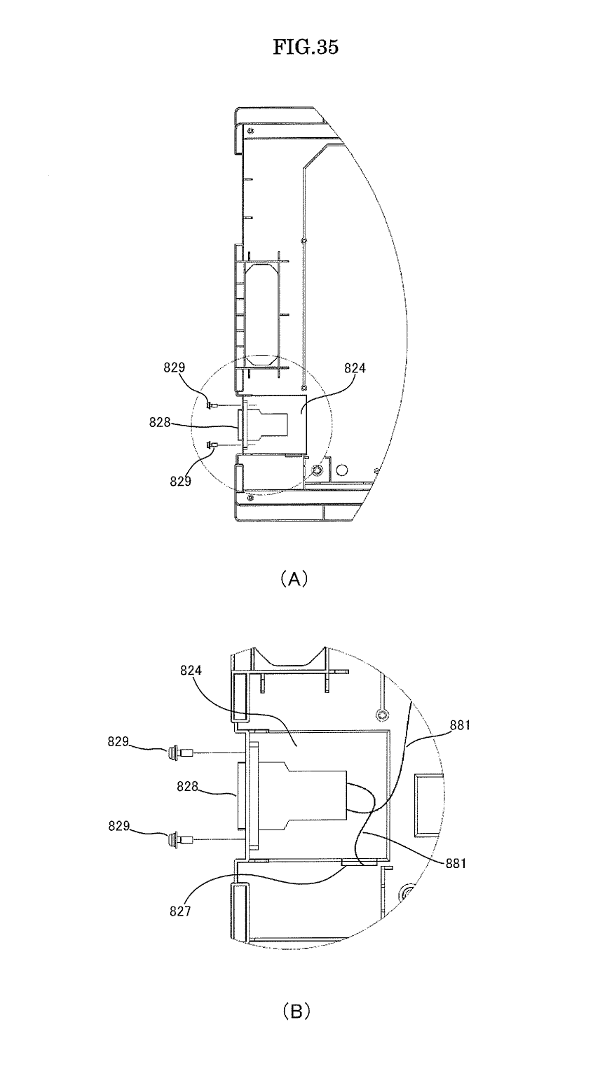

FIG. 35 is a diagram illustrating how the first connector 828 is mounted on the battery housing body 800. FIG. 35(B) is an enlarged view of main sections of FIG. 35(A). On a side wall of the unit battery housing body 800, the following are provided: a first connector mounting opening section 825, which is used to mount the first connector 828; and first connector mounting screw holes 826, which are on both sides thereof. The first connector 828 is fitted into the first connector mounting opening section 825, and mounting screws 829 are tightened into the first connector mounting screw holes 826. In this manner, the first connector 828 is fixed to the battery housing body 800. Near the first connector housing concave section 824, a power supply line opening section 827 is so provided as to pass through the first surface 801 and the second surface 812, thereby enabling a power supply line 881 of the first connector 828, which is provided on the first surface 801, to extend to the second surface 812.

In one end portion (or end portion on a side where the fourth battery housing chamber 810 and the fifth battery housing chamber 818 are disposed) of the unit battery housing body 800, a second connector mounting concave section 832 is provided: The second connector mounting concave section 832 is a space where a sense line coming from a unit battery 100 and a second connector 840 are disposed, and output from a thermistor connection line can be taken out through the second connector 840.

Through the second connector 234, information about potential of a tab of each of unit batteries 100 connected in series, and information about temperatures inside the module can be taken out. The potential information of a tab of each of unit batteries 100 enables a battery management circuit unit 1100, described later, to manage each unit battery 100.

When a battery module 1000 is mounted on an electric storage device 1200, the battery module 1000 is positionally regulated by a rail member, and is fitted into a connector (or seventh connector 1152 described later) that is provided in the back of a housing of the electric storage device 1200. However, if the rail member and any other member have a tolerance, it is difficult to fit the second connector 840 into the seventh connector 1152. Therefore, the second connector 840 is so formed as to be slightly variable in order to cover the above tolerance.

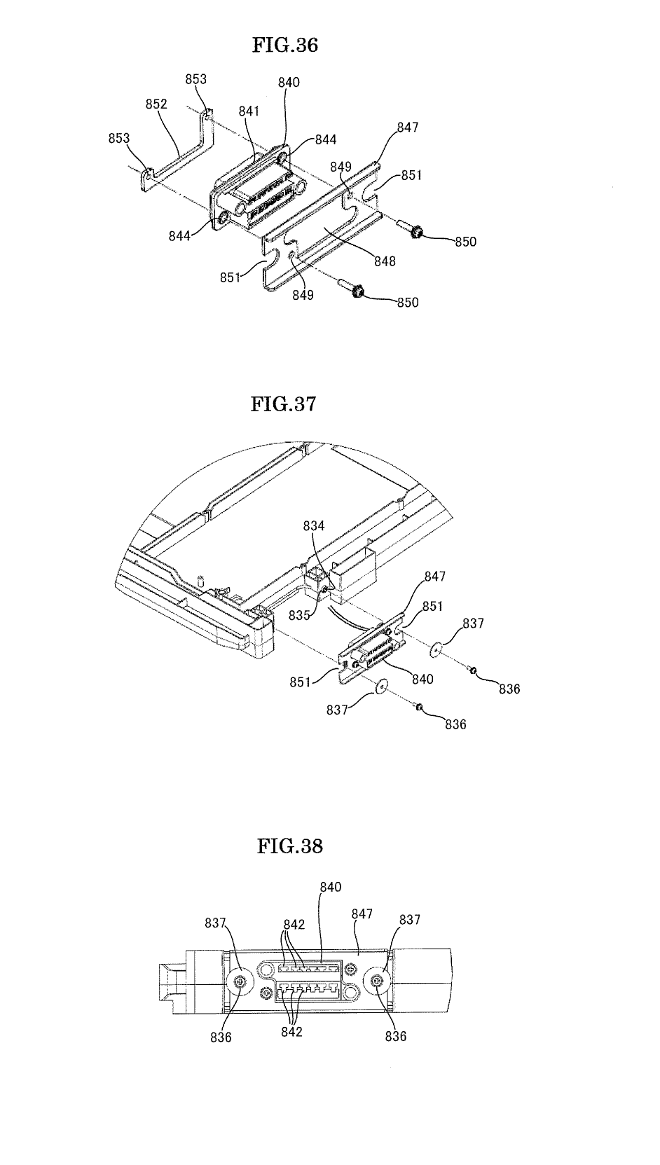

The second connector 840 will be described based on FIGS. 36 to 38. FIG. 36 is a diagram illustrating how the second connector 840 is mounted onto a connector mounting panel 847. FIG. 37 is a diagram illustrating how the connector mounting panel 847 is mounted onto the battery housing body 800. FIG. 38 is a front view of the second connector 840 mounted to the battery housing body 800.

At both ends of a body section 841 of the second connector 840, two through-holes 843 (not shown in FIG. 36) are provided. In the two through-holes 843, bushes 844 are installed. The outer diameter of the bushes 844 is smaller than the inner diameter of the through-holes 843 by 2Δb. Therefore, the position of the body section 841 of the second connector 840 can change by 2Δb with respect to the bushes 844.

The second connector 840 is fitted into a connector mounting opening section 848 of the connector mounting panel 847; with mounting screws 850, which are inserted/tightened into connector mounting screw holes 849 of the connector mounting panel 847, the bushes 844, and female screw holes 853 of a clamping member 852, the second connector 840 is fixed to the connector mounting panel 847. Therefore, the second connector 840 positionally can change by a displacement amount of 2Δb with respect to the connector mounting panel 847.

On a panel mounting base section 833 in the second connector mounting concave section 832, screw hole peripheral protruding sections 835 are so provided as to protrude from a plane that makes up the panel mounting base section 833. At the center of the screw hole peripheral protruding sections 835, a panel mounting screw hole 834 is provided: The panel mounting screw hole 834 is used to mount the connector mounting panel 847 on the battery housing body 800.

The outer diameter of the screw hole peripheral protruding sections 835 that are inserted into mounting notch sections 851 provided on both sides of the connector mounting panel 847 is smaller than inner-side portions of the mounting notch sections 851 by 2Δa. The connector mounting panel 847 positionally can change by 2Δa with respect to the battery housing body 800.

The connector mounting panel 847 on which the second connector 840 is mounted is mounted to the battery housing body 800 with mounting screws 836, which are inserted into the connector mounting screw holes 849, retaining washers 837, the mounting notch sections 851, and the panel mounting screw holes 834.

The connector mounting panel 847 positionally can change by 2Δa with respect to the battery housing body 800. The second connector 840 positionally can change by 2Δb with respect to the connector mounting panel 847. Therefore, the second connector 840 positionally can change by 2Δa+2Δb with respect to the battery housing body 800. If the dimensional relationship Δa>Δb is set, the second connector 840 of the battery module 1000, which is guided by the rail member as the position thereof is regulated, can be more smoothly fitted into the seventh connector 1152.

In (end portion on a side where the first battery housing chamber 807 and the eighth battery housing chamber 821 are disposed) of the unit battery housing body 800, a grip through-hole 854 is so provided as to pass through between the first surface 801 and the second surface 812. The grip through-hole 854 and an adjacent area thereof function as a grip section 855. The grip section 855 contributes to making it easier to handle the battery module.

In the unit battery housing body 800, between the fourth battery housing chamber 810 of the first surface 801 and the fifth battery housing chamber 818 of the second surface 812, a bus-bar-laying through-hole 867 is so provided as to pass through between the first surface 801 and the second surface 812.

In the battery module of the present invention, batteries that are each disposed in the battery housing chambers are connected in series. The bus-bar-laying through-hole 867 makes it possible for an inter-surface bus bar 877 to stretch between the fourth battery housing chamber 810 of the first surface 801 and the fifth battery housing chamber 818 of the second surface 812. As a result, a unit battery 100 housed in the fourth battery housing chamber 810, and a unit battery 100 housed in the fifth battery housing chamber 818 are electrically connected together via the inter-surface bus bar 877.

In each of the first to eighth battery housing chambers 807 to 821, two unit battery alignment projections 860 are erected on the front or back surface of the base.

One of the unit battery alignment projections 860 of each housing chamber is fitted into the alignment through-hole 124 of the positive electrode pulled-out tab 120; the other unit battery alignment projection 860 is fitted into the alignment through-hole 134 of the negative electrode pulled-out tab 130. Therefore, the unit batteries 100 can be quickly positioned and set in the unit battery housing body 800; the above structure is therefore effective in terms of production efficiency.

In each housing chamber, a tab member mounting section 861 is erected from a plane of the front or back surface of the base. The tab member mounting sections 861 are designed to keep the following components a predetermined distance away from the plane when a unit battery 100 is set in the unit battery housing body 800: the positive electrode pulled-out tab 120 and negative electrode pulled-out tab 130 of the unit battery 100, and bus bars that are disposed between the tabs.

In some of the tab member mounting sections 861, tab member fixing screw holes 862 are provided. By using the tab member fixing screw holes 862 and tightening screws, it is possible to: (1) mechanically fix the unit battery 100 to the unit battery housing body 800; (2) electrically connect the tabs to the bus bar of the unit battery housing body 800; and (3) electrically connect the tabs and a sense line and a power supply line. The tab member fixing screw holes 862 are preferably provided in such a way that a metal cylindrical body, whose inner periphery is cut so as to form a screw pattern, is buried in and molded integrally with the unit battery housing body 800 made of resin.

In some of the tab member fixing screw holes 862 of the tab member mounting sections 861, a cross-shaped rib structure is provided, thereby reinforcing the tab member fixing screw holes 862. Among the tab member fixing screw holes 862, at a location where an inter-tab-member bus bar 876 is provided, an inter-screw-hole bridge section 863 is provided between the adjacent tab member fixing screw holes 862, making it possible to place the inter-tab-member bus bar 876 in a stable manner. On an upper surface of the inter-screw-hole bridge section 863, a bus bar alignment projection 864 is provided. Into a through-hole that is provided in advance in the inter-tab-member bus bar 876, the bus bar alignment projection 864 is fitted. Therefore, it is possible to easily set the inter-tab-member bus bar 876, helping to improve production efficiency.

The positive electrode pulled-out tab 120 of a unit battery 100 housed in the first battery housing chamber 807 of the first surface 801, and the negative electrode pulled-out tab 130 of a unit battery 100 housed in the eighth battery housing chamber 821 of the second surface 812 each are connected not only to a sense line but also to a power supply line. In order to fix an end section bus bar 875 that is used for the connection, an end section bus bar fixing frame 865 is provided in each housing chamber.

In one end section on an outer periphery of the unit battery housing body 800, a first end side protruding guide member 870 is provided. In the other end section that faces the above end section, a second end side protruding guide member 872 is provided.

The first end side protruding guide member 870 and the second end side protruding guide member 872 are so formed as to have a continuous convex portion extending in a longitudinal direction. The continuous convex portion is designed to slide in a concave guide member 1145 of a rail member described later. Therefore, the battery module 1000 of the present invention can be housed in a housing of the electric storage device 1200.

In both end portions of the first end side protruding guide member 870, tapered sections 871 are provided. In both end portions of the second end side protruding guide member 872, tapered sections 873 are provided. Therefore, when the battery module 1000 is inserted into the concave guide members 1145 of the rail members as described above, it is easy to insert, making it easier to handle. When the battery module 1000 is taken out of the concave guide members 1145 of the rail members, each tapered section offers play. Therefore, there is less need to pay attention to the direction in which the battery module 1000 is removed, and it becomes easier to handle.

The width of the first end side protruding guide member 870 used is different from the width of the second end side protruding guide member 872 used. Therefore, it is possible to prevent the battery module 1000 that takes an unexpected posture from being inserted into or removed from the electric storage device 1200. Incidentally, the width of the first end side protruding guide member 870, or the width of the second end side protruding guide member 872, can be defined as a length seen in a direction perpendicular to the front or back surface of the base.

Both the first end side protruding guide member 870 and the second end side protruding guide member 872 are on side faces, which are different from the front and back surfaces of the base. On the two side faces that face each other, the first end side protruding guide member 870 and the second end side protruding guide member 872 are provided along a planar direction of the front or back surface of the base.

It can be said that the first end side protruding guide member 870 and the second end side protruding guide member 872 are so provided as to protrude from the peripheral partition wall sections (802, 813) or to extend from the base, and that, in each tapered section, a protruding amount of the above protruding, or an extending amount of the extending, varies.

The unit battery housing body 800 adopts a structure in which the unit batteries 100 and various wires disposed on the first surface 801 are covered with a first surface cover body 910, and the unit batteries 100 and various wires disposed on the second surface 812 are covered with a second surface cover body 920.

Therefore, sixteen cover body fixing screw holes 869, which are used to fix the first surface cover body 910 to the first face 801 with screws, are provided on the first surface 801. Similarly, sixteen cover body fixing screw holes 869, which are used to fix the second surface cover body 920 to the first face 220 with screws, are provided on the second surface 812. On each surface, sixteen cover body fixing screw holes 869 are provided. However, all the cover body fixing screw holes 869 may not be used for screw-fixing. Moreover, the number of cover body fixing screw holes 869 provided on one surface is not limited to sixteen; any number of cover body fixing screw holes 869 can be provided.

The following describes a process of mounting unit batteries 100 and other components in the unit battery housing body 800 having the above configuration to make the battery module of the present invention.

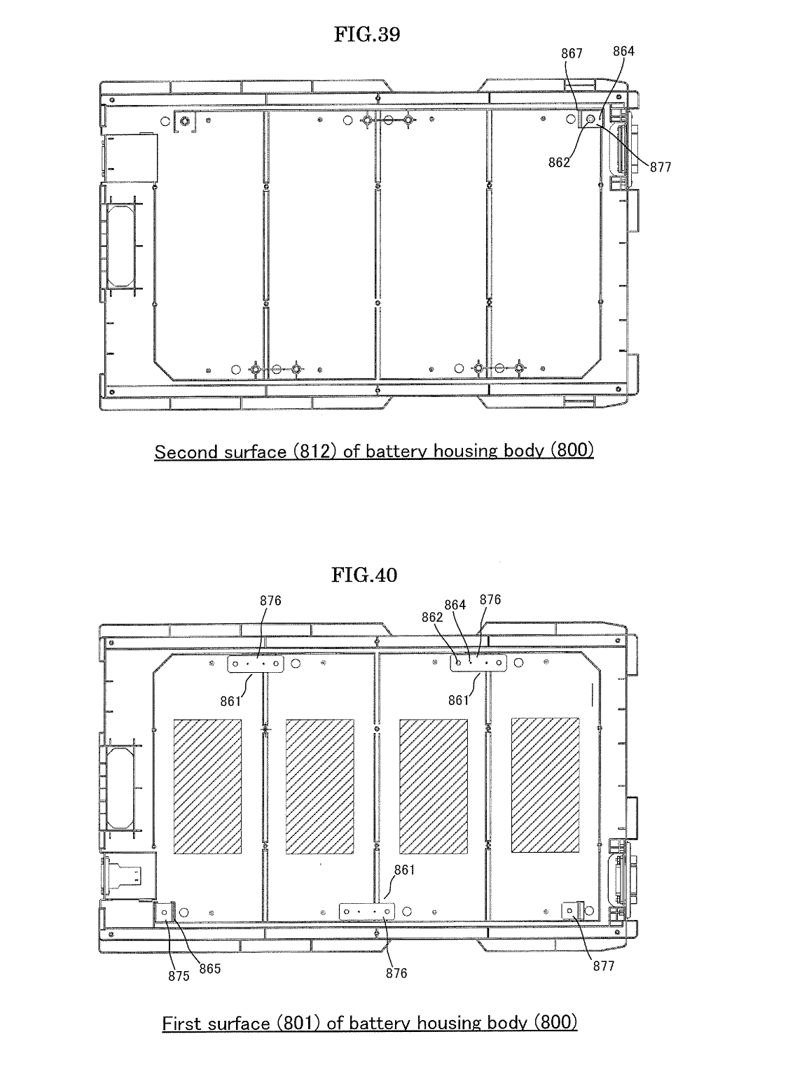

In a process shown in FIG. 39, an inter-surface bus bar 877 is set: The inter-surface bus bar 877 is used to electrically connect a unit battery 100 housed in the fourth battery housing chamber 810 of the first surface 801 to a unit battery 100 housed in the fifth battery housing chamber 818 of the second surface 812. The inter-surface bus bar 877 is inserted into the bus-bar-laying through-hole 867, and a through hole provided in the inter-surface bus bar 877 is fitted onto the bus bar alignment projection 864. In this manner, the mounting of the inter-surface bus bar 877 is completed. In the inter-surface bus bar 877, a through-hole corresponding to the tab member fixing screw hole 862 is provided in advance.

In a process shown in FIG. 40, a through-hole provided in an inter-tab-member bus bar 876 is fitted into a bus bar alignment projection 864. In this manner, the inter-tab-member bus bar 876 is set on a tab member mounting section 861. In the inter-tab-member bus bar 876, a through-hole corresponding to a tab member fixing screw hole 862 is provided in advance. During this process, in the end section bus bar fixing frame 865, an end section bus bar 875 is set. In the end section bus bar 875, a through-hole corresponding to a tab member fixing screw hole 862 is provided in advance. Moreover, an adhesive is applied to a shaded area of each battery housing chamber.

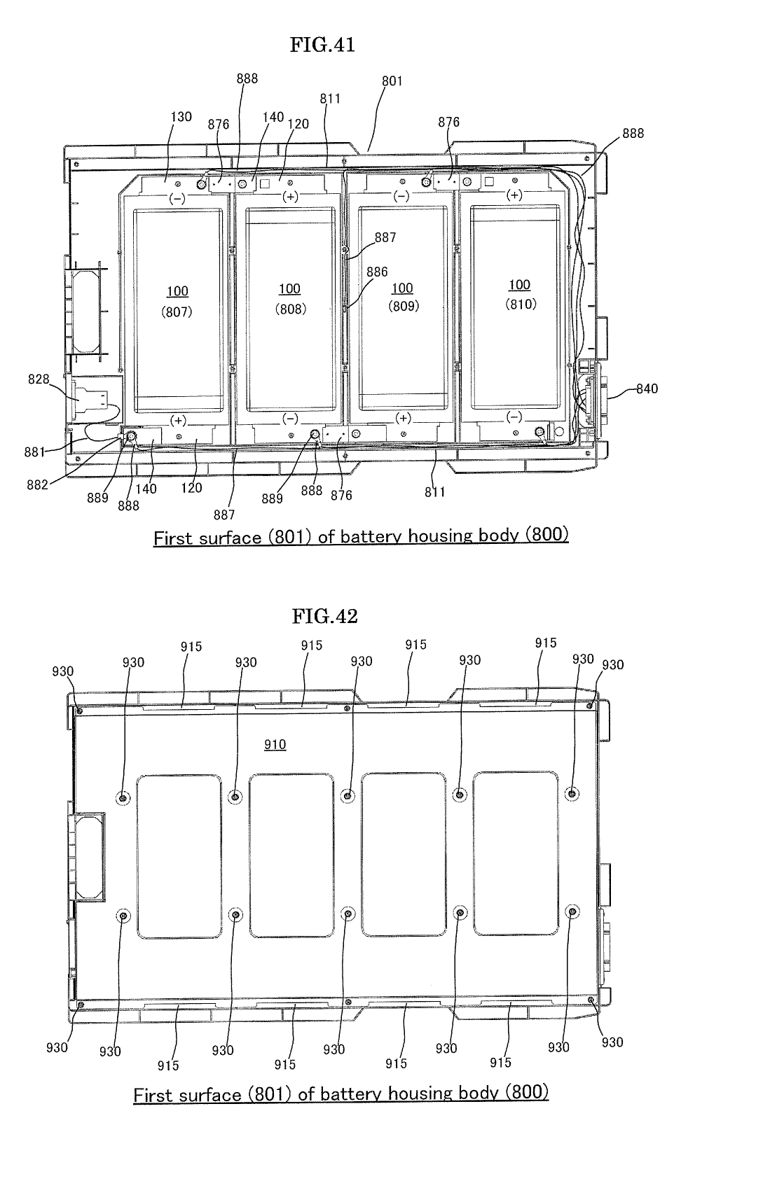

Then, in a process shown in FIG. 41, unit batteries 100 are each placed in the first battery housing chamber 807, second battery housing chamber 808, third battery housing chamber 809, and fourth battery housing chamber 810 to which the adhesive has been applied. At this time, into the alignment through-holes 124 of the positive electrode pulled-out tabs 120 of the unit batteries 100 and the alignment through-holes 134 of the negative electrode pulled-out tabs 130, the unit battery alignment projections 860 of the battery housing body 800 are inserted. Therefore, the unit batteries 100 are easily aligned with the battery housing body 800, contributing to an improvement in production efficiency. In the diagrams, the side where the positive electrode pulled-out tabs 120 of the unit batteries 100 are pulled out is marked with (+); the side where the negative electrode pulled-out tabs 130 are pulled out is marked with (−). As shown in FIG. 41, on one end side of the battery housing body 800, the polarity of a tab of a unit battery 100 housed in a battery housing chamber is different from the polarity of a tab of a unit battery 100 housed in an adjacent battery housing chamber. Therefore, the unit batteries 100 are connected in series as the tabs of the unit batteries 100 are electrically connected together via an inter-tab-member bus bar 876.

According to the present embodiment, in a direction perpendicular to a direction in which the pulled-out tabs of the unit batteries 100 are pulled out, a plurality of the unit batteries 100 are arranged in one direction, and the tabs of the adjacent unit batteries 100 are electrically connected. In this manner, the unit batteries 100 can be easily connected in series.

By using tab member fixing screw holes 862 and screws 889, an inter-tab-member bus bar 876 is electrically and mechanically fixed to a tab of a unit battery 100. To one of the two screws 889 that are used to fix the inter-tab-member bus bar 876, a sense line terminal 888, too, is fixed. The sense line terminal 888 is electrically connected to the second connector 840 through a sense line 887 that is placed in the first surface sense line housing section 811, making it possible to output potential information of tabs of the unit batteries 100 through the second connector 840.

An additional tab member 140 of the unit battery 100 in the first battery housing chamber 807 is electrically and mechanically fixed with a screw 889 to a power line terminal 882, a sense line terminal 888, and the end section bus bar 875 on the end section bus bar 875. The power line terminal 882 is electrically connected to the first connector 828 through a power supply line 881. Through the first connector 828, positive-polarity output can be taken out as output of the battery module.

Between the two first surface compartmentalization partition wall sections 803 that are between the second battery housing chamber 808 and the third battery housing chamber 809, a thermistor 886 is provided to monitor a temperature of the battery module 1000. The thermistor 886 is electrically connected to the second connector 840 through a thermistor connection line 885. Through the second connector 840, temperature information of the battery module 1000 can be output.

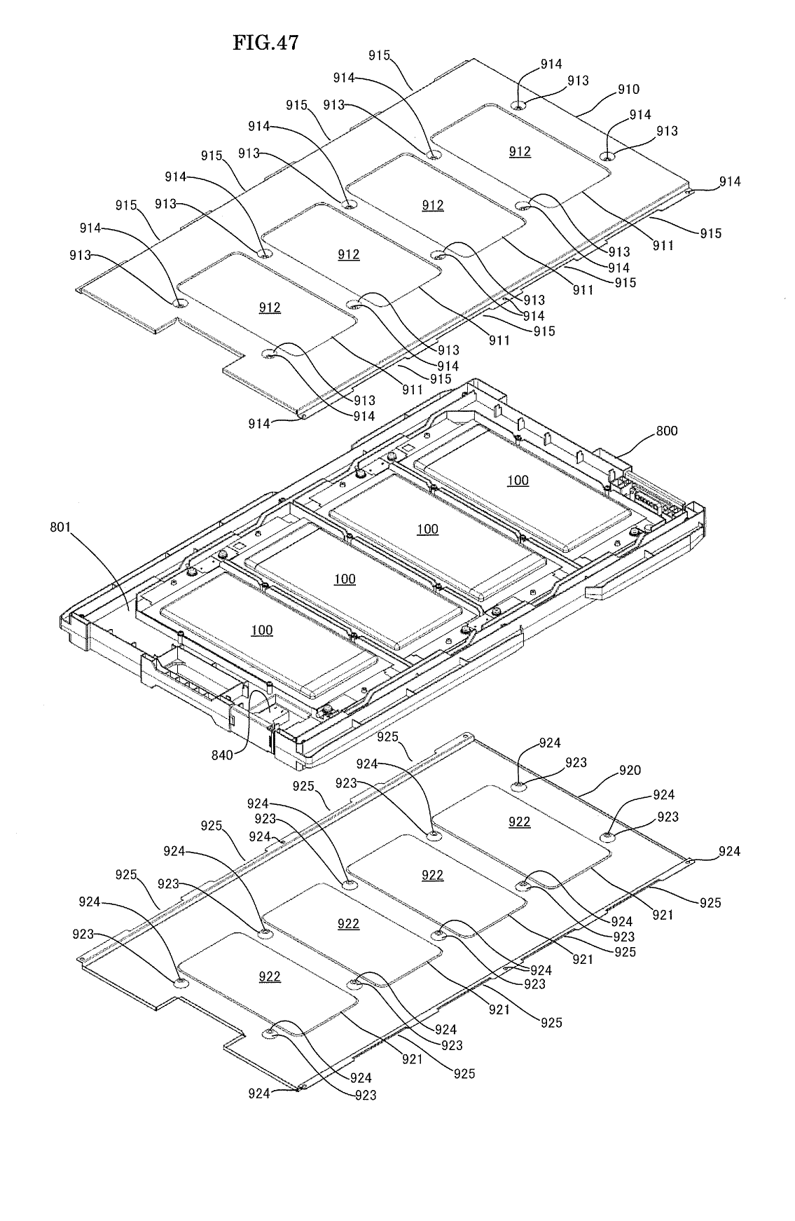

In a process shown in FIG. 42, on the first surface 801 of the battery housing body 800, the first surface cover body 910 is mounted with screws 930. With reference to a perspective view shown in FIG. 47, the first surface cover body 910 will be described. The first surface cover body 910 and the second surface cover body 920 have the same configuration except that the first surface cover body 910 is mirror-symmetrical to the second surface cover body 920. Therefore, the first surface cover body 910 will be illustrated below.

The first surface cover body 910 is a cover member made of aluminum to cover a unit battery 100, power supply line 881, sense line 887, thermistor 886, and other components that are housed on the first surface 801 of the unit battery housing body 800.

Raising of the first surface cover body 910 (battery-pressing raised sections 911) has been performed to press the unit batteries 100 housed in the battery housing chambers when the first surface cover body 910 is mounted on the first surface 801. Because of the battery-pressing raised sections 911, the surfaces that press the unit batteries 100 are defined as pressing surfaces 912. The pressing surfaces 912 that are based on the battery-pressing raised sections 911 press electrode stack regions 105 of the unit batteries 100 when the first surface cover body 910 is mounted, thereby suppressing bulging of unit batteries 100 and the like, which might occur over time as the unit batteries 100 are used, and extending the life of the unit batteries 100.

On the first surface cover body 910, screw holes 914 are formed at locations that face the cover body fixing screw holes 869 when the first surface cover body 910 is mounted on the first surface 801. Around the screw holes 914, screw-hole raised sections 913 are provided. Therefore, the first surface cover body 910 is fixed in such a way that regions of the first surface cover body 910 around the screw holes 914 come in close contact with the first surface 801.

On the first surface cover body 910, notch sections 915 are so provided as to face the pulled-out tabs of the unit batteries 100 when the first surface cover body 910 is mounted on the battery housing body 800. The notch sections 915 makes it possible to ensure exhaust performance of the battery module 1000.

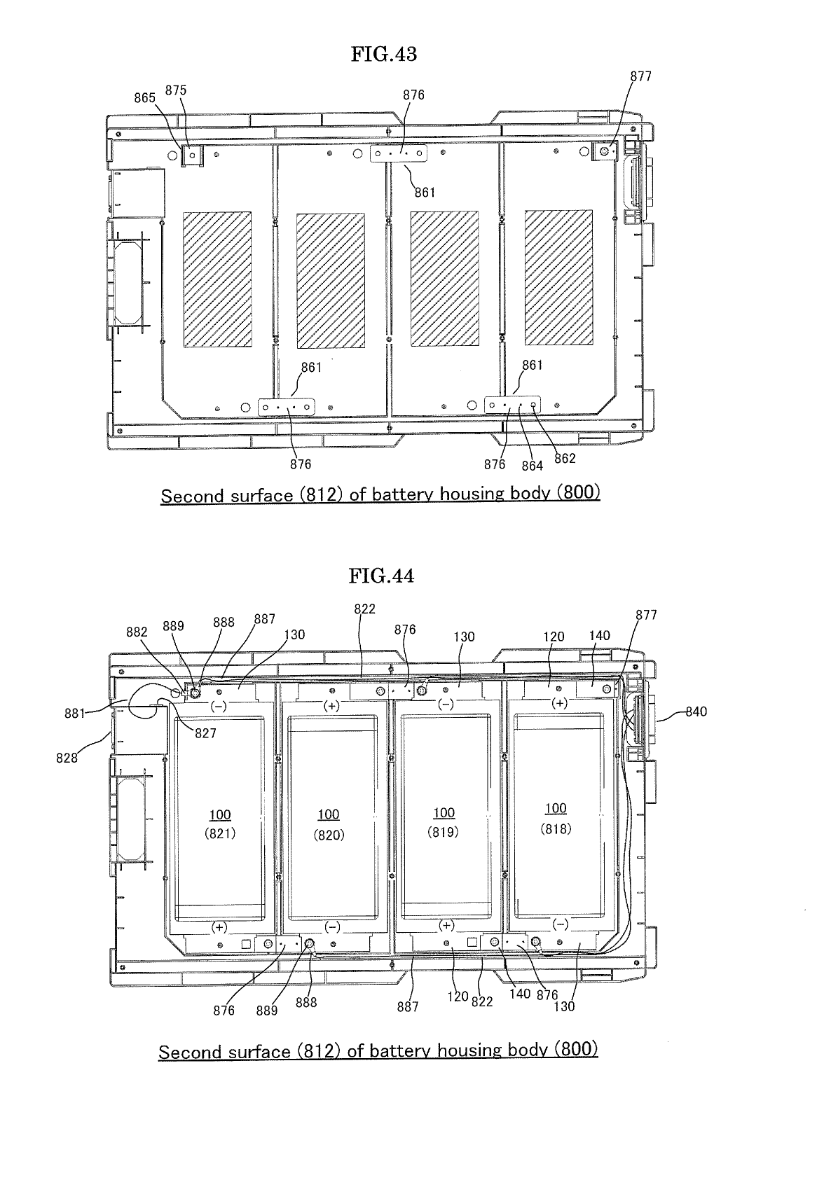

Then, in a process shown in FIG. 43, on the second surface 812 of the battery housing body 800, a through-hole provided in an inter-tab-member bus bar 876 is fitted into a bus bar alignment projection 864. In this manner, the inter-tab-member bus bar 876 is set on a tab member mounting section 861. In the inter-tab-member bus bar 876, a through-hole corresponding to a tab member fixing screw hole 862 is provided in advance. During this process, in the end section bus bar fixing frame 865, an end section bus bar 875 is set. In the end section bus bar 875, a through-hole corresponding to a tab member fixing screw hole 862 is provided in advance. Moreover, an adhesive is applied to a shaded area of each battery housing chamber.

Then, in a process shown in FIG. 44, on the second surface 812 of the battery housing body 800, unit batteries 100 are each placed in the fifth battery housing chamber 818, sixth battery housing chamber 819, seventh battery housing chamber 820, and eighth battery housing chamber 821 to which the adhesive has been applied. At this time, into the alignment through-holes 124 of the positive electrode pulled-out tabs 120 of the unit batteries 100 and the alignment through-holes 134 of the negative electrode pulled-out tabs 130, the unit battery alignment projections 860 of the battery housing body 800 are inserted. Therefore, the unit batteries 100 are easily aligned with the battery housing body 800, contributing to an improvement in production efficiency. In the diagrams, the side where the positive electrode pulled-out tabs 120 of the unit batteries 100 are pulled out is marked with (+); the side where the negative electrode pulled-out tabs 130 are pulled out is marked with (−). As shown in FIG. 44, on one end side of the battery housing body 800, the polarity of a tab of a unit battery 100 housed in a battery housing chamber is different from the polarity of a tab of a unit battery 100 housed in an adjacent battery housing chamber. Therefore, the unit batteries 100 are connected in series as the tabs of the unit batteries 100 are electrically connected together via an inter-tab-member bus bar 876.

According to the present embodiment, in a direction perpendicular to a direction in which the pulled-out tabs of the unit batteries 100 are pulled out, a plurality of the unit batteries 100 are arranged in one direction, and the tabs of the adjacent unit batteries 100 are electrically connected. In this manner, the unit batteries 100 can be easily connected in series.

By using tab member fixing screw holes 862 and screws 889, an inter-tab-member bus bar 876 is electrically and mechanically fixed to a tab of a unit battery 100. To one of the two screws 889 that are used to fix the inter-tab-member bus bar 876, a sense line terminal 888, too, is fixed. The sense line terminal 888 is electrically connected to the second connector 840 through a sense line 887 that is placed in the first surface sense line housing section 811, making it possible to output potential information of tabs of the unit batteries 100 through the second connector 840.

The negative electrode pulled-out tab 130 of the unit battery 100 in the eighth battery housing chamber 821 is electrically and mechanically fixed with a screw 889 to a power line terminal 882, a sense line terminal 888, and the end section bus bar 875 on the end section bus bar 875. The power line terminal 882 is electrically connected to the first connector 828 through a power supply line 881. Through the first connector 828, negative-polarity output can be taken out as output of the battery module.

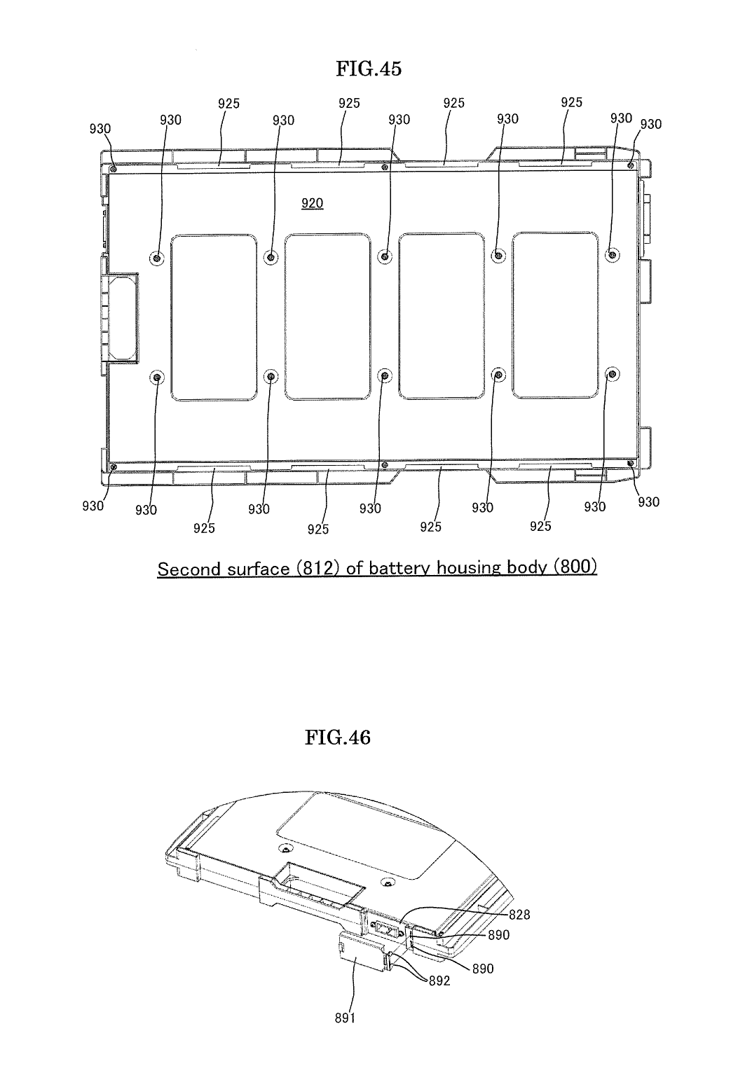

Then, in a process shown in FIG. 45, on the second surface 812 of the battery housing body 800, the second surface cover body 920 is mounted with screws 930.

Then, in a process shown in FIG. 46, on the first connector 828, a cap member 891 is mounted. To a conductive terminal of the first connector 828, voltage that is equivalent to that of the eight unit batteries 100 connected in series is being applied. To ensure safety in handling the battery module 1000, the cap member 891 covers the first connector 828. On the cap member 891, two locking pieces 892 are provided. The two locking pieces 892 are inserted into two locking openings 890, which are provided in a side wall section of the battery housing body 800 for the two locking pieces 892. Therefore, the cap member 891 can be mounted in such a way as to cover the first connector 828. The cap member 891 is removed when the battery module 1000 is mounted on the electric storage device 1200.

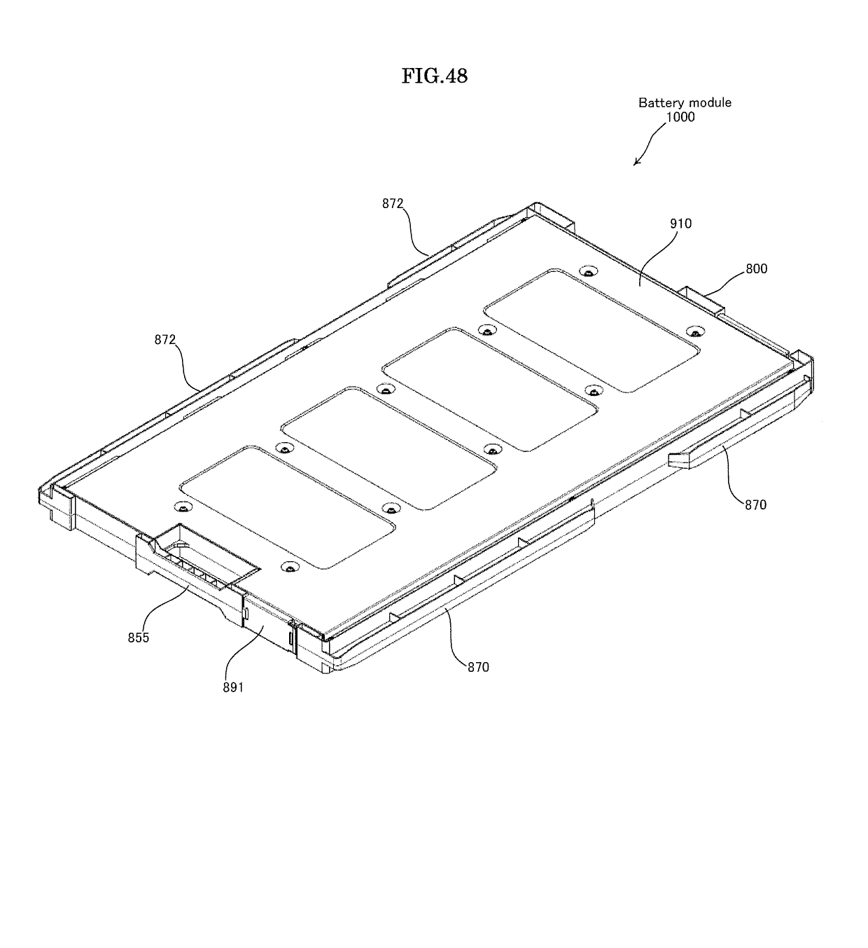

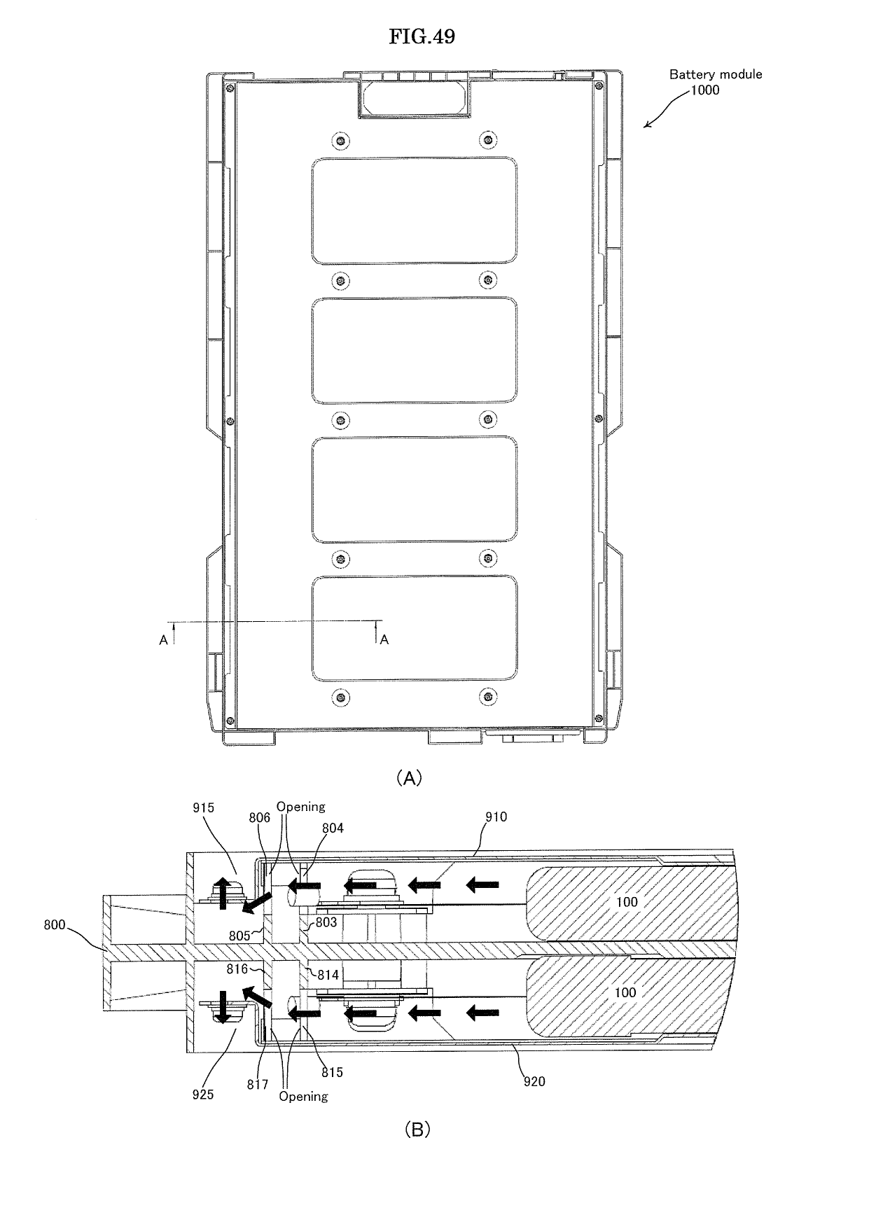

Through the above processes, the battery module 1000 is completed as shown in FIG. 48, which is a perspective view. With reference to FIG. 49, features of the battery module 1000 of another embodiment will be described.

In general, in a battery module, a plurality of unit batteries are housed and connected together electrically before the battery module is used. Even if the battery module is used in an abnormal state, one of a plurality of the unit batteries starts malfunctioning, and the gas generated inside a laminate film outer casing should be discharged out of the laminate film outer casing, it is desirable that the effects of the gas on adjacent unit batteries be reduced. According to the present embodiment, an exhaust structure that is designed to exhaust the above gas is provided. FIG. 49 is a diagram illustrating an exhaust structure of the battery module 1000 according to another embodiment of the present invention.

FIG. 49(A) is a plane view of the battery module 1000. FIG. 49(B) is a cross-sectional view of FIG. 49(A) taken along A-A. The cross-sectional view shows a situation obtained by cutting along almost the center of a width direction of a pulled-out tab of a unit batter 100 housed in the battery housing body 800.

If a laminate battery has bulged due to the gas generated inside the laminate film outer casing, a heat seal on an outer peripheral side of the laminate film outer casing is likely to open near an area where a positive electrode pulled-out tab 120 or a negative electrode pulled-out tab 130 is held by the laminate film outer casing.

Therefore, according to the present embodiment, in each of the compartmentalization partition wall sections (first surface compartmentalization partition wall sections 803, second surface compartmentalization partition wall sections 814) that are provided in a direction perpendicular to a direction in which the pulled-out tabs of the unit batteries 100 are pulled out, and in the intermediate partition wall sections (first surface intermediate partition wall sections 805, second surface intermediate partition wall sections 816), the compartmentalization partition wall notch sections (compartmentalization partition wall notch sections 804, compartmentalization partition wall notch section 815), and the intermediate partition wall notch sections (intermediate partition wall notch sections 806, intermediate partition wall notch sections 817) are respectively provided. Moreover, in the cover bodies (first surface cover body 910, second surface cover body 920), the notch sections (notch sections 915, notch sections 925) are provided. Therefore, the gas discharged out of the laminate film outer casings of the unit batteries 100 is released as indicated by arrows in the diagram.

That is, according to the present embodiment, the cover bodies (first surface cover body 910, and second surface cover body 920) and the compartmentalization partition wall notch sections (compartmentalization partition wall notch sections 804, compartmentalization partition wall notch section 815) form openings. Similarly, the cover bodies (first surface cover body 910, and second surface cover body 920) and the intermediate partition wall notch sections (intermediate partition wall notch sections 806, intermediate partition wall notch sections 817) form openings. The openings become paths through which the gas discharged out of the unit batteries 100 is released.

According to the present embodiment, the compartmentalization partition wall notch sections (compartmentalization partition wall notch sections 804, compartmentalization partition wall notch section 815), and the intermediate partition wall notch sections (intermediate partition wall notch sections 806, intermediate partition wall notch sections 817) are provided at locations where the notch sections intersect with the direction in which a pulled-out tab of each unit battery 100 is pulled out, the compartmentalization partition wall sections, and the intermediate partition wall sections, helping to improve the gas exhaust performance.

The battery module 1000 of another embodiment includes the above exhaust structure. Therefore, even if gas is generated as one of a plurality of unit batteries 100 mounted in the battery module 1000 generates abnormal heat, the gas can be released through the above exhaust structure. Therefore, it is possible to reduce the effects of the gas on a unit battery 100 adjacent to the above unit battery 100, and to safeguard the entire battery module 1000.

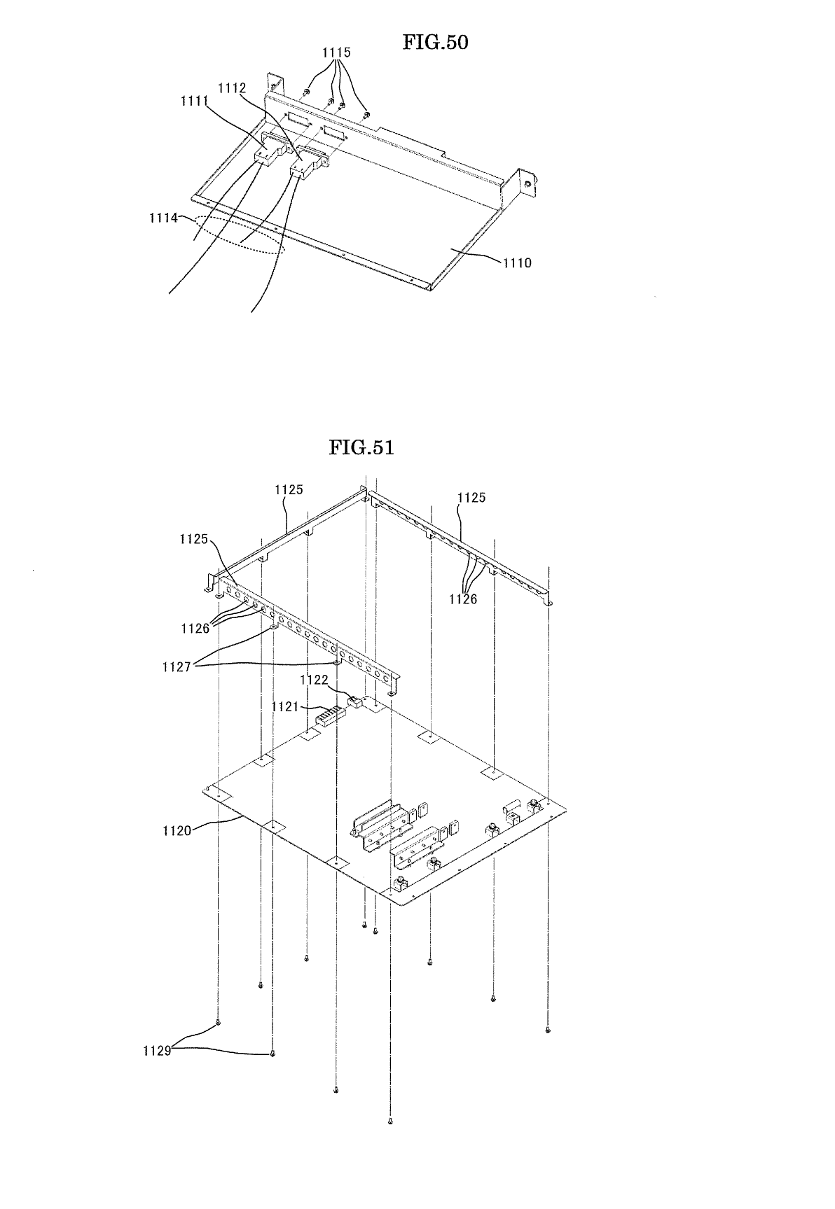

The configuration of the battery management circuit unit 1100 that manages the above battery module 1000 of the present invention will be outlined below. FIGS. 50, 51, and 52 are diagrams illustrating a production process of the battery management circuit unit 1100. FIG. 53 is a diagram showing the battery management circuit unit 1100.

In a process shown in FIG. 50, on a connector panel 1110, a third connector 1111 and a fourth connector 1112 are mounted with screws 1115. Given how the battery management circuit unit 1100 is mounted to the electric storage device 1200, and other factors, it is desirable that the battery management circuit unit 1100 be substantially equal in size to the battery module 1000. However, if the above size is achieved only by a circuit board 1120, problems would arise in terms of costs and the like. Therefore, the connector panel 1110 is used.

In a process shown in FIG. 51, on the circuit board 1120 on which battery-management circuits are mounted, side plates 1125 are fixed by using screw hole sections 1127 of the circuit board 1120 and screws 1129; ventilation holes 1126 are provided in some portions of the side plates 1125 to cool the circuits.

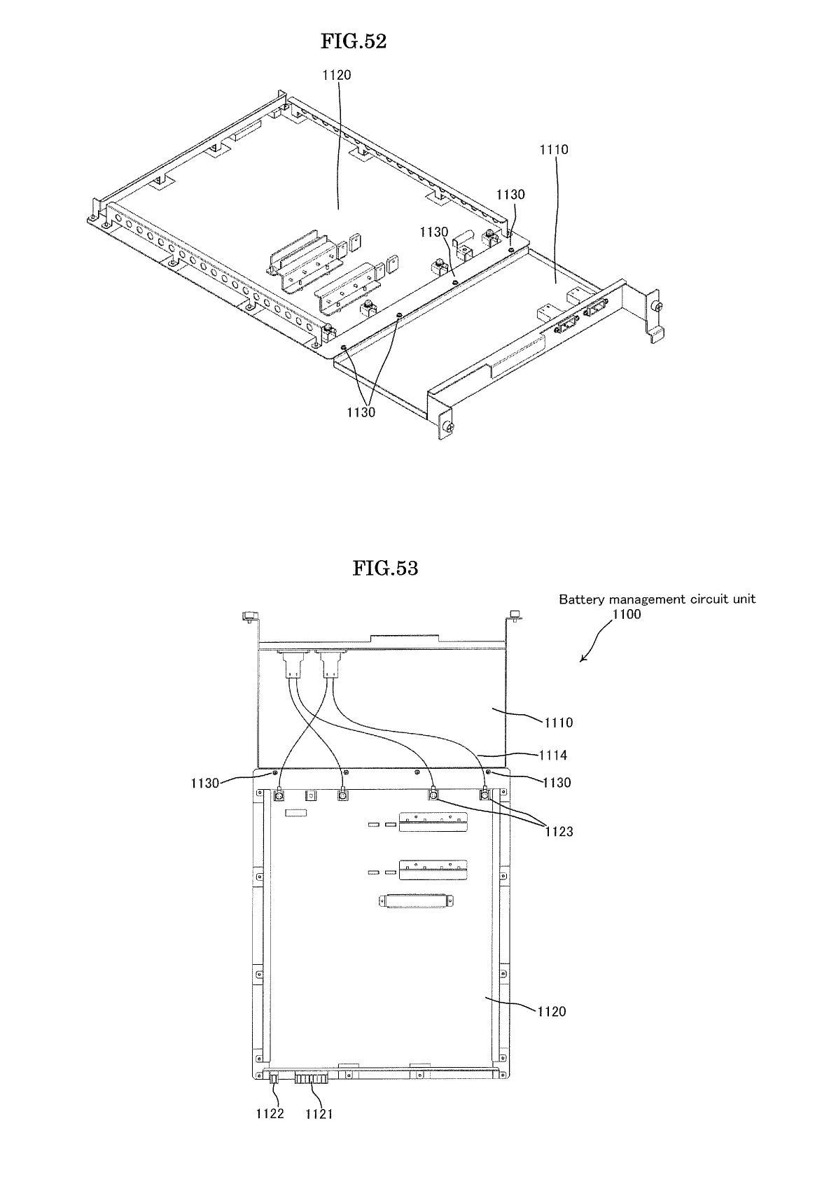

Then, in a process shown in FIG. 52, the circuit board 1120 is fixed to the connector panel 1110 with screws 1130.

Then, in a process shown in FIG. 53, lead wires 1114 of the third connector 1111 and fourth connector 1112, which are provided on the connector panel 1110, are electrically connected to terminals 1123 of the circuit board 1120.

In the battery management circuit unit 1100 having the above configuration, the third connector 1111, the fourth connector 1112, the fifth connector 1121, and the sixth connector 1122 are provided.

The following describes the electric storage device 1200 that includes the above battery management circuit unit 1100 and battery module 1000.

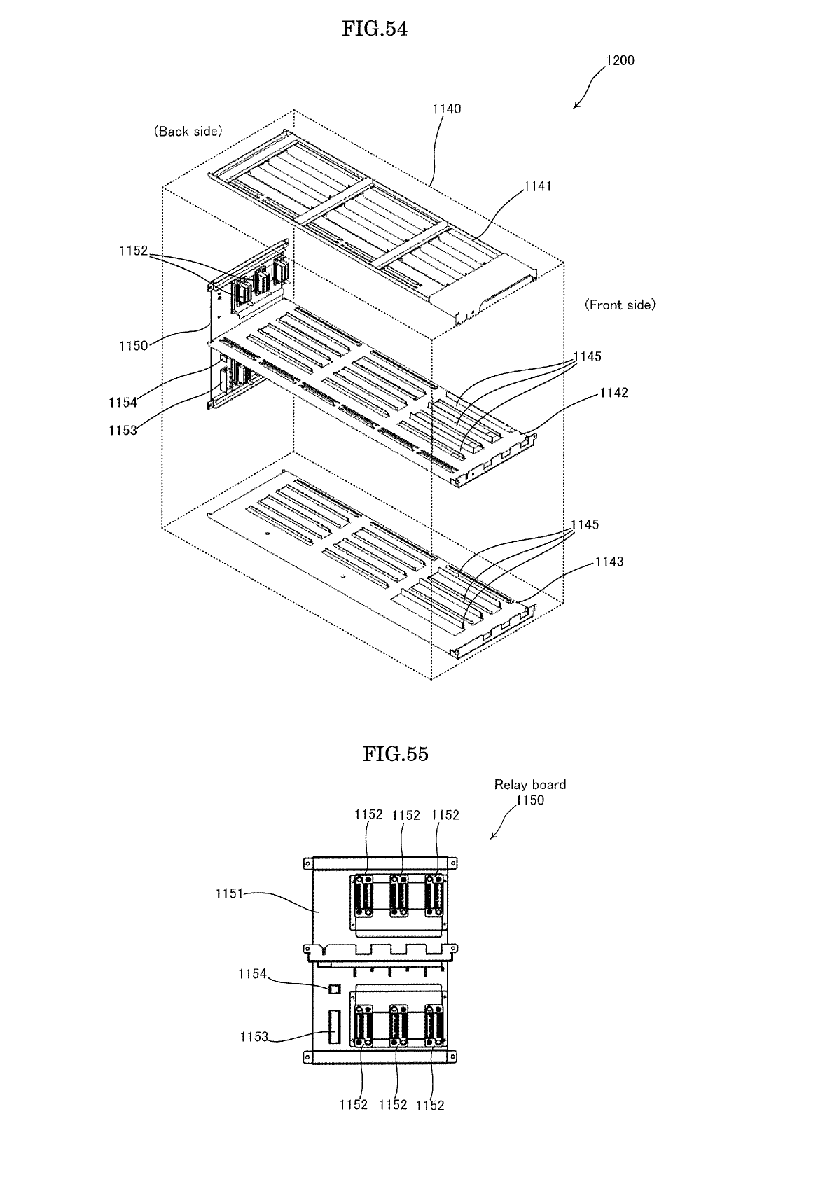

FIG. 54 shows a housing 1140 of the electric storage device 1200 that uses a battery module 1000 according to another embodiment of the present invention. Inside the housing 1140, an upper rail member 1141, a middle rail member 1142, and a lower rail member 1143 are provided as shown in the diagram. On a lower surface of the upper rail member 1141, on an upper and a lower surface of the middle rail member 1142, and on an upper surface of the lower rail member 1143, concave guide members 1145 are provided; the concave guide members 1145 are used when the battery modules 100 are set in the electric storage device 1200 as the battery modules 100 slide.

On a back surface side of the housing 1140 of the electric storage device 1200, a relay board 1150 is provided. FIG. 55 is a view of the relay board 1150 when seen from the front of the electric storage device 1200. On the relay board 1150, the following are provided: seventh connectors 1152, to which the second connector 840 of each battery module 1000 is fitted; and an eight connector 1153 and a ninth connector 1154, to which the fifth connector 1121 and sixth connector 1122 of the battery management circuit unit 1100 are respectively fitted. Wires, not shown, are laid, and sense information and temperature information of each battery module 1000 therefore can be relayed to the battery management circuit unit 1100. The battery management circuit unit 1100 therefore acquires data about potential of each unit battery 100 and data about temperatures in each battery module 1000, and carries out control processes, such as discharge stop, based on the data.

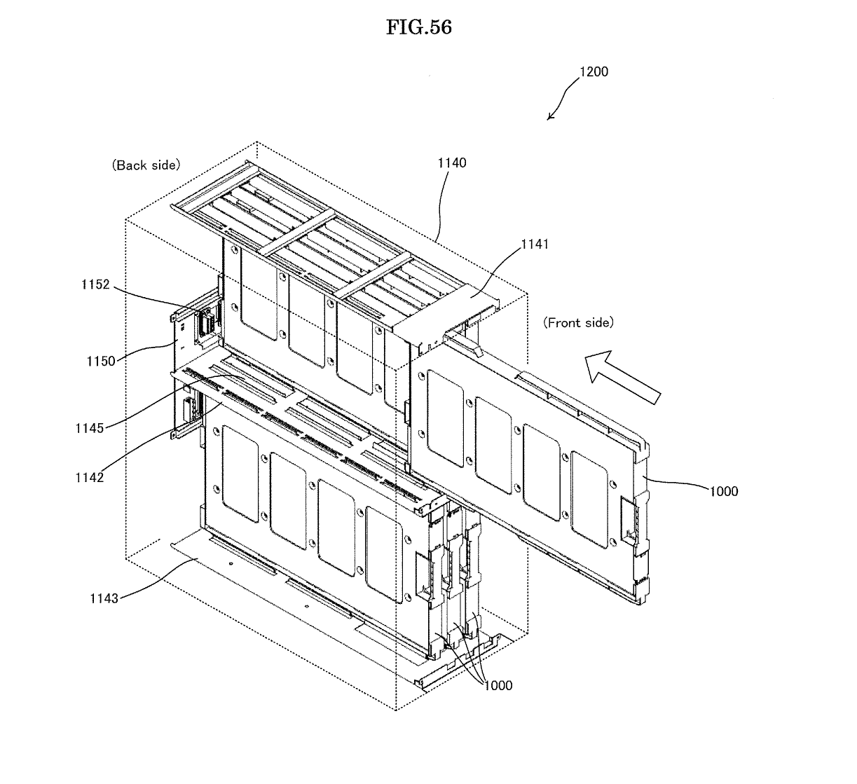

FIG. 56 shows how the concave guide members 1145 of the rail members are utilized, and battery modules 1000 slide and are set in the housing 1140 of the electric storage device 1200. At this time, into the seventh connectors 1152 of the relay board 1150 on the back surface side of the housing 1140, the second connectors 840 of the battery modules 1000 need to be fitted.

If the rail members and any other members have a tolerance, it is difficult to fit the second connector 840 into the seventh connector 1152. Therefore, the second connector 840 is so formed as to be slightly variable in order to cover the above tolerance.

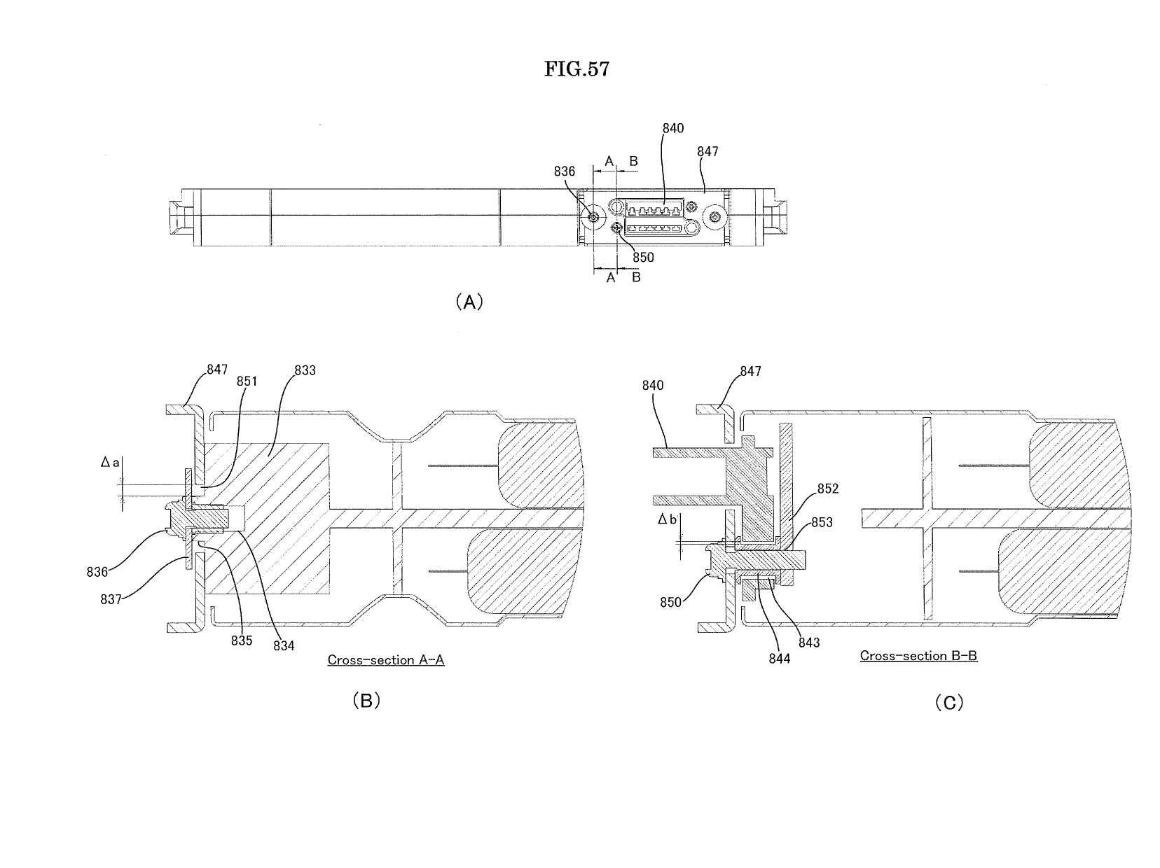

A structure to make the second connector 840 variable as described above will be described. FIG. 57 is a diagram illustrating the configuration of portions around the second connector 840 of the battery module 1000 according to another embodiment of the present invention. FIG. 57(A) is a front view of the second connector 840 of the battery module 1000. FIG. 57(B) is a cross-sectional view of FIG. 57(A) taken along A-A. FIG. 57(C) is a cross-sectional view of FIG. 57(A) taken along B-B.

As shown in FIG. 57(B), on a panel mounting base section 833 of the battery housing body 800, a screw hole peripheral protruding section 835 is so provided as to protrude from a plane that makes up the panel mounting base section 833. At the center of the screw hole peripheral protruding section 835, a panel mounting screw hole 834 is provided: The panel mounting screw hole 834 is used to mount the connector mounting panel 847 on the battery housing body 800.

The outer diameter of the screw hole peripheral protruding sections 835 that are inserted into mounting notch sections 851 provided on both sides of the connector mounting panel 847 is smaller than inner-side portions of the mounting notch sections 851 by 2Δa, as shown in the diagram. The connector mounting panel 847 positionally can change by 2Δa with respect to the battery housing body 800.

As shown in FIG. 57(C), in a through-hole 843 of the second connector 840, a bush 844 is installed. The outer diameter of the bush 844 is smaller than the inner diameter of the through-hole 843 by 2Δb. Therefore, the position of the body section 841 of the second connector 840 can change by 2Δb with respect to the bush 844.

The connector mounting panel 847 positionally can change by 2Δa with respect to the battery housing body 800. The second connector 840 positionally can change by 2Δb with respect to the connector mounting panel 847. Therefore, the second connector 840 positionally can change by 2Δa+2Δb with respect to the battery housing body 800.

In this case, the dimensional relationship Δa>Δb is preferably set. Because of the tolerance of 2Δa, the second connector 840 of the battery module 1000, which is guided by the rail member as the position thereof is regulated, is roughly positioned with respect to the seventh connector 1152; at a time when the second connector 840 is being fitted into the seventh connector 1152, because of the tolerance of 2Δb, the second connector 840 is fitted into the seventh connector 1152. If the dimensional relationship Δa>Δb is set, the second connector 840 can be more smoothly fitted into the seventh connector 1152 as described above.

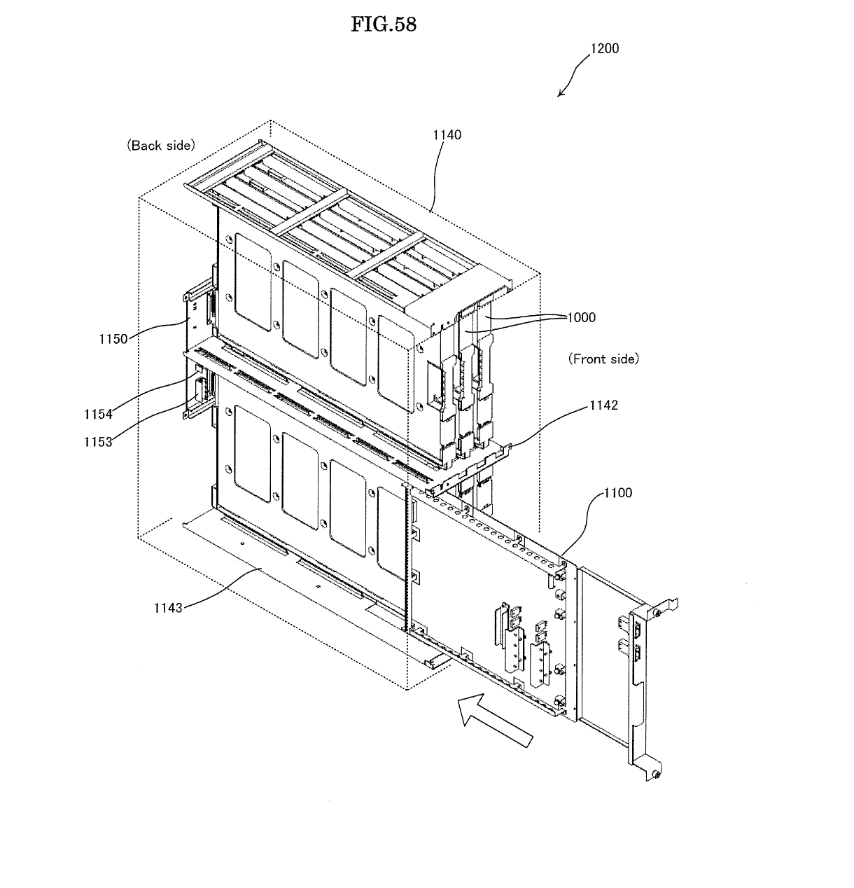

FIG. 58 shows how the battery management circuit unit 1100 is set in the housing 1140 of the electric storage device 1200. The fifth connector 1121 and sixth connector 1122 of the battery management circuit unit 1100 are fitted into the eighth connector 1153 and ninth connector 1154 of the relay board 1150, respectively.

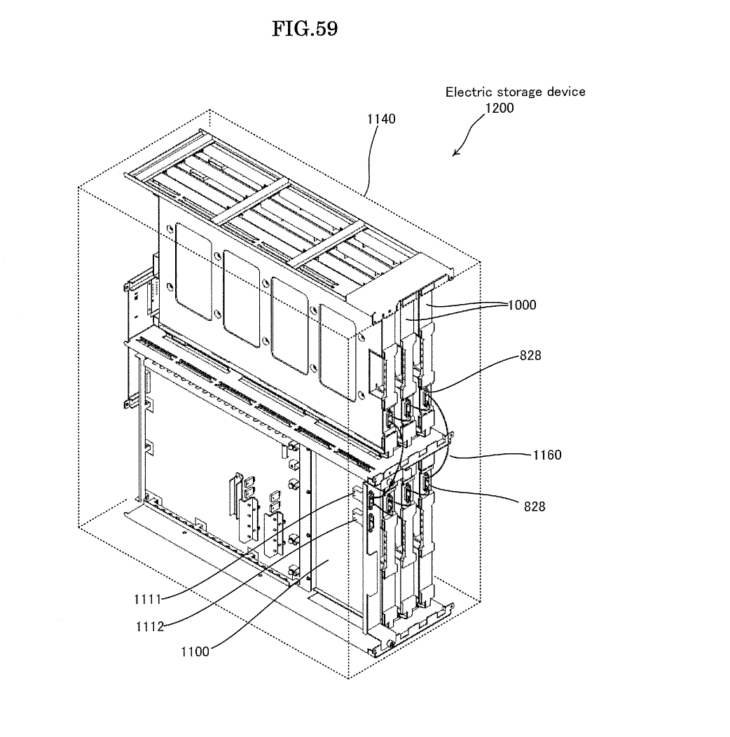

In a process shown in FIG. 59, the cap member 891 of each battery module 1000 is removed, and the battery modules 1000 are connected in series through a power supply line 1160. The power supply line 1160 of both ends connected in series is input to the third connector 1111 of the battery management circuit unit 1100.

In that manner, each battery module 1000 and the battery management circuit unit 1100 are set, and the electric storage device 1200 is completed.

### INDUSTRIAL APPLICABILITY

The present invention relates to battery modules, such as lithium-ion batteries, which have become increasingly widely used in a field of clean-energy electric storage devices and other fields in recent years. A battery module that uses high-energy-density lithium-ion batteries as unit batteries is required to have a particularly high level of flame retardancy to ensure safety. Moreover, in a conventional battery module that uses flexible secondary battery cells, it is difficult to curb a decrease in rigidity as the battery module is made thinner, and one of the problems is that it is difficult to make the battery module thinner. In the battery module of the present invention, a plurality of unit batteries are housed separately by means of compartmentalization partition wall sections. Therefore, it is possible to prevent a drop in flame retardancy, which might be caused by the overlapping unit batteries and the like. Furthermore, the compartmentalization partition wall sections help to keep the rigidity of the battery module high. Therefore, it is possible to provide the battery module that easily can be made thinner and maintain reliability, and the industrial applicability is very high.

### EXPLANATION OF REFERENCE SYMBOLS

100: Unit battery
105: Electrode stack region
110: Battery body section
111: Alignment through-hole
115: Insulation tape
120: Positive electrode pulled-out tab
124: Alignment through-hole
130: Negative electrode pulled-out tab
134: Alignment through-hole
135: Through-hole
140: Additional tab member
143: Welding section
145: Through-hole
150: Two-sided tape
200: Unit battery housing body
210: First surface
211: First surface peripheral partition wall section
212: First surface compartmentalization partition wall section
214: Wire-laying notch section
215: First battery housing chamber
216: Second battery housing chamber
217: First surface wiring housing chamber
218: First surface compartmentalization partition wall section
220: Second surface
221: Second surface peripheral partition wall section
222: Second surface compartmentalization partition wall section
224: Wire-laying notch section
225: Third battery housing chamber
226: Fourth battery housing chamber
227: Second surface wiring housing chamber
228: Second surface compartmentalization partition wall section
231: First through-hole
232: First connector
233: Second through-hole
234: Second connector
235: Grip through-hole
236: Grip section
237: Bus-bar-laying through-hole
238: Fuse mounting through-hole
239: Cover-body locking through-hole
240: Unit battery mounting section
241: Unit battery alignment projection
245: Tab member mounting section
246: Tab member fixing screw hole
249: Fuse fixing screw hole
250: First end side protruding guide member
251: Tapered section
252: Tapered section
255: Second end side protruding guide member
256: Tapered section
257: Tapered section
260: Cover body fixing screw hole
271: First bus bar
272: Second bus bar
273: Third bus bar
274: Fourth bus bar
275: Fifth bus bar
281: Power supply line
282: Power line terminal
283: Screw
285: Thermistor connection line
286: Thermistor
287: Sense line
288: Sense line terminal
289: Screw
290 Fuse
310: First surface cover body
311: Battery-pressing raised section
312: Pressing surface
313: Screw hole raised section
314: Screw hole
315: Notch section
316: Locking piece
320: Second surface cover body
321: Battery-pressing raised section
322: Pressing surface
323: Screw hole raised section
324: Screw hole
325: Notch section
326: Locking piece
350: Two-sided tape
360: Cover body insulation sheet
361: Pressing-surface punched section
362: Screw-hole punched section
363: Screw-hole notch section
370: Two-sided tape
380: Pressing-surface insulation sheet
390: Screw
400: Battery module
500: Battery management circuit unit
510: Chassis
511: Bottom surface section
512: Side wall section
513: Screw hole section
515: Ventilation hole
516: Connector
517: Heat dissipation sheet
520: First circuit board
521: Semiconductor component
523: Heat sink
524: Bottom surface section
525: Fin
527: Bolt
528: Nut
540: Second circuit board
545: Screw
550: Module housing rack
560: Concave guide member
590: Housing
600: Electric storage device
700: Battery module
701: Unit battery
702: Positive electrode pulled-out tab
703: Negative electrode pulled-out tab
704: Convex guide member
705: Electrode stack region
706: Bus bar
707: Bus bar
708: First surface peripheral partition wall section
709: Second surface peripheral partition wall section
710: First surface compartmentalization partition wall section
711: Second surface compartmentalization partition wall section
800: Unit battery housing body
801: First surface
802: First surface peripheral partition wall section
803: First surface compartmentalization partition wall section
804: Compartmentalization partition wall notch section
805: First surface intermediate partition wall section
806: Intermediate partition wall notch section
807: First battery housing chamber
808: Second battery housing chamber
809: Third battery housing chamber
810: Fourth battery housing chamber
811: First surface sense line housing section
812: Second surface
813: Second surface peripheral partition wall section
814: Second surface compartmentalization partition wall section
815: Compartmentalization partition wall notch section
816: Second surface intermediate partition wall section
817: Intermediate partition wall notch section
818: Fifth battery housing chamber
819: Sixth battery housing chamber
820: Seventh battery housing chamber
821: Eighth battery housing chamber
822: Second surface sense line housing section
824: First connector housing concave section
825: First connector mounting opening section
826: First connector mounting screw hole
827: Power supply line opening section
828: First connector
829: Mounting screw
832: Second connector housing concave section
833: Panel mounting base section
834: Panel mounting screw hole
835: Screw hole peripheral protruding section
836: Mounting screw
837: Retaining washer
840: Second connector
841: Body section
842: Metal terminal section
843: Through-hole
844: Bush
847: Connector mounting panel
848: Connector mounting opening section
849: Connector mounting screw hole
850: Mounting screw
851: Mounting notch section
852: Clamping member
853: Female screw hole
854: Grip through-hole
855: Grip section
860: Unit battery alignment projection
861: Tab member mounting section
862: Tab member fixing screw hole
863: Inter-screw-hole bridge section
864: Bus bar alignment projection
865: End section bus bar fixing frame
867: Bus-bar-laying through-hole
869: Cover body fixing screw hole
870: First end side protruding guide member
871: Tapered section
872: Second end side protruding guide member
873: Tapered section
875: End section bus bar
876: Inter-tab-member bus bar
877: Inter-surface bus bar
881: Power supply line
822: Power line terminal
883: Screw
885: Thermistor connection line
886: Thermistor
887: Sense line
888: Sense line terminal
889: Screw
890: Locking opening
891: Cap member
892: Locking piece
910: First surface cover body
911: Battery-pressing raised section
912: Pressing surface
913: Screw hole raised section
914: Screw hole
915: Notch section
920: Second surface cover body
921: Battery-pressing raised section
922: Pressing surface
923: Screw hole raised section
924: Screw hole
925: Notch section
930: Screw
1000: Battery module
1100: Battery management circuit unit
1110: Connector panel
1111: Third connector
1112: Fourth connector
1114: Lead wire
1115: Screw
1120: Circuit board
1121: Fifth connector
1122: Sixth connector
1123: Terminal
1125: Side plate
1126: Ventilation hole
1127: Screw hole section
1129: Screw
1130: Screw
1140: Housing
1141: Upper rail member
1142: Middle rail member
1143: Lower rail member
1145: Concave guide member
1150: Relay board
1151: Base material
1152: Seventh connector
1153: Eighth connector
1154: Ninth connector
1160: Power supply line
1200: Electric storage device

1. A battery module, comprising:
a flat-plate base that includes a front surface and a back surface as two main surfaces;
a compartmentalization partition wall section that is erected and formed on the front or back surface from the base; and
a plurality of unit batteries that are mounted on the base, wherein
the compartmentalization partition wall section is provided between the unit battery and the adjacent unit battery.

2. The battery module according to claim 1, wherein
the compartmentalization partition wall sections are formed on both the front surface and the back surface.

3. The battery module according to claim 1, wherein
the compartmentalization partition wall section is so formed as to protrude from the base, and forms a rectangular shape as a shape on a plane of the front or back surface.

4. The battery module according to claim 1, wherein
the compartmentalization partition wall section is so formed as to protrude from the base, and forms a quadrangular shape as a shape on a plane of the front or back surface.

5. The battery module according to claim 1, wherein
a plurality of the compartmentalization partition wall sections are provided between the unit batteries and the adjacent unit batteries.

6. The battery module according to claim 2, comprising:
a first surface cover body that is placed on a plurality of the unit batteries on the front surface; and
a second surface cover body that is placed on a plurality of the unit batteries on the back surface.

7. The battery module according to claim 6, wherein
the first and second surface cover bodies are made of aluminum.

8. The battery module according to claim 1, comprising
a protruding guide member that is provided on two side faces that are different from the front and back surfaces and face each other, in such a way as to extend along a planar direction of the front or back surface.

9. The battery module according to claim 8, wherein:
the protruding guide member is so provided as to protrude from the peripheral partition wall section or to extend from the base; and a tapered section is so provided that a protruding amount of the protruding, or an extending amount of the extending, varies.

10. The battery module according to claim 8, wherein
a width of the protruding guide member provided on one of the two side faces is different from a width of the protruding guide member provided on the other side face in a direction perpendicular to the front or back surface.

11. The battery module according to claim 1, wherein
the compartmentalization partition wall section is provided in a direction perpendicular to a direction in which a pulled-out tab of the unit battery is pulled out, and a notch section is provided in the compartmentalization partition wall section.

12. The battery module according to claim 11, comprising
a first surface cover body that covers the front surface of the base, wherein an opening is so formed as to be surrounded by the first surface cover body and the notch section.

13. The battery module according to claim 11, comprising
a second surface cover body that covers the back surface of the base, wherein an opening is so formed as to be surrounded by the second surface cover body and the notch section.

14. The battery module according to claim 11, wherein
a plurality of the notch sections are provided in the compartmentalization partition wall section.

15. The battery module according to claim 11, wherein
the notch section is provided at a location of the compartmentalization partition wall section where the notch section intersects with a direction in which the pulled-out tab is pulled out.

16. The battery module according to claim 1, wherein:
the pulled-out tabs of the unit battery include a positive electrode pulled-out tab and a negative electrode pulled-out tab; the positive electrode pulled-out tab is pulled out of one side of a body section of the unit battery; and the negative electrode pulled-out tab is pulled out of the other side of the body section which faces the one side.

17. The battery module according to claim 1, wherein
in a direction perpendicular to a direction in which a pulled-out tab of the unit battery is pulled out, a plurality of the unit batteries are arranged in one direction.

18. The battery module according to claim 17, wherein
on the compartmentalization partition wall section that intersects with a direction in which the pulled-out tab of each of the unit batteries is pulled out, the notch section is provided.

19. The battery module according to claim 18, wherein
a plurality of the unit batteries are electrically connected together.

20. The battery module according to claim 19, wherein
a connection type of the electric connection is series connection.

21. The battery module according to claim 1, wherein
the unit battery is an electrochemical element.

22. The battery module according to claim 1, wherein
the unit battery is a lithium-ion secondary battery.
